(19) United States
(12) Patent Application Publication
(10) Pub. No.: US 2026/0286221 A1
(43) Pub. Date: Sep. 24, 2026

(54) CHIRAL REACTIVE MESOGEN MIXTURE

(71) Applicant: MERCK PATENT GMBH, Darmstadt (DE)

(72) Inventors: James ALLEN, Feltham (GB); Sarabjot KAUR, Feltham (GB); Kevin ADLEM, Feltham (GB); Owain Llyr PARRI, Feltham (GB); Thomas BANKS, Uxbridge (GB)

(73) Assignee: MERCK PATENT GMBH, Darmstadt (DE)

(21) Appl. No.: 19/167,976

(22) PCT Filed: Mar. 27, 2024
(86) PCT No.: PCT/EP2024/058282

§ 371 Date: Sep. 23, 2025

(30) Foreign Application Priority Data
Mar. 31, 2023 (EP) 23165889.9

(51) Int. Cl. C09K 19/18; C09K 19/04; C09K 19/32; C09K 19/58

(52) U.S. Cl. CPC C09K 19/18; C09K 19/322; C09K 19/588; C09K 2019/0448; C09K 2019/188; C09K 2219/03

(57) ABSTRACT

Chiral reactive mesogen (RM) mixtures and formulations comprising the same. Further, polymers and polymer films obtained from such chiral RM mixtures. Further, the use of such chiral RM mixtures. Additionally, formulations, polymers, and polymer films comprising or obtained from such chiral RM mixtures in optical or electro-optical components or devices.

### CROSS-REFERENCE TO RELATED APPLICATIONS

This is a PCT National Stage application filed under 35 U.S.C. § 371 (c), claiming priority benefit under 35 U.S.C. § 365(a) of and to PCT International Application No. PCT/EP2024/058282, filed Mar. 27, 2024, which claims priority benefit under 35 U.S.C. § 365(b) of and to EP Patent Application No. 23165889.9, filed Mar. 31, 2023, the entire contents of which documents are incorporated herein by reference in their entirety and for all purposes.

### FIELD OF THE INVENTION

The invention relates to chiral reactive mesogen (RM) mixtures and formulations comprising them, to polymers and polymer films obtained from such chiral RM mixtures, and the use of the chiral RM mixtures, formulations, polymers and polymer films in optical or electro-optical components or devices.

### BACKGROUND

In the newly emerging area of AR/VR (augmented reality/virtual reality) some applications, such as optical waveguides, require materials which exhibit high average refractive index (n̅) while maintaining high birefringence (Δn). Reactive mesogen (RM) materials have been proposed for these applications, for example to produce diffraction gratings such as Pancharatnam-Berry gratings (PBG) and lenses, also referred to as Bragg polarization gratings (Bragg PG) or polarization volume gratings (PVG). These RM materials can be polymerized into a liquid crystal polymer (LCP) network with carefully controlled properties. The best alignment for RMs in PBGs is typically achieved for chiral nematic (hereinafter also referred to as cholesteric) systems in which the chiral structure promotes the self-organization of the bulk LC.

To maximize the performance of the optical element multiple factors must be designed and carefully controlled. These include; the grating pitch (A), the optical indices (extraordinary(nₑ), ordinary(nₒ) and average(n̅)) and thickness (d) of the LCP and the chiral pitch which gives rise to the grating slant angle (OG). It is also sometimes required to vary these properties within one optical element, this can be achieved through the use of multiple layers of LCP where the properties of the RM mixture can be modified to change the indices or slant angle, as described for example in Xiang, X., Kim, J. & Escuti, M. J. Sci Rep 8, 7202 (2018). FIG. 1 which is also shown in this reference exemplarily illustrates a diagram of a two-layer PBG formed from an LCP with an average refractive index n̅ and a birefringence Δn on a photoalignment layer (PAL) that is provided on a substrate and has a grating pitch Λₓ. The two layers of the LCP PBG have a layer thickness d₁ and d₂, and different slant angles θ_{G1} and θ_{G2} due to the differing chiral pitch Λ₁ and Λ₂ in each layer.

To produce multiple-layer PBGs, multiple RM coating steps must be undertaken where the first RM layer is coated on an alignment layer, typically a photo-alignment layer (PAL) or lithographically fabricated alignment layer. The RM layer adopts the alignment direction promoted by the alignment layer and the material is cured to give an LCP. The next layer of RM is then coated directly on top of the previous LCP layer. To achieve good quality alignment, it is necessary for the layer being coated not to damage the previous layer and for strong intermolecular interactions to take place between the layers to impart the alignment direction from one layer to the next.

However, in the preparation of multiple-layer PBGs using conventional RM materials, overcoating of the RM layers has been found to be challenging with it being difficult to prevent damage in the lower RM layers. This requires good control of the degree of cure and crosslinking. Also, good intermolecular forces are needed between the layers to enable good alignment transfer to the subsequent layer. When using an RM material with very high refractive index the alignment is often not transferred well between layers leading to a misaligned schlieren-like texture in the second layer of RM deposited.

### SUMMARY OF THE INVENTION

It is therefore an aim of the present invention to provide RM materials and polymer films which enable the preparation of multiple-layer PBGs formed from multiple cholesteric RM layers coated on top of each other which show uniform alignment with good intermolecular forces and good alignment transfer between the RM layers, with reduced alignment defects like schlieren texture, while avoiding damage in the lower RM layers. Other aims of the present invention are immediately evident to the person skilled in the art from the following detailed description.

Surprisingly, the inventors of the present invention have found that these aims could be achieved by providing a chiral reactive mesogen mixture, which is hereinafter also referred to as “RM mixture”, according to the invention as described and claimed hereinafter. In particular, it has been surprisingly found that by careful material design and selection it is possible to solve one or more of the above problems and to provide RM mixtures which can be successfully overcoated to provide good PBG alignment.

The present invention relates to a mixture comprising at least one chiral compound and at least one, preferably at least two, polymerizable compounds of formula I

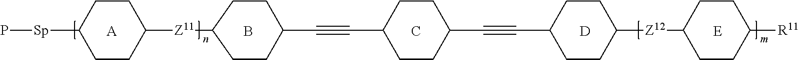

wherein the individual radicals, independently of each other and on each occurrence identically or differently, have the following meanings
P a polymerizable group,
Sp a spacer group or a single bond,
A, B, D, E benzene-1,4-diyl, naphthalene-1,4-diyl, naphthalene 2,6-diyl or anthracene-9,10-diyl, all of which are optionally substituted by one 3- or more groups L or P-Sp-,
C benzene-1,4-diyl, naphthalene-1,4-diyl, naphthalene 2,6-diyl, anthracene-9,10-diyl, phenanthrene-2,7-diyl or fluorene-2,7-diyl, all of which are optionally substituted by one or more groups L or P-Sp-,
and one of the rings C and D may also denote a single bond,
R¹¹ F, Cl, CN, alkoxy or thioalkyl with 1 or 2 C atoms which is optionally fluorinated, or P—Sp-, preferably OCH₃, SCH₃, OC₂H₅, SC₂H₅, OCF₃, OCF₂H or P—Sp-, more preferably OCH₃, SCH₃ or P—Sp-, very preferably OCH₃ or P—Sp-,
Z¹¹, Z¹²—O—, —S—, —CO—, —COO—, —OCO—, —S—CO—, —CO—S—, —O—COO—, —CO—NR⁰—, —NR⁰—CO—, —NR⁰—CO—NR⁰⁰, —NR⁰—CO—O—, —O—CO—NR⁰—, —OCH₂—, —CH₂O—, —SCH₂—, —CH₂S—, —CF₂O—, —OCF₂—, —CF₂S—, —SCF₂—, —CH₂CH₂—, —(CH₂)ₙ₁, —CF₂CH₂—, —CH₂CF₂—, —CF₂CF₂—, —CH═N—, —N═CH—, —N═N—, —CH═CR⁰—, —CY¹═CY²—, —C≡C—, —CH═CH—COO—, —OCO—CH═CH— or a single bond, preferably —COO—, —OCO—, —C≡C—, or a single bond, very preferably a single bond,
Y¹, Y² H, F, Cl or CN,
L F, Cl, —CN, P—Sp-, or straight chain, branched or cyclic alkyl having 1 to 25 or 3 to 25 C atoms, wherein one or more non-adjacent CH₂-groups are optionally replaced by —O—, —S—, —CO—, —CO—O—, —O—CO—, —O—CO—O—, CR⁰═CR⁰⁰—, —C≡C—,

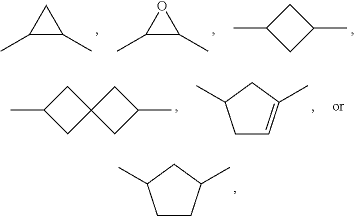

in such a manner that O- and/or S-atoms are not directly connected with each other, and wherein one or more H atoms are each optionally replaced by P—Sp-, F or Cl, or two substituents L that are connected to directly adjacent C atoms may also form a cycloalkyl or cycloalkenyl group with 5, 6, 7 or 8 C atoms,
R⁰, R⁰⁰ H or alkyl having 1 to 12 C atoms,
n1 1, 2, 3 or 4,
n 0, 1, 2, 3 or 4, preferably 0, 1 or 2, more preferably 0 or 1, most preferably 0,
m 0, 1, 2, 3 or 4, preferably 0, 1 or 2, more preferably 0 or 1, most preferably 0,
r 0, 1, 2, 3 or 4, preferably 0, 1 or 2,
s 0, 1, 2 or 3, preferably 0, 1 or 2,
t 0, 1 or 2, preferably 0 or 1.

The invention further relates to a formulation, which is hereinafter referred to as “RM formulation”, comprising one or more polymerizable compounds and one or more chiral compounds, or an RM mixture, as described above and below, and further comprising one or more solvents and/or additives.

The invention further relates to a polymer film obtainable or obtained by polymerizing an RM mixture or RM formulation as described above and below, preferably wherein the RMs are aligned, and preferably at a temperature where the polymerizable compounds or the RM mixture exhibit a liquid crystal phase.

The invention further relates to the use of the RM mixture or the polymer film as described above and below in optical, electro-optical or electronic components or devices.

The invention further relates to an optical, electro-optical or electronic device or a component comprising an RM mixture or a polymer film as described above and below.

Said components include, without limitation, optical retardation films, polarizers, optical compensators, diffraction or surface gratings such as Bragg polarization gratings (Bragg PG), polarization volume gratings (PVG) or Pancharatnam Berry gratings (PBG), furthermore nonmechanical beam steering elements, optical waveguides, optical couplers or combiners, polarization beam splitters, partial mirrors, reflective films, alignment layers, color filters, antistatic protection sheets, electromagnetic interference protection sheets, lenses for light guides, focusing and optical effects, polarization controlled lenses, and IR reflection films; for example for use in LC displays (LCDs), organic light emitting diodes (OLEDs), autostereoscopic 3D displays, see-through near-eye displays, augmented reality (AR) or virtual reality (VR) systems, switchable windows, spatial light modulators, optical data storage, remote optical sensing, holography, spectroscopy, optical telecommunications, polarimetry or front/back-lighting.

Said devices include, without limitation, electro optical displays, especially LCDs, OLEDs, autostereoscopic 3D displays, see-through near-eye displays, AR/VR systems, goggles for AR/VR applications, switchable windows, spatial light modulators, optical data storage devices, optical sensors, holographic devices, spectrometers, optical telecommunication systems, polarimeters or front-/backlights.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 exemplarily and schematically illustrates a two-layer liquid crystal polymer (LCP) PBG on a photo-alignment layer (PAL).

FIG. 2A shows a polarized optical microscopy image of an LCP PBG according to Comparison Example 1.

FIG. 2B shows a polarized optical microscopy image of an LCP PBG according to Example 1.

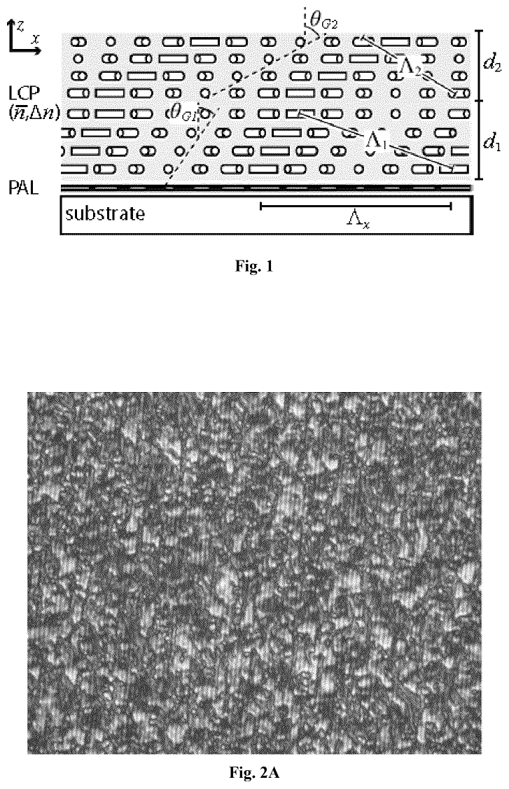

### DEFINITIONS OF TERMS

Throughout the description and claims of this specification, the words “comprise” and “contain” and variations of the words, for example “comprising” and “comprises”, mean “including but not limited to”, and are not intended to (and do not) exclude other components.

Unless the context clearly indicates otherwise, as used herein plural forms of the terms herein are to be construed as including the singular form and vice versa.

The term “film” as used herein includes rigid or flexible, self-supporting or free-standing films with mechanical stability, as well as coatings or layers on a supporting substrate or between two substrates. “Thin film” means a film having a thickness in the nanometer or micrometer range, preferably at least 10 nm, very preferably at least 100 nm, and preferably not more than 100 μm, very preferably not more than 10 μm.

The term “chiral” in general is used to describe an object that is non-superimposable on its mirror image.

“Achiral” (non-chiral) objects are objects that are identical to their mirror image.

The terms “chiral nematic” and “cholesteric” are used synonymously in this application, unless explicitly stated otherwise.

The reflection wavelength λ is given by the pitch p of the cholesteric helix and the mean birefringence n of the cholesteric liquid crystal in accordance with the following equation:

$$λ = n \cdot p$$

A cholesteric LC (CLC) medium mixture can be prepared, for example, by doping a nematic LC medium with a chiral dopant having a high twisting power. The pitch p of the induced cholesteric helix is then given by the concentration c and the helical twisting power HTP of the chiral dopant in accordance with the following equation:

$$p = {( HTP c )}^{- 1}$$

It is also possible to use two or more dopants, for example in order to com-pensate for the temperature dependence of the HTP of the individual dopants and thus to achieve low temperature dependence of the helix pitch and the reflection wavelength of the CLC medium. For the total HTP (HTPₜₒₜₐₗ) holds then approximately the following equation:

$$H T {P}_{t otal} = {\sum }_{i} {c}_{i} {HTP}_{i}$$

wherein cᵢ is the concentration of each individual dopant and HTPᵢ is the helical twisting power of each individual dopant.

Visible light is electromagnetic radiation that has wavelength in a range from about 400 nm to about 740 nm. Ultraviolet (UV) light is electromagnetic radiation with a wavelength in a range from about 200 nm to about 450 nm.

The Irradiance (Eₑ) or radiation power is defined as the power of electromagnetic radiation (dθ) per unit area (dA) incident on a surface:

$${E}_{e} = d θ / dA .$$

The radiant exposure or radiation dose (Hₑ), is as the irradiance or radiation power (Eₑ) per time (t):

$${H}_{e} = {E}_{e} \cdot t .$$

All temperatures, such as, for example, the melting point T(C,N) or T(C,S), the transition from the smectic (S) to the nematic (N) phase T(S,N) and the clearing point T(N,I) of the liquid crystals, are quoted in degrees Celsius. All temperature differences are quoted in differential degrees.

The term “clearing point” means the temperature at which the transition between the mesophase with the highest temperature range and the isotropic phase occurs.

The term “isomerizable compound” means a compound comprising one or more isomerizable groups.

The term “isomerizable group” means a functional group of a molecule that causes a change of the geometry of the molecule, i.e., isomerization, either by bond rotation, skeletal rearrangement or atom- or group-transfer, or by dimerization, for example upon irradiation with light of a suitable wavelength that can be absorbed by the molecule (photoisomerization).

Examples of photoisomerizable groups are —C═C— double bonds and azo groups (—N═N—). Examples of molecular structures and sub-structures comprising such photoisomerizable groups are stilbene, (1,2-difluoro-2-phenyl-vinyl)-benzene, cinnamate, α-cyanocinnamate, 4-phenylbut-3-en-2-one, Schiff base (i.e., a group RⁱRⁱⁱC═NRⁱⁱⁱ, wherein Rⁱⁱⁱ is different from H, and is for example alkyl or aryl), chalcone, coumarin, chromone, pentalenone and azobenzene.

The term “director” is known in prior art and means the preferred orientation direction of the long molecular axes (in case of calamitic compounds) or short molecular axes (in case of discotic compounds) of the liquid-crystalline or RM molecules. In case of uniaxial ordering of such anisotropic molecules, the director is the axis of anisotropy.

The term “alignment” or “orientation” relates to alignment (orientational ordering) of anisotropic units of material such as small molecules or fragments of big molecules in a common direction named “alignment direction”. In an aligned layer of liquid-crystalline or RM material the liquid-crystalline director coincides with the alignment direction so that the alignment direction corresponds to the direction of the anisotropy axis of the material.

The terms “uniform orientation” or “uniform alignment” of a liquid-crystalline or RM material, for example in a layer of the material, mean that the long molecular axes (in case of calamitic compounds) or the short molecular axes (in case of discotic compounds) of the liquid-crystalline or RM molecules are oriented substantially in the same direction. In other words, the lines of liquid-crystalline director are parallel.

The term “homeotropic structure” or “homeotropic orientation” refers to a film wherein the optical axis is substantially perpendicular to the film plane.

The term “planar structure” or “planar orientation” refers to a film wherein the optical axis is substantially parallel to the film plane.

The term “A plate” refers to an optical retarder utilizing a layer of uniaxially birefringent material with its extraordinary axis oriented parallel to the plane of the layer.

The term “C plate” refers to an optical retarder utilizing a layer of uniaxially birefringent material with its extraordinary axis oriented perpendicular to the plane of the layer.

In an A plate or C plate comprising optically uniaxial birefringent liquid crystal material with uniform orientation, the optical axis of the film is given by the direction of the extraordinary axis. An A (or C) plate comprising optically uniaxial birefringent material with positive birefringence is also referred to as “positive A (or C) plate” or “+A (or +C) plate”.

An A (or C) plate comprising a film of optically uniaxial birefringent material with negative birefringence, such as discotic anisotropic materials is also referred to as “negative A (or C) plate” or “−A (or C) plate” depending on the orientation of the discotic materials. A film made from a cholesteric calamitic material with a reflection band in the UV part of the spectrum also has the optics of a negative C plate.

The birefringence Δn is defined as follows

$$Δ n = {n}_{e} - {n}_{o}$$

wherein nₑ is the extraordinary refractive index and nₒ is the ordinary refractive index, and the average effective refractive index n_{av.} is given by the following equation:

$${n}_{av .} = {( ( 2 {n}_{o}^{2} + {n}_{e}^{2} ) / 3 )}^{1 / 2}$$

The average effective refractive index n_{av.}and the ordinary refractive index nₒ can be measured using an Abbe refractometer. An can then be calculated from the above equations.

As used herein, the term “RM mixture” means a mixture consisting of two or more, preferably two to ten, more preferably two to six RMs.

As used herein, the term “RM formulation” means at least one RM or RM mixture, and one or more other materials added to the at least one RM or RM mixture to provide, or to modify, specific properties of the RM formulation and/or of the at least one RM therein. It will be understood that an RM formulation is also a vehicle for carrying the RM to a substrate to enable the forming of layers or structures thereon. Exemplary materials include, but are not limited to, solvents, polymerization initiators, surfactants and adhesion promoters, etc. as described in more detail below.

Unless stated otherwise, the percentage of a compound in an RM mixture as given above and below means % by weight of the total RM mixture, excluding solvents or additives as described above and below that are used in the RM formulation.

Unless stated otherwise, the percentage of a compound in an RM formulation as given above and below means % by weight of all solids in the RM formulation, including liquid additives as described below but excluding solvents.

As used herein, the terms “reactive mesogen” and “RM” will be understood to mean a compound containing a mesogenic or liquid crystalline skeleton, and one or more functional groups attached thereto which are suitable for polymerization and are also referred to as “polymerizable group” or “P”.

Unless stated otherwise, the term “polymerizable compound” as used herein will be understood to mean a polymerizable monomeric compound.

The terms “liquid crystal”, “mesogen” and “mesogenic compound” as used herein mean a compound that under suitable conditions of temperature, pressure and concentration can exist as a mesophase or in particular as a LC phase.

The term “mesogenic group” as used herein is known to the person skilled in the art and described in the literature, and means a group which, due to the anisotropy of its attracting and repelling interactions, essentially contributes to causing a liquid-crystal (LC) phase in low-molecular-weight or polymeric substances. Compounds containing mesogenic groups (mesogenic compounds) do not necessarily have to have an LC phase themselves. It is also possible for mesogenic compounds to exhibit LC phase behaviour only after mixing with other compounds and/or after polymerization. Typical mesogenic groups are, for example, rigid rod- or disc-shaped units. An overview of the terms and definitions used in connection with mesogenic or LC compounds is given in Pure Appl. Chem. 2001, 73(5), 888 and C. Tschierske, G. PeIzI, S. Diele, Angew. Chem. 2004, 116, 6340-6368.

The term “spacer group”, hereinafter also referred to as “Sp”, as used herein is known to the person skilled in the art and is described in the literature, see, for example, Pure Appl. Chem. 2001, 73(5), 888 and C. Tschierske, G. PeIzI, S. Diele, Angew. Chem. 2004, 116, 6340-6368. As used herein, the terms “spacer group” or “spacer” mean a flexible group, for example an alkylene group, which connects the mesogenic group and the polymerizable group(s) in a polymerizable mesogenic compound.

A “polymer network” is a network in which all polymer chains are interconnected to form a single macroscopic entity by many crosslinks.

The polymer network can occur in the following types:
A graft polymer molecule is a branched polymer molecule in which one or more the side chains are different, structurally or configurationally, from the main chain.
A star polymer molecule is a branched polymer molecule in which a single branch point gives rise to multiple linear chains or arms. If the arms are identical, the star polymer molecule is said to be regular. If adjacent arms are composed of different repeating subunits, the star polymer molecule is said to be variegated.
A comb polymer molecule consists of a main chain with two or more three-way branch points and linear side chains. If the arms are identical the comb polymer molecule is said to be regular.
A brush polymer molecule consists of a main chain with linear, unbranched side chains and where one or more of the branch points has four-way functionality or larger.

If in the formulae shown above and below a group R, including any variations thereof such as R¹, R⁰, R⁰⁰, R⁰*, R¹¹, R²², R^{C}, R³, R⁴ etc., or L denotes an alkyl radical and/or an alkoxy radical, this may be straight-chain or branched. It is preferably straight-chain, has 2, 3, 4, 5, 6 or 7 C atoms and accordingly preferably denotes ethyl, propyl, butyl, pentyl, hexyl, heptyl, ethoxy, propoxy, butoxy, pentoxy, hexyloxy or heptyloxy, furthermore methyl, octyl, nonyl, decyl, undecyl, dodecyl, tridecyl, tetra-decyl, pentadecyl, methoxy, octyloxy, nonyloxy, decyloxy, undecyloxy, dodecyloxy, tridecyloxy or tetradecyloxy.

If in the formulae shown above and below a group R including any variations thereof such as R¹, R⁰, R⁰⁰, R*⁰, R¹¹, R²², R^{C}, R³, R⁴ etc., or L denotes an alkyl radical and/or an alkoxy radical, this may be straight-chain or branched. It is preferably straight-chain, has 2, 3, 4, 5, 6 or 7 C atoms and accordingly preferably denotes ethyl, propyl, butyl, pentyl, hexyl, heptyl, ethoxy, propoxy, butoxy, pentoxy, hexyloxy or heptyloxy, furthermore methyl, octyl, nonyl, decyl, undecyl, dodecyl, tridecyl, tetra-decyl, pentadecyl, methoxy, octyloxy, nonyloxy, decyloxy, undecyloxy, dodecyloxy, tridecyloxy or tetradecyloxy.

If in the formulae shown above and below a group R including any variations thereof such as R¹, R⁰, R⁰⁰, R⁰*, R¹¹, R²², R^{C}, R³, R⁴ etc., or L denotes an alkyl radical wherein one or more CH₂ groups are replaced by S, this may be straight-chain or branched. It is preferably straight-chain, has 1, 2, 3, 4, 5, 6 or 7 C atoms and accordingly preferably denotes thiomethyl, thioethyl, thiopropyl, thiobutyl, thiopentyl, thiohexyl or thioheptyl.

Oxaalkyl preferably denotes straight-chain 2-oxapropyl (=methoxymethyl), 2-oxabutyl (=ethoxymethyl) or 3-oxabutyl (=2-methoxyethyl), 2-, 3- or 4-oxapentyl, 2-, 3-, 4- or 5-oxahexyl, 2-, 3-, 4-, 5- or 6-oxaheptyl, 2-, 3-, 4-, 5-, 6- or 7-oxaoctyl, 2-, 3-, 4-, 5-, 6-, 7- or 8-oxanonyl, 2-, 3-, 4-, 5-, 6-, 7-, 8- or 9-oxadecyl.

If in the formulae shown above and below a group R including any variations thereof such as R¹, R⁰, R⁰⁰, R⁰*, R¹¹, R²², R^{C}, R³, R⁴ etc., or L denotes an alkoxy or oxaalkyl group it may also contain one or more additional oxygen atoms, provided that oxygen atoms are not linked directly to one another.

In another preferred embodiment, one or more of R including any variations thereof such as R¹, R⁰, R⁰⁰, R⁰*, R¹¹, R²², R^{C}, R³, R⁴ etc., or L are selected from the group consisting of

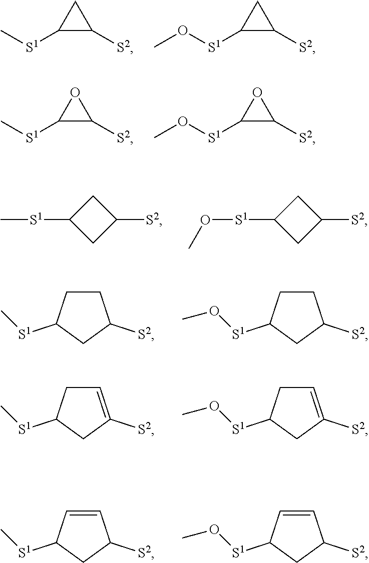

—S¹—F, —O—S¹—F, —O—S₁—O—S₂, wherein S¹ is C₁₋₁₂-alkylene or C₂₋₁₂-alkenylene and S² is H, C₁₋₁₂-alkyl or C₂₋₁₂-alkenyl, and very preferably are selected from the group consisting of

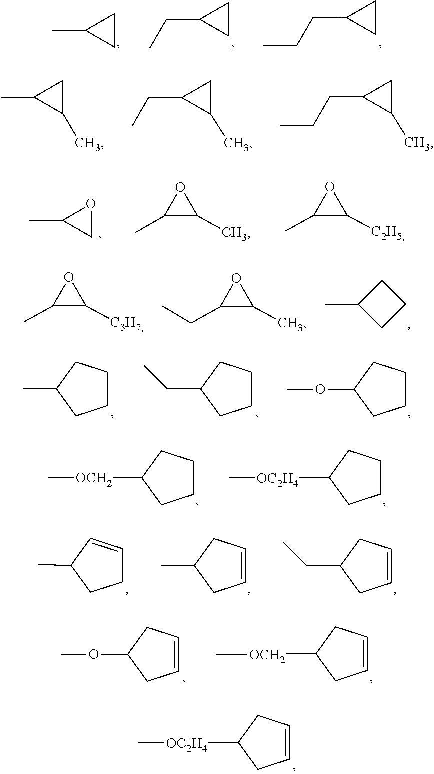

—OCH₂OCH₃, —O(CH₂)₂OCH₃, —O(CH₂)₃OCH₃, —O(CH₂)₄OCH₃, —O(CH₂)₂F, —O(CH₂)₃F and —O(CH₂)₄F.

If in the formulae shown above and below a group R including any variations thereof such as R¹, R⁰, R⁰⁰, R⁰*, R¹¹, R²², R^{C}, R³, R⁴ etc., or L denotes an alkyl radical in which one CH₂ group has been replaced by —CH═CH—, this may be straight-chain or branched. It is preferably straight-chain and has 2 to 10 C atoms. Accordingly, it denotes, in particular, vinyl, prop-1- or -2-enyl, but-1-, -2- or -3-enyl, pent-1-, -2-, -3- or -4-enyl, hex-1-, -2-, -3-, -4- or -5-enyl, hept-1-, -2-, -3-, -4-, -5- or -6-enyl, oct-1-, -2-, -3-, -4-, -5-, -6- or -7-enyl, non-1-, -2-, -3-, -4-, -5-, -6-, -7- or -8-enyl, dec-1-, -2-, -3-, -4-, -5-, -6-, -7-, -8- or -9-enyl.

If in the formulae shown above and below a group R including any variations thereof such as R¹, R⁰, R⁰⁰, R⁰*, R¹¹, R²², R^{C}, R³, R⁴ etc., or L denotes an alkyl or alkenyl radical which is at least monosubstituted by halogen, this radical is preferably straight-chain, and halogen is preferably F or Cl. In the case of polysubstitution, halogen is preferably F. The resultant radicals also include perfluorinated radicals. In the case of mono-substitution, the fluorine or chlorine substituent may be in any desired position, but is preferably in the ω-position.

Above and below,

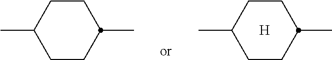

denotes a trans-1,4-cyclohexylene ring, and

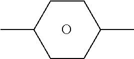

denotes a 1,4-phenylene ring.

Halogen is preferably F or Cl, very preferably F.

The group —CR⁰═CR⁰⁰— is preferably —CH═CH—.

—OC—, —CO—, —C(═O)— and —C(O)— denote a carbonyl group, i.e.

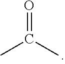

Preferred substituents L, are, for example, F, Cl, Br, I, —CN, —C(═O)N(R^{x})₂, —C(═O)Y¹, —C(═O)R^{x}, —N(R^{x})₂, straight-chain or branched alkyl, alkoxy, alkylcarbonyl, alkoxycarbonyl, alkylcarbonyloxy or alkoxycarbonyloxy each having 1 to 25 or 3 to 25 C atoms, in which one or more H atoms may optionally be replaced by F or Cl, optionally substituted silyl having 1 to 20 Si atoms, or optionally substituted aryl having 6 to 25, preferably 6 to 15, C atoms,
wherein R^{x} denotes H, F, Cl, CN, or straight chain, branched or cyclic alkyl having 1 to 25 or 3 to 25 C atoms, wherein one or more non-adjacent CH₂-groups are optionally replaced by —O—, —S—, —CO—, —CO—O—, —O—CO—, —O—CO—O— in such a manner that O- and/or S-atoms are not directly connected with each other, and wherein one or more H atoms are each optionally replaced by F, Cl, P— or P—Sp-, and Y¹ denotes halogen.

Particularly preferred substituents L are, for example, F, Cl, CN, NO₂, CH₃, C₂H₅, OCH₃, SCH₃, OC₂H₅, SC₂H₅, COCH₃, COC₂H₅, COOCH₃, COOC₂H₅, CF₃, OCF₃, OCHF₂, OC₂F₅, furthermore phenyl.

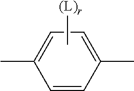

is preferably

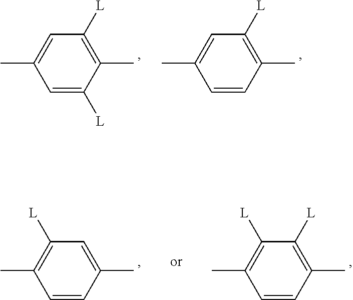

in which L has one of the meanings indicated above.

Throughout the application, the term “aryl and heteroaryl groups” encompass groups, which can be monocyclic or polycyclic, i.e., they can have one ring (such as, for example, phenyl) or two or more rings, which may also be fused (such as, for example, naphthyl) or covalently linked (such as, for example, biphenyl), or contain a combination of fused and linked rings. Heteroaryl groups contain one or more heteroatoms, preferably selected from O, N, S and Se. Particular preference is given to mono-, bi- or tricyclic aryl groups having 6 to 25 C atoms and mono-, bi- or tricyclic heteroaryl groups having 2 to 25 C atoms, which optionally contain fused rings, and which are optionally substituted. Preference is furthermore given to 5, 6 or 7-membered aryl and heteroaryl groups, in which, in addition, one or more CH groups may be replaced by N, S or O in such a way that 0 atoms and/or S atoms are not linked directly to one another. Preferred aryl groups are, for example, phenyl, biphenyl, terphenyl, [1,1′:3′,1″]¬¬terphenyl-2′-yl, naphthyl, anthracene, binaphthyl, phenanthrene, pyrene, dihydropyrene, chrysene, perylene, tetracene, pentacene, benzopyrene, fluorene, indene, indenofluorene, spirobifluorene, more preferably 1,4-phenylene, 4,4′-biphenylene, 1,4-terphenylene.

Preferred heteroaryl groups are, for example, 5 membered rings, such as pyrrole, pyrazole, imidazole, 1,2,3-triazole, 1,2,4-triazole, tetrazole, furan, thiophene, selenophene, oxazole, isoxazole, 1,2 thiazole, 1,3-thiazole, 1,2,3-oxadiazole, 1,2,4 oxadiazole, 1,2,5-oxadiazole, 1,3,4-oxadiazole, 1,2,3-thiadiazole, 1,2,4-thiadiazole, 1,2,5-thiadiazole, 1,3,4-thiadiazole, 6 membered rings, such as pyridine, pyridazine, pyrimidine, pyrazine, 1,3,5-triazine, 1,2,4-triazine, 1,2,3-triazine, 1,2,4,5-tetrazine, 1,2,3,4-tetrazine, 1,2,3,5-tetrazine, or condensed groups, such as indole, iso-indole, indolizine, indazole, benzimidazole, benzotriazole, purine, naphthimidazole, phenanthrimidazole, pyridimidazole, pyrazinimidazole, quinoxalinimidazole, benzoxazole, naphthoxazole, anthroxazole, phen-anthroxazole, isoxazole, benzothiazole, benzofuran, isobenzofuran, dibenzofuran, quinoline, isoquinoline, pteridine, benzo-5,6-quinoline, benzo-6,7-quinoline, benzo-7,8-quinoline, benzoisoquinoline, acridine, phenothiazine, phenoxazine, benzopyridazine, benzopyrimidine, quinoxaline, phenazine, naphthyridine, azacarbazole, benzocarboline, phenanthridine, phenanthroline, thieno[2,3b]thiophene, thieno[3,2b]-thiophene, dithienothiophene, isobenzothiophene, dibenzothiophene, benzothiadiazothiophene, or combinations of these groups. The heteroaryl groups may also be substituted by alkyl, alkoxy, thioalkyl, fluorine, fluoroalkyl or further aryl or heteroaryl groups.

In a group

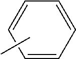

the single bond shown between the two ring atoms can be attached to any free position of the benzene ring.

—OC—, —CO—, —C(═O)— and —C(O)— denote a carbonyl group, i.e.

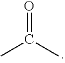

The polymerizable group P, including any variations thereof such as P⁰, P¹, P², P*⁰, is a group which is suitable for a polymerization reaction, such as, for example, free-radical or ionic chain polymerization, polyaddition or polycondensation, or for a polymer-analogous reaction, for example addition or condensation onto a main polymer chain. Particular preference is given to groups for chain polymerization, in particular those containing a C═C double bond or —C═C— triple bond, and groups which are suitable for polymerization with ring opening, such as, for example, oxetane or epoxide groups.

Preferred groups P, including any variations thereof such as P⁰, P¹, P², P*⁰, are selected from the group consisting of CH₂═CW¹—CO—O—, CH₂═CW¹—CO—,

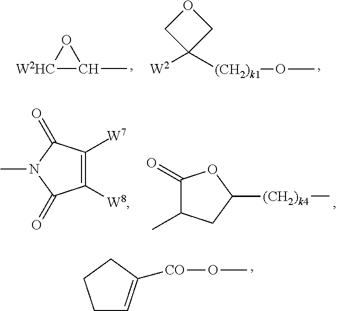

CH₂═CW²—(O)ₖ₃—, CW¹═CH—CO—(O)ₖ₃—, CW¹═CH—CO—NH—, CH₂═CW¹—CO—NH—, CH₃—CH═CH—O—, (CH₂═CH)₂CH—OCO—, (CH₂═CH—CH₂)₂CH—OCO—, (CH₂═CH)₂CH—O—, (CH₂═CH—CH₂)₂N—, (CH₂═CH—CH₂)₂N—CO—, HO—CW²W³—, HS—CW²W³—, HW²N—, HO—CW²W³—NH—, CH₂═CW¹—CO—NH—, CH₂═CH—(COO)ₖ₁-Phe-(O)ₖ₂—, CH₂═CH—(CO)ₖ₁-Phe-(O)ₖ₂—, Phe-CH═CH—, HOOC—, OCN— and W⁴W⁵W⁶Si—, in which W¹ denotes H, F, Cl, CN, CF₃, phenyl or alkyl having 1 to 5 C atoms, in particular H, F, Cl or CH₃, W² and W³ each, independently of one another, denote H or alkyl having 1 to 5 C atoms, in particular H, methyl, ethyl or n-propyl, W⁴, W⁵ and W⁶ each, independently of one another, denote Cl, oxaalkyl or oxacarbonylalkyl having 1 to 5 C atoms, W⁷ and W⁸ each, independently of one another, denote H, Cl or alkyl having 1 to 5 C atoms, Phe denotes 1,4-phenylene, which is optionally substituted by one or more radicals L as defined above which are other than P—Sp-, k₁, k₂ and k₃ each, independently of one another, denote 0 or 1, k₃ preferably denotes 1, and k₄ denotes an integer from 1 to 10.

Very preferred groups P, including any variations thereof such as P⁰, P¹, P², P*⁰, are selected from the group consisting of CH₂═CW¹—CO—O—, CH₂═CW¹—CO—,

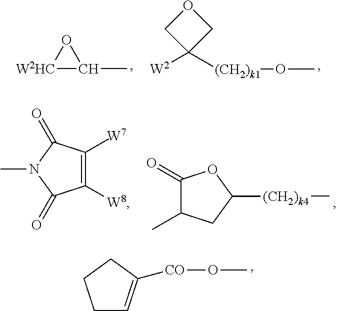

CH₂═CW²—O—, CH₂═CW²—,
CW¹═CH—CO—(O)ₖ₃—, CW¹═CH—CO—NH—, CH₂═CW¹—CO—NH—, (CH₂═CH)₂CH—OCO—, (CH₂═CH—CH₂)₂CH—OCO—, (CH₂═CH)₂CH—O—, (CH₂═CH—CH₂)₂N—, (CH₂═CH—CH₂)₂N—CO—, CH₂═CW¹—CO—NH—, CH₂═CH—(COO)ₖ₁-Phe-(O)ₖ₂—, CH₂═CH—(CO)ₖ₁-Phe-(O)ₖ₂—, Phe-CH═CH— and W⁴W⁵W⁶Si—, in which W¹ denotes H, F, Cl, CN, CF₃, phenyl or alkyl having 1 to 5 C atoms, in particular H, F, Cl or CH₃, W² and W³ each, independently of one another, denote H or alkyl having 1 to 5 C atoms, in particular H, methyl, ethyl or n-propyl, W⁴, W⁵ and W⁶ each, independently of one another, denote Cl, oxaalkyl or oxacarbonylalkyl having 1 to 5 C atoms, W⁷ and W^{a} each, independently of one another, denote H, Cl or alkyl having 1 to 5 C atoms, Phe denotes 1,4-phenylene, k₁, k₂ and k₃ each, independently of one another, denote 0 or 1, k₃ preferably denotes 1, and k₄ denotes an integer from 1 to 10.

Very particularly preferred groups P, including any variations thereof such as P⁰, P¹, P², P*⁰, are selected from the group consisting of CH₂═CW¹—CO—O—, in particular CH₂═CH—CO—O—, CH₂═C(CH₃)—CO—O— and CH₂═CF—CO—O—, furthermore CH₂═CH—O—, (CH₂═CH)₂CH—O—CO—,

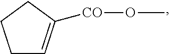

(CH₂═CH)₂CH—O—,

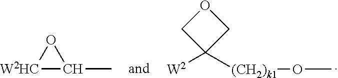

Further preferred polymerizable groups P, including any variations thereof such as P⁰, P¹, P², P*⁰, are selected from the group consisting of vinyloxy, acrylate, methacrylate, fluoroacrylate, chloroacrylate, oxetane and epoxide, most preferably from acrylate and methacrylate.

In another preferred embodiment of the invention, in a polymerizable compound as disclosed above and below, including compounds of formula I and its subformulae, all polymerizable groups have the same meaning, and preferably denote acrylate or methacrylate, very preferably acrylate.

The spacer group, including any variations thereof such as Sp⁰, Sp¹, Sp², Sp*⁰, when being different from a single bond, is preferably of the formula Sp″—X″, so that the respective radical P—Sp- etc. conforms to the formula P—Sp″—X″—, wherein
Sp″ denotes linear or branched alkylene having 1 to 20 or 3 to 20, preferably 1 to 12 or 1 to 12, C atoms, which is optionally mono- or polysubstituted by F, Cl, Br, I or CN and in which, in addition, one or more non-adjacent CH₂ groups may each be replaced, independently of one another, by —O—, —S—, —NH—, —N(R⁰)—, —Si(R⁰R⁰⁰)—, —CO—, —CO—O—, —O—CO—, —O—CO—O—, —S—CO—, —CO—S—, —N(R⁰⁰)—CO—O—, —O—CO—N(R⁰)—, —N(R⁰)—CO—N(R⁰⁰)—, —CH═CH— or —C═C— in such a way that O and/or S atoms are not linked directly to one another,
X″ denotes —O—, —S—, —CO—, —CO—O—, —O—CO—, —O—CO—O—, —CO—N(R⁰)—, —N(R⁰)—CO—, —N(R⁰)—CO—N(R⁰⁰)—, —OCH₂—, —CH₂O—, —SCH₂—, —CH₂S—, —CF₂O—, —OCF₂—, —CF₂S—, —SCF₂—, —CF₂CH₂—, —CH₂CF₂—, —CF₂CF₂—, —CH═N—, —N═CH—, —N═N—, —CH═CR⁰—, —CY²═CY³—, —C≡C—, —CH═CH—CO—O—, —O—CO—CH═CH— or a single bond,
R⁰ and R⁰⁰ each, independently of one another, denote H or alkyl having 1 to 20 C atoms, and
Y² and Y³ each, independently of one another, denote H, F, Cl or CN.
X″ is preferably —O—, —S—, —CO—, —COO—, —OCO—, —O—COO—, —CO—NR⁰—, —NR⁰—CO—, —NR⁰—CO—NR⁰⁰— or a single bond.

Typical spacer groups Sp, including any variations thereof such as Sp⁰, Sp¹, Sp², Sp*⁰, and —Sp″—X″— are, for example, —(CH₂)ₚ₁—, —(CH₂)ₚ₁—O—, —(CH₂)ₚ₁—O—CO—, —(CH₂)ₚ₁—CO—O—, —(CH₂)ₚ₁—O—CO—O—, —(CH₂CH₂O)_{q1}—CH₂CH₂—, —CH₂CH₂—S—CH₂CH₂—, —CH₂CH₂—NH—CH₂CH₂— or —(SiR⁰R⁰⁰—O)ₚ₁—, in which p1 is an integer from 1 to 12, q1 is an integer from 1 to 3, and R⁰ and R⁰⁰ have the meanings indicated above.

Particularly preferred groups Sp, including any variations thereof such as Sp⁰, Sp¹, Sp², Sp*⁰, and —Sp″—X″— are —(CH₂)ₚ₁—, —(CH₂)ₚ₁—O—, —(CH₂)ₚ₁—O—CO—, —(CH₂)ₚ₁—CO—O—, —(CH₂)ₚ₁—O—CO—O—, in which p1 and q1 have the meanings indicated above.

Particularly preferred groups Sp″ are, in each case straight-chain, ethylene, propylene, butylene, pentylene, hexylene, heptylene, octylene, nonylene, decylene, undecylene, dodecylene, octadecylene, ethyleneoxyethylene, methyleneoxybutylene, ethylenethioethylene, ethylene-N-methyliminoethylene, 1-methylalkylene, ethenylene, propenylene and butenylene.

In another preferred embodiment of the invention, the polymerizable compounds as disclosed above and below, including compounds of formula I and its subformulae, contain a spacer group Sp, including any variations thereof such as Sp⁰, Sp¹, Sp², Sp*⁰, that is substituted by one or more polymerizable groups P, so that the group Sp-P etc. corresponds to Sp(P)ₛ, with s being ≥2 (branched polymerizable groups).

Preferred polymerizable compounds according to this preferred embodiment are those wherein s is 2, i.e., compounds which contain a group Sp(P)₂. Very preferred polymerizable compounds according to this preferred embodiment contain a group selected from the following formulae:

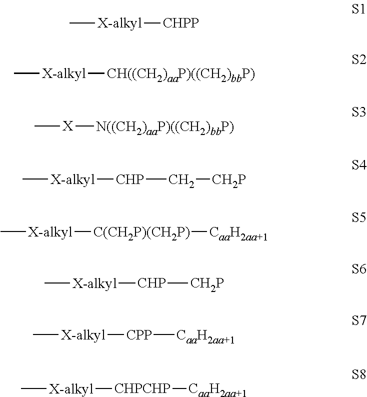

in which P is as defined in formula I,
alkyl denotes a single bond or straight-chain or branched alkylene having 1 to 12 or 3 to 12 C atoms which is unsubstituted or mono- or polysubstituted by F, Cl or CN and in which one or more non-adjacent CH₂ groups may each, independently of one another, be replaced by —C(R⁰)═C(R⁰)—, —C≡C—, —N(R⁰)—, —O—, —S—, —CO—, —CO—O—, —O—CO—, —O—CO—O— in such a way that O and/or S atoms are not linked directly to one another, where R⁰ has the meaning indicated above,
aa and bb each, independently of one another, denote 0, 1, 2, 3, 4, 5 or 6,
X has one of the meanings indicated for X″, and is preferably 0, CO, SO₂, O—CO—, CO—O or a single bond.

Preferred spacer groups Sp(P)₂ are selected from formulae S1, S2 and S3.

Very preferred spacer groups Sp(P)₂ are selected from the following subformulae:

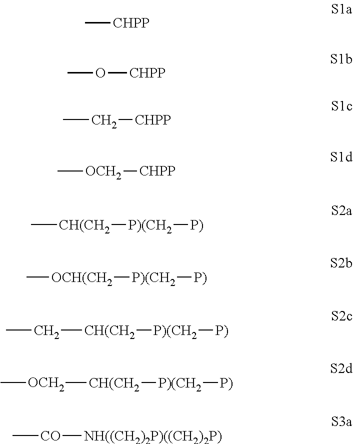

### DETAILED DESCRIPTION

The RM mixtures according to the present invention, and the RM formulations and polymer films prepared therefrom, enable the preparation of multiple-layer PBGs formed from multiple chiral RM layers coated on top of each other, which show uniform alignment with good intermolecular forces and good alignment transfer between the RM layers, wherein alignment defects like streaks or a schlieren texture and damage in the lower RM layers can be reduced or even entirely avoided.

In particular, it has surprisingly been found that the combination of one or direactive RMs of formula I, i.e., having two terminal polymerizable groups, and one or more monoreactive compounds of formula I having a terminal polymerizable group and a terminal polar group like methoxy, enables particularly good planar alignment of the chiral RM mixture and leads to significantly improved inter-layer alignment transfer between the chiral RM layers with less or even without alignment defects.

Compared thereto, e.g., a chiral RM mixture containing a monoreactive RM with a longer or bulkier terminal alkyl or alkoxy group shows increased misalignment with defects like streaks or a schlieren texture and fail to provide good PBG alignment.

Therefore, in a preferred embodiment of the present invention, the RM mixture comprises one or more compounds of formula I1 and one or more compounds of formula I2

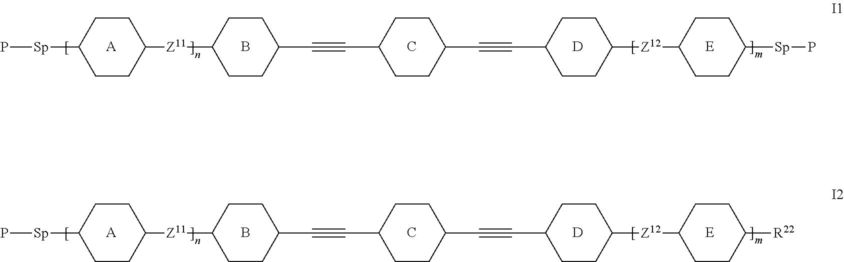

wherein P, Sp-, A, B, C, D, E, Z¹¹, Z¹², n and m have the meanings given in formula I or one of the preferred meanings given above and below, and R²² denotes CN or alkoxy or thioalkyl with 1 or 2 C atoms which is optionally fluorinated, preferably OCH₃, OCF₃, SCH₃, OC₂H₅ or SC₂H₅, very preferably OCH₃ or SCH₃, most preferably OCH₃.

Further preferably the RM mixture according to the present invention contains less than 10%, preferably less than 5%, very preferably less than 1%, of a compound of formula I3

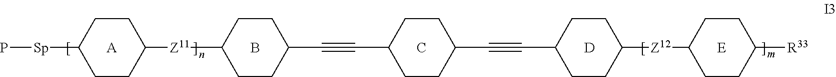

wherein P, Sp-, A, B, C, D, E, Z¹¹, Z¹², n and m have the meanings given in formula I and R³³ denotes alkyl or alkoxy with three or more C atoms which is preferably branched or cyclic.

Most preferably the RM mixture according to the present invention does not contain a compound of formula I3.

In the compounds of formulae I, I1 and I2 and their subformulae as described above and below, P is preferably selected from the group consisting of vinyloxy, acrylate, methacrylate, fluoroacrylate, chloroacrylate, oxetane and epoxide, very preferably from acrylate and methacrylate, most preferably acrylate.

Further preferred are compounds of formula I, I1 and I2 and their subformulae as described above and below, wherein all polymerizable groups P that are present in the compound have the same meaning, and very preferably denote acrylate or methacrylate, most preferably acrylate.

Further preferred are compounds of formula I, I1 and I2 and their subformulae as described above and below, which contain one, two, three or four groups P—Sp, very preferably two or three groups P—Sp.

Further preferred are compounds of formula I and their subformulae as described above and below, wherein R¹¹ is P—Sp-.

Further preferred are compounds of formula I2 and their subformulae as described above and below, wherein R²² is OCH₃ or SCH₃, very preferably OCH₃.

Further preferred are compounds of formula I, I1 and I2 and their subformulae as described above and below, wherein Sp denotes a single bond or —(CH₂)ₚ₁—, —O—(CH₂)ₚ₁—, —O—CO—(CH₂)ₚ₁, or —CO—O—(CH₂)ₚ₁, wherein p1 is 2, 3, 4, 5 or 6, and, if Sp is —O—(CH₂)ₚ₁—, —O—CO—(CH₂)ₚ₁ or —CO—O—(CH₂)ₚ₁ the O-atom or CO-group, respectively, is linked to the benzene ring.

Further preferred are compounds of formula I, I1 and I2 and their subformulae as described above and below, wherein at least one group Sp is a single bond.

Further preferred are compounds of formula I, I1 and I2 and their subformulae as described above and below, wherein at least one group Sp is a single bond and at least one group Sp is different from a single bond.

Further preferred are compounds of formula I, I1 and I2 and their subformulae as described above and below, wherein at least one group Sp is different from a single bond, and is selected from —(CH₂)ₚ₁—, —O—(CH₂)ₚ₁—, —O—CO—(CH₂)ₚ₁, or —CO—O—(CH₂)ₚ₁, wherein p1 is an integer from 2 to 10, preferably 2, 3, 4, 5 or 6, and, if Sp is —O—(CH₂)ₚ₁—, —O—CO—(CH₂)ₚ₁ or —CO—O—(CH₂)ₚ₁ the O-atom or CO-group, respectively, is linked to the benzene ring.

Further preferred are compounds of formula I, I1 and I2 and their subformulae as described above and below, wherein L is P—Sp-, —CN, or straight chain, branched or cyclic alkyl having 1 to 25 or 3 to 25 C atoms, wherein one or more non-adjacent CH₂-groups are optionally replaced by —O—, —S—, —CO—, —CO—O—, —O—CO—, —O—CO—O—, CR⁰═CR⁰⁰—, —C≡C—,

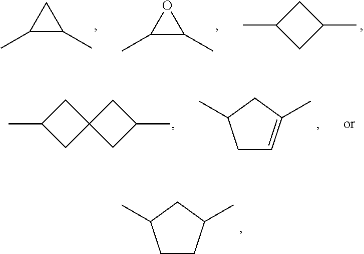

in such a manner that O- and/or S-atoms are not directly connected with each other, and wherein one or more H atoms are each optionally replaced by P—Sp-, F or Cl, or two substituents L that are connected to directly adjacent C atoms may also form a cycloalkyl or cycloalkenyl group with 5, 6, 7 or 8 C atoms.

Very preferred are compounds of formula I, I1 and I2 and their subformulae as described above and below, wherein L is straight chain alkyl, alkoxy or thioalkyl having 1 to 6 C atoms, or branched or cyclic alkyl, alkoxy or thioalkyl having 3 to 8 C atoms.

Further preferred are compounds of formula I, I1 and I2 and their subformulae as described above and below, wherein Z¹¹ and Z¹² denote —COO—, —OCO—, —C═C— or a single bond, more preferably —C═C— or a single bond, most preferably a single bond.

Ring C in formula I, I1 and I2 is preferably selected from the group consisting of benzene-1,4-diyl, naphthalene-1,4-diyl or anthracene-9,10-diyl, all of which are optionally substituted by one or more groups L or P—Sp.

If ring C is a benzene ring, it is preferably mono- or disubstituted by L.

Preferably A, B, C, D and E in formula I, I1 and I2 are selected from the group consisting of

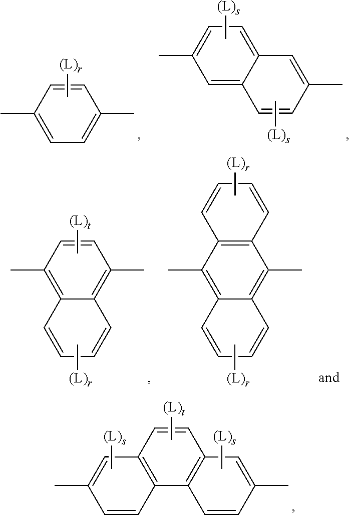

wherein the individual radicals, independently of each other and on each occurrence identically or differently, have the following meanings
L P—Sp-, —CN, F, Cl, or alkyl, alkoxy or thioalkyl which is optionally fluorinated and has 1 to 6, preferably 1 to 3, more preferably 1 or 2 C atoms, preferably P—Sp-, —CN, F, Cl, OCH₃, SCH₃, C₂H₅, OC₂H₅, SC₂H₅,
r 0, 1, 2, 3 or 4, preferably 0, 1 or 2,
s 0, 1, 2 or 3, preferably 0 or 1,
t 0, 1 or 2, preferably 0 or 1.

More preferably one or both of rings A, B, C, D and/or E in formula I, I1 and I2 are selected from the group consisting of

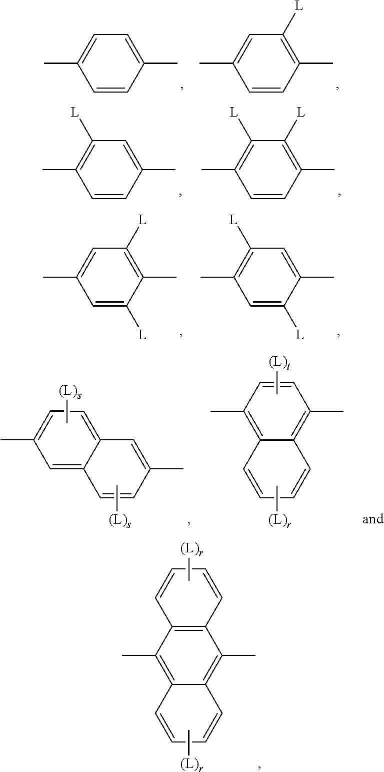

wherein L, on each occurrence identically or differently, denotes P—Sp-, —CN, F, Cl, or alkyl, alkoxy or thioalkyl which is optionally fluorinated and has 1 to 6, preferably 1 to 3, more preferably 1 or 2 C atoms, preferably P—Sp-, —CN, F, Cl, OCH₃, SCH₃, C₂H₅, OC₂H₅, SC₂H₅.

Especially preferred are compounds of formula I, I1 and I2 wherein one or both of rings B and D denote a benzene-1,4-diyl, naphthalene-1,4-diyl, naphthalene-2,6-diyl or anthracene-9,10-diyl radical which is optionally mono- or disubstituted by L as defined above.

Further preferred are compounds of formula I, I1 and I2 wherein ring C denotes a benzene-1,4-diyl, naphthalene-1,4-diyl, naphthalene-2,6-diyl or anthracene-9,10-diyl radical which is optionally mono- or disubstituted by L as defined above.

Further preferred are compounds of formula I, I1 and I2, preferably those wherein n=m=0, wherein the rings B, C and D form a group selected from the following formulae or their mirror images:

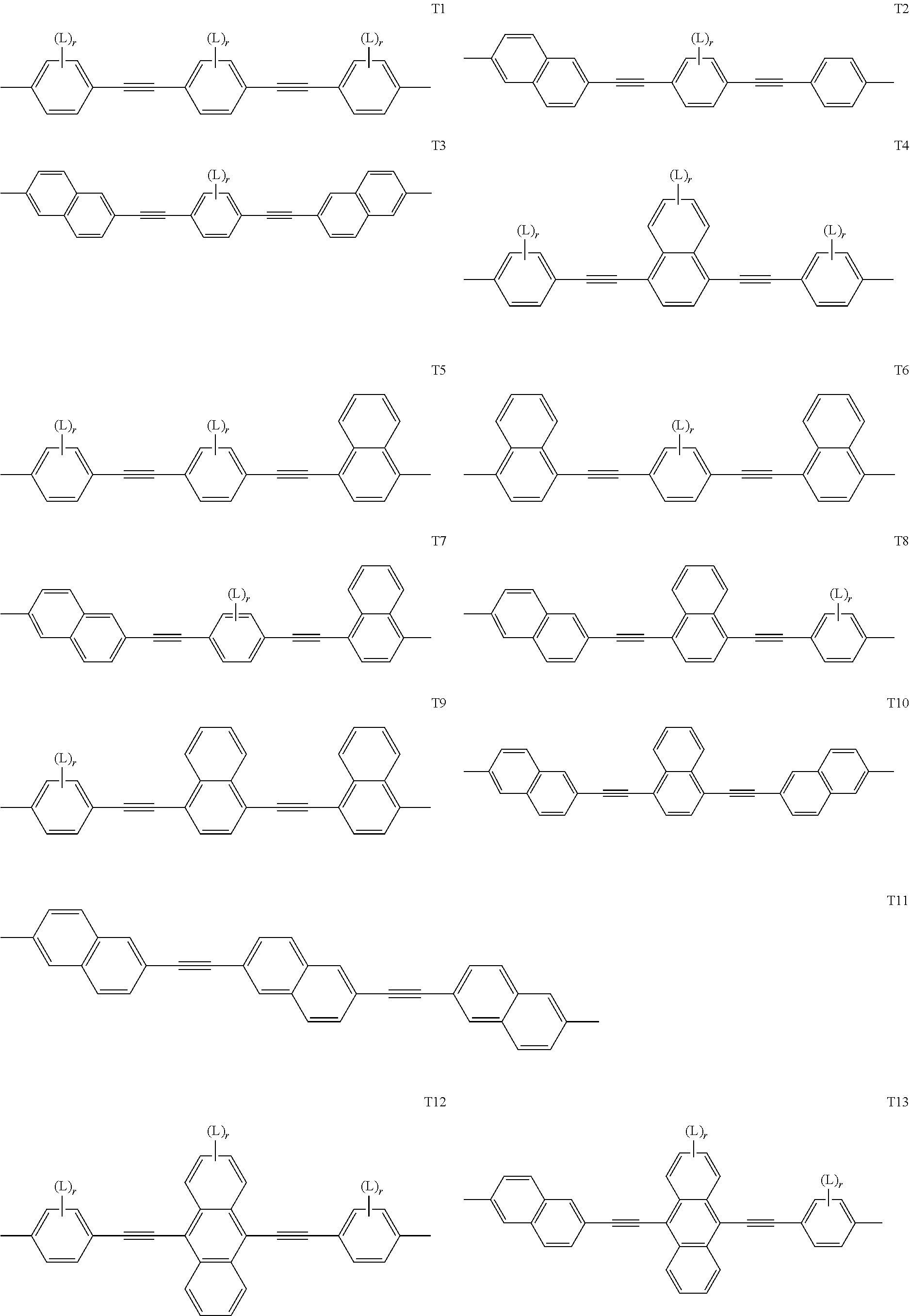

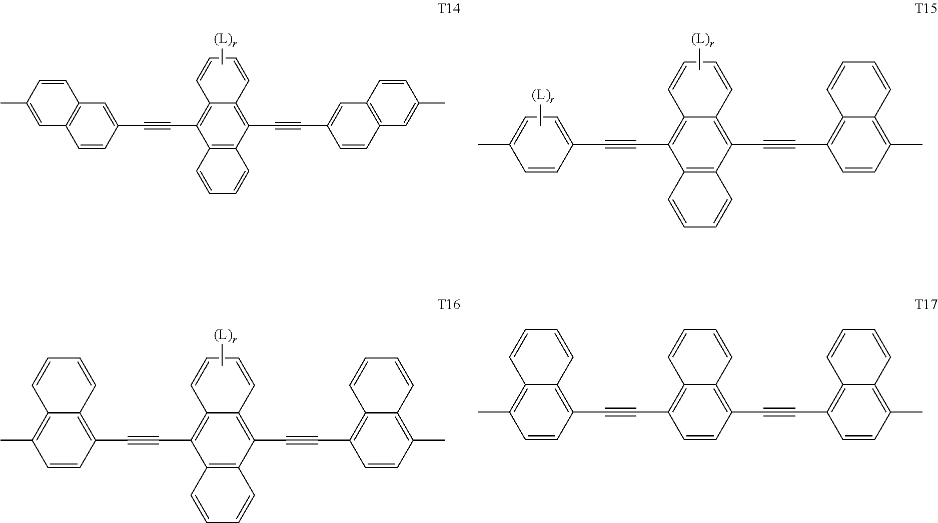

wherein the naphthalene rings are optionally substituted with one or two groups L, and L, on each occurrence identically or differently, denotes P-Sp-, —CN, F, Cl, or alkyl, alkoxy or thioalkyl which is optionally fluorinated and has 1 to 6, preferably 1 to 3, more preferably 1 or 2 C atoms, preferably P—Sp-, —CN, F, Cl, OCH₃, SCH₃, C₂H₅, OC₂H₅, SC₂H₅, and r is 0, 1, 2 or 3 preferably 0, 1 or 2. L is preferably alkyl, alkoxy or thioalkyl having 1, 2, 3 or C atoms, very preferably methyl, ethyl, methoxy, ethoxy, thiomethyl or thioethyl, most preferably methyl or ethyl.

Especially preferred are the groups of formulae T1 to T7.

Preferred compounds of formula I and I1 are selected from the following subformulae:

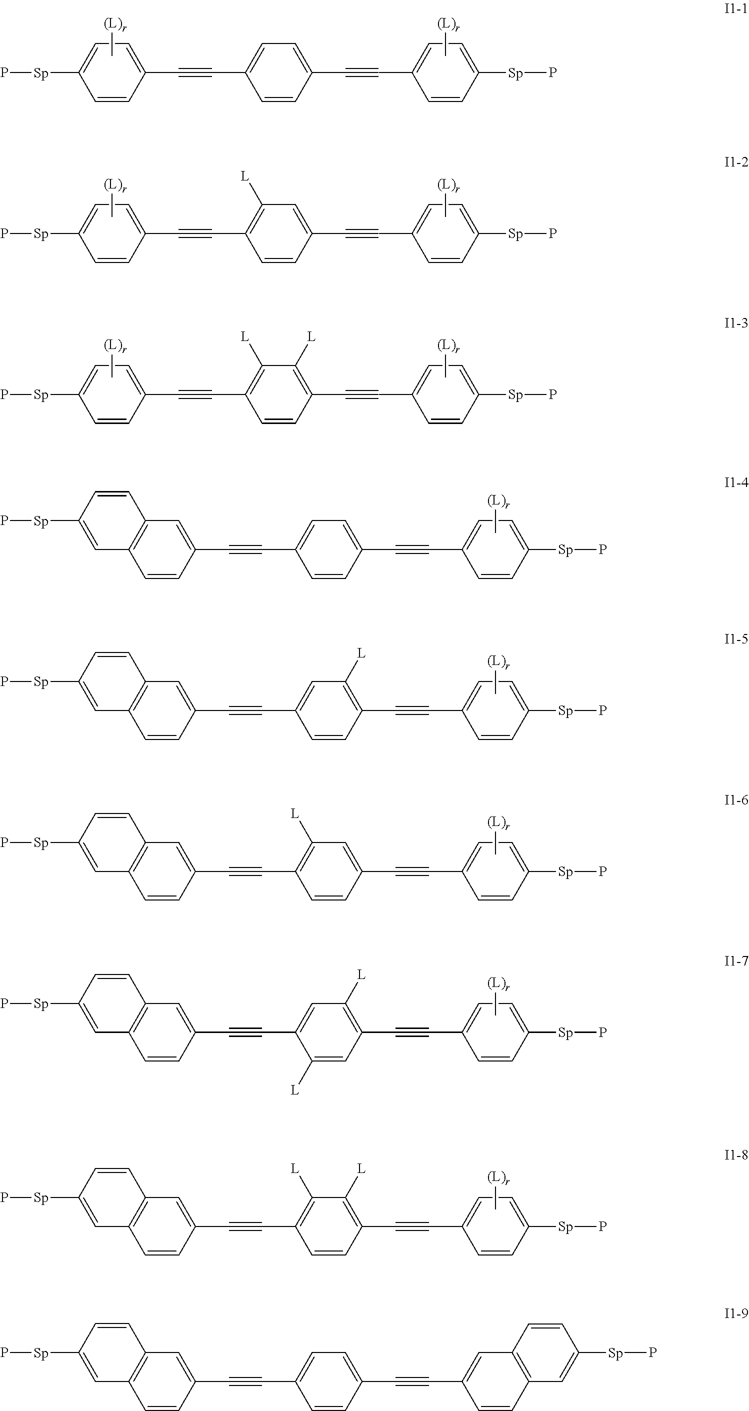

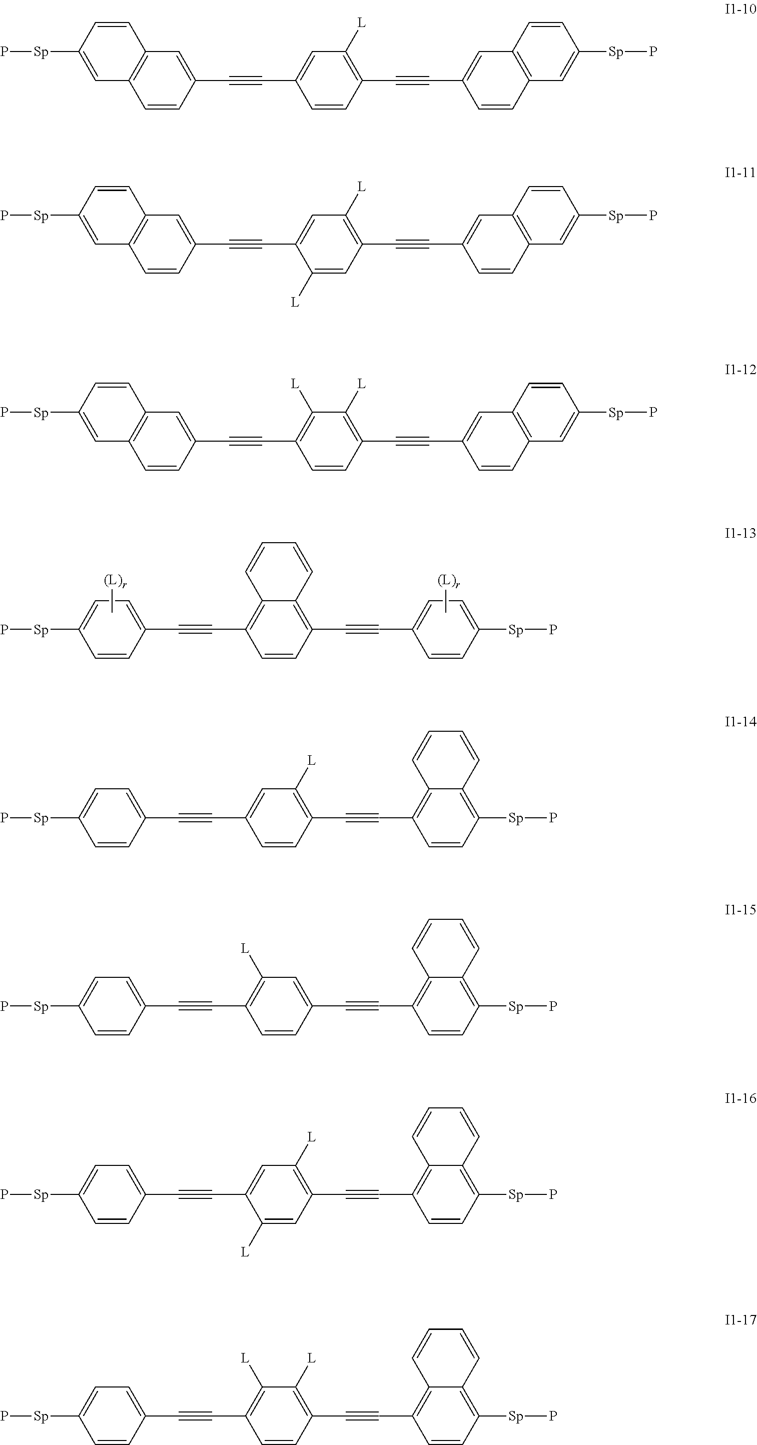

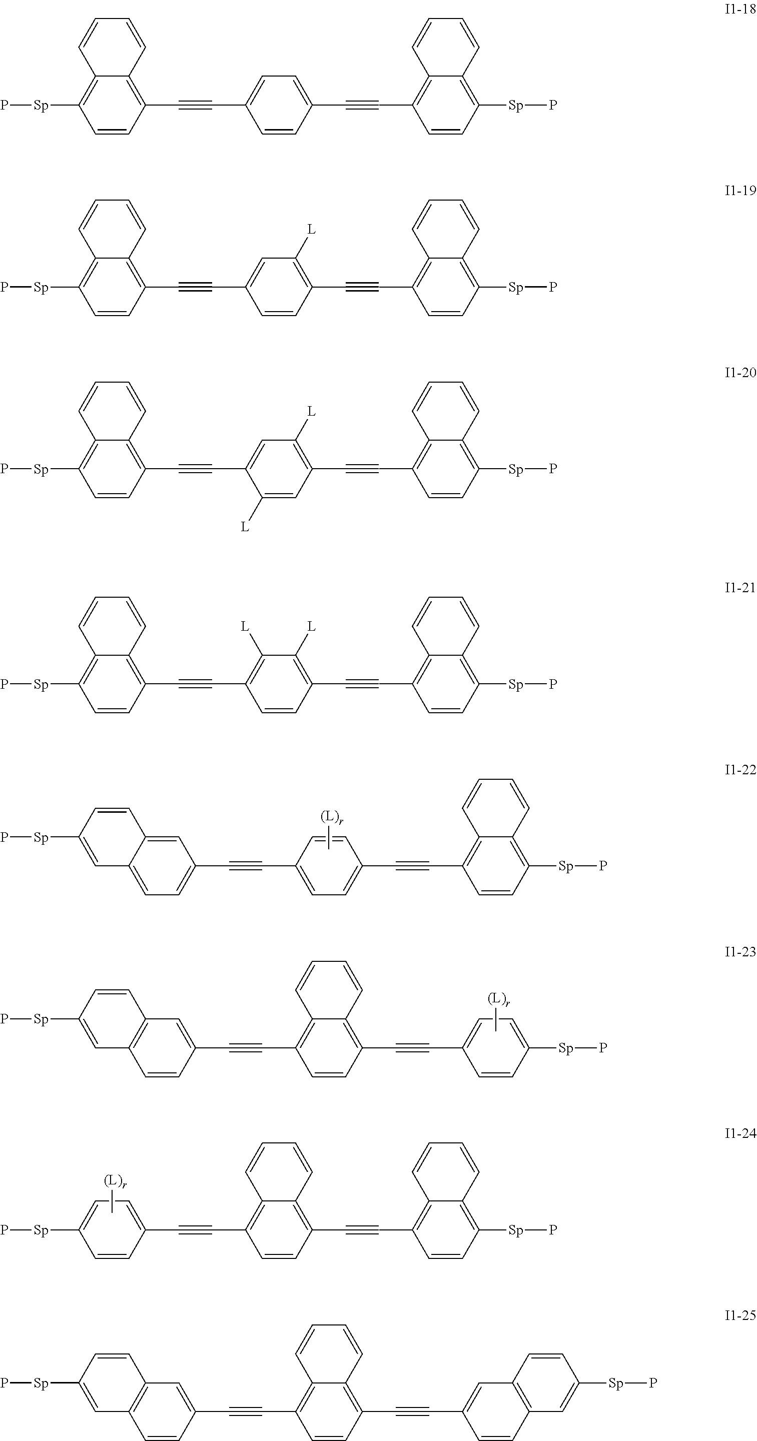

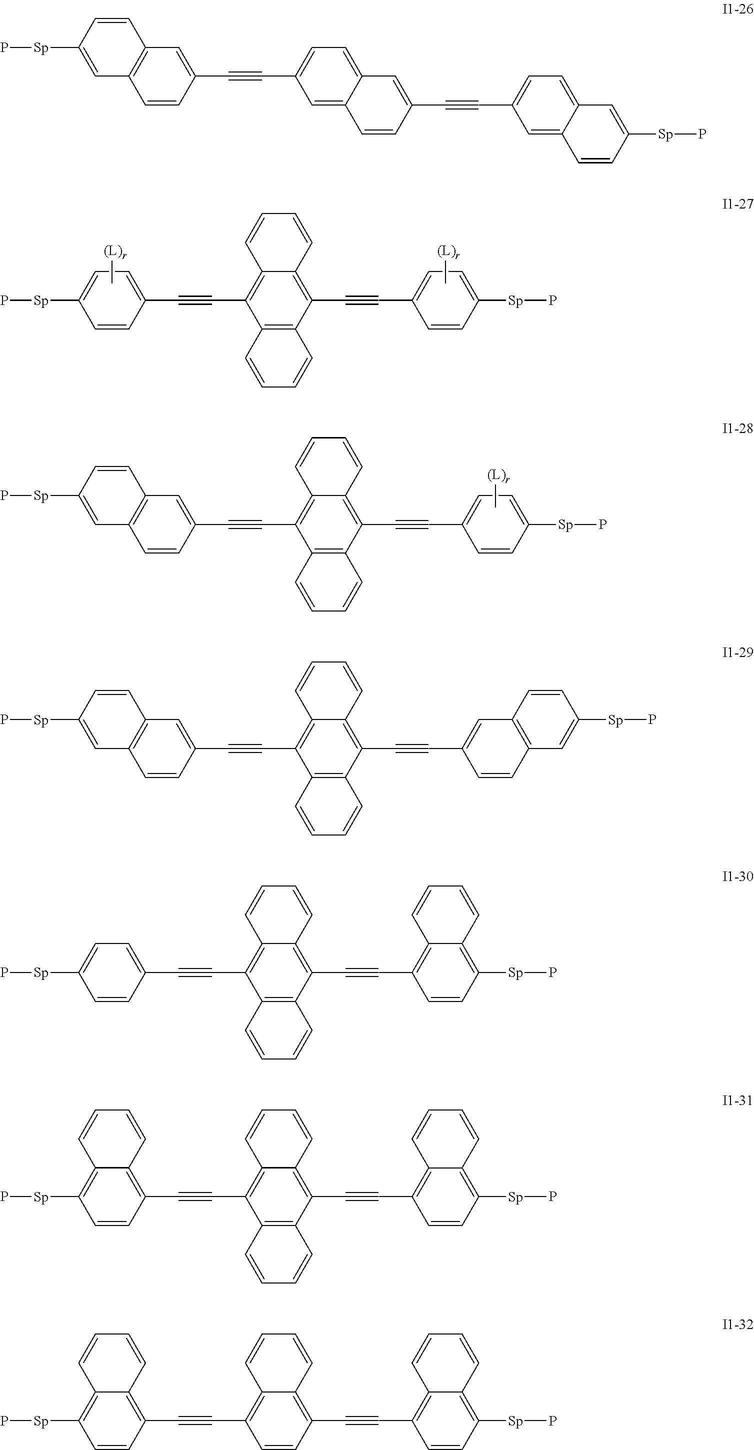

wherein the naphthalene rings are optionally substituted with one or two groups L, and P, Sp, L and r, independently of each other and on each occurrence identically or differently, have the meanings given in formula I or one of the preferred meanings given above and below. L is preferably selected from alkyl, alkoxy or thioalkyl having 1 to 6, more preferably 1, 2 or 3 C atoms, very preferably from methyl or ethyl. P is preferably acrylate.

Further preferred are compounds of the formulae I1 and I1-1 to I1-32 wherein one of the two groups Sp is a single bond and the other group Sp is different from a single bond.

Very preferred compounds of formula I and I2 are selected from the following subformulae:

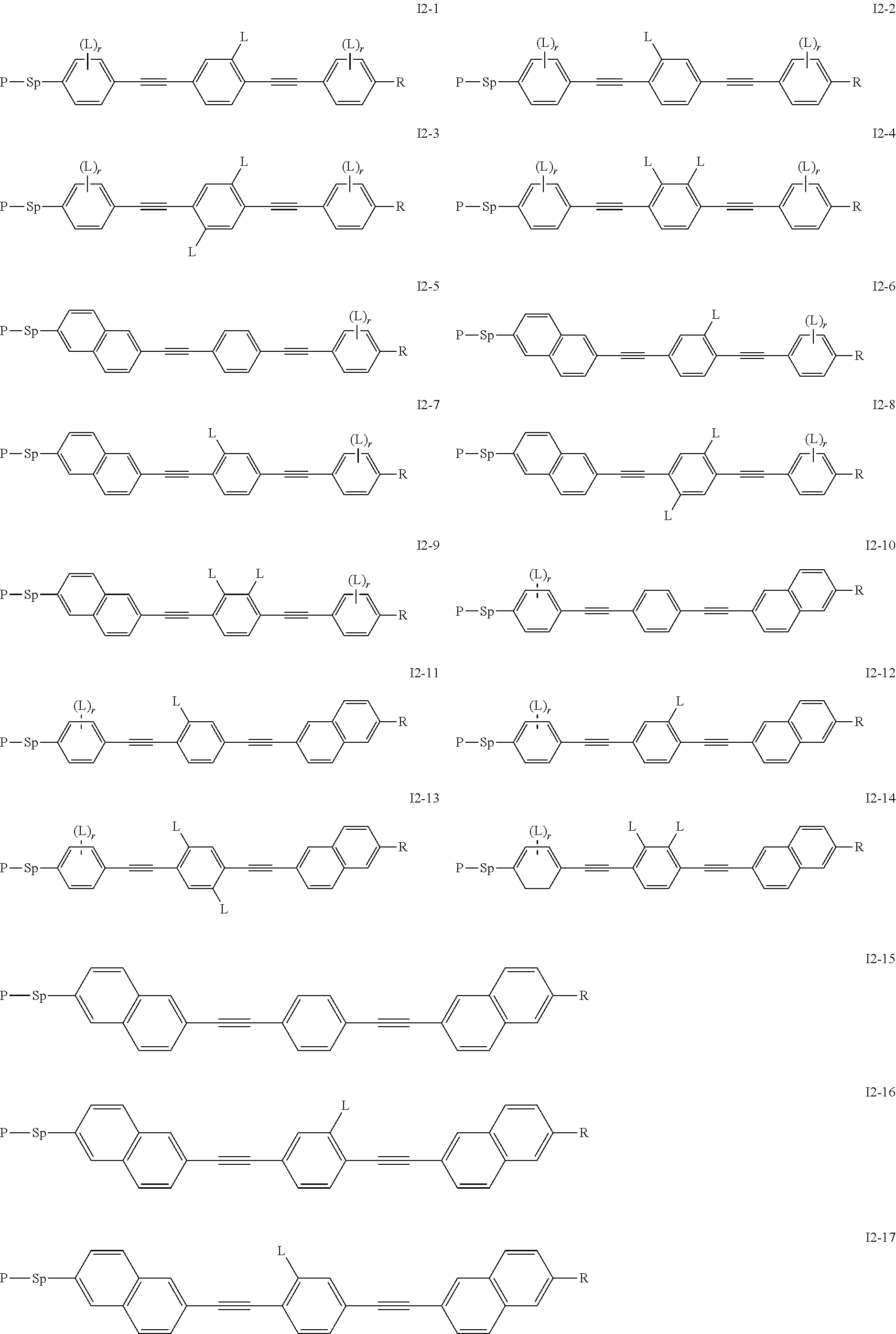

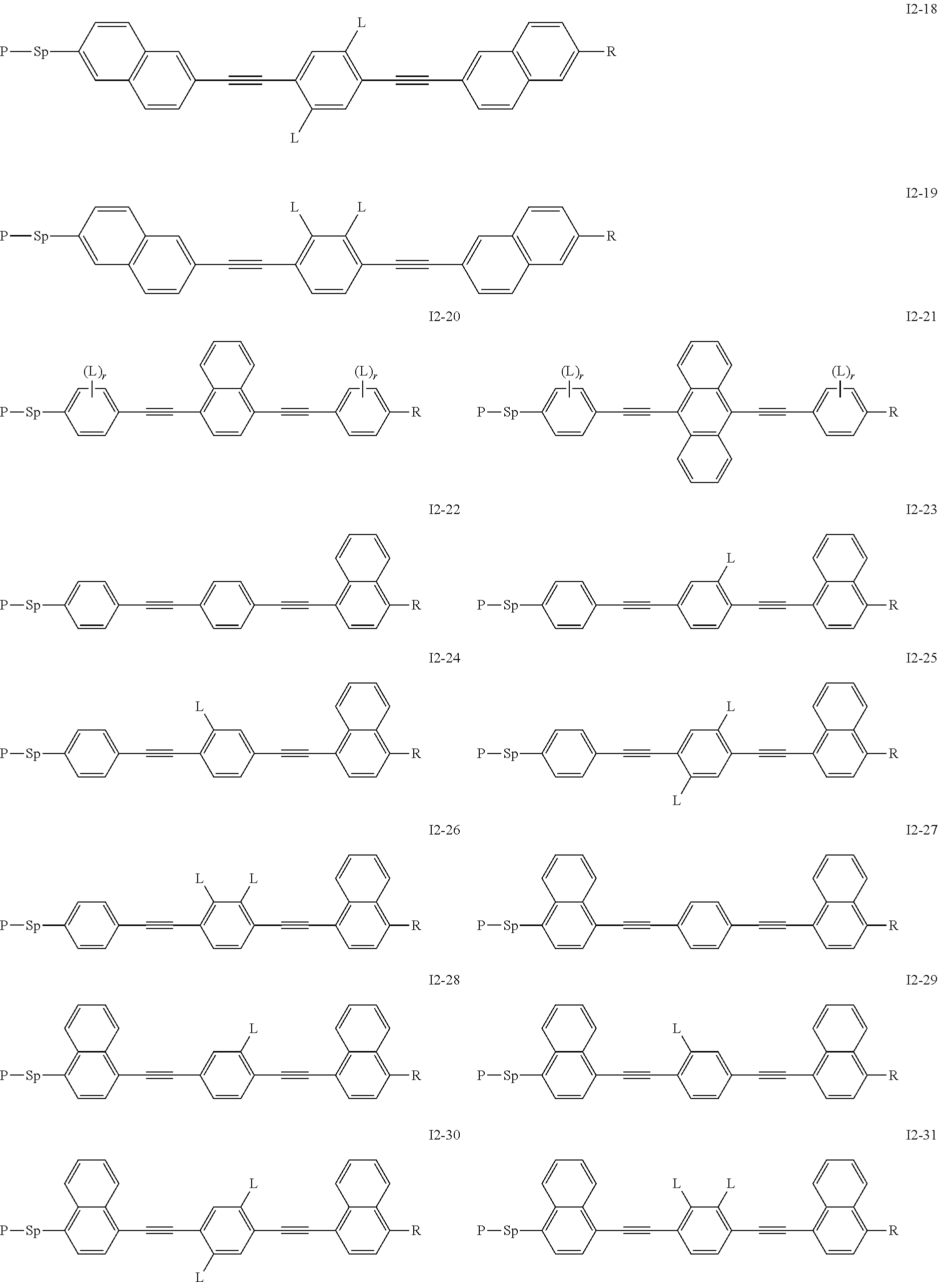

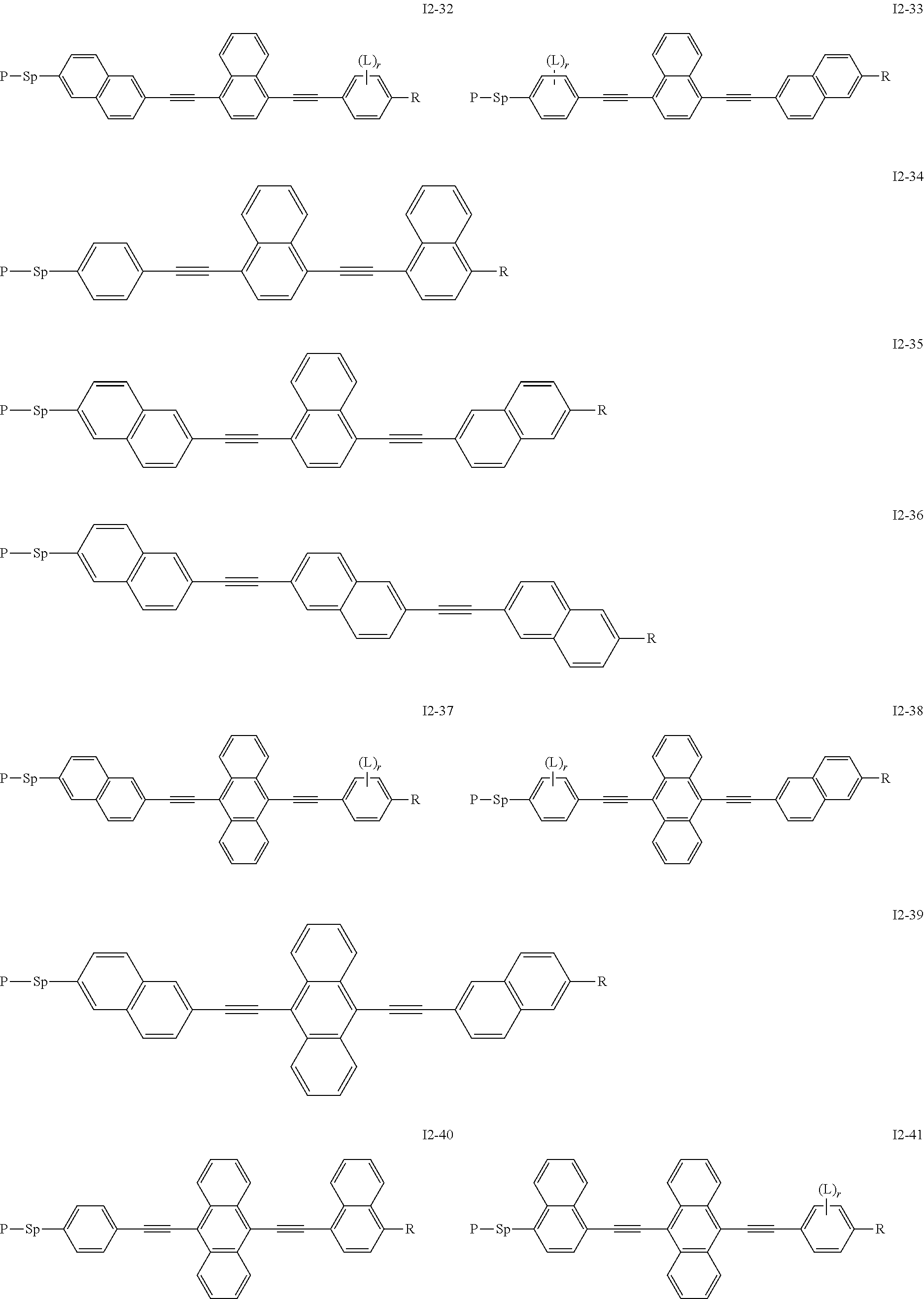

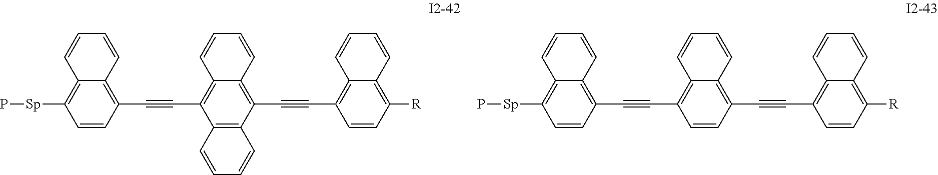

wherein the naphthalene rings are optionally substituted with one or two groups L, and P, Sp, L and r, independently of each other and on each occurrence identically or differently, have the meanings given in formula I or one of the preferred meanings given above and below, and R has one of the meanings given for R²² as given in formula I2, and preferably denotes OCH₃ or SCH₃, very preferably OCH₃. L is preferably selected from alkyl, alkoxy or thioalkyl having 1 to 6, more preferably 1, 2 or 3 C atoms, very preferably from methyl or ethyl. P is preferably acrylate.

Further preferred are compounds of the formulae I2 and I2-1 to I2-43 wherein Sp is a single bond.

Further preferred compounds of the formulae I, I1, I2, I1-1 to I1-32 and I2-1 to I2-43 are selected from the following preferred embodiments including any combination thereof:
n=m=0, or
n=1 and m=0, or
n=m=1, and/or
one of ring B and ring D is a single bond, and/or
ring C denotes naphthalene-1,4-diyl or anthracene-9,10-diyl, or
ring C denotes benzene-1,4-diyl which is substituted by alkyl, alkoxy or thioalkyl with 1 to 3, preferably 1 or 2 C atoms, more preferably methyl or ethyl, most preferably ethyl, and/or
at least one of the rings B and D denotes naphthalene-1,4-diyl, naphthalene-2,6-diyl, or anthracene-9,10-diyl, which is optionally substituted by one or more groups L or P—Sp-, and/or
at least one of the rings B, C and D denotes naphthalene-1,4-diyl, naphthalene-2,6-diyl, or anthracene-9,10-diyl, which is optionally substituted by one or more groups L or P—Sp-, and/or at least one of the rings B, C and D is benzene-1,4-diyl that is substituted with an ethyl group,
P denotes acrylate or methacrylate and/or
Sp denotes Sp″—X″, preferably, —Sp″—X″— denotes —(CH₂)ₚ₁—, —(CH₂)ₚ₁—O—, —(CH₂)ₚ₁—O—CO—, —(CH₂)ₚ₁—CO—O—, —(CH₂)ₚ₁—O—CO—O—, —(CH₂CH₂O)_{q1}—CH₂CH₂—, —CH₂CH₂—S—CH₂CH₂—, or —CH₂CH₂—NH—CH₂CH₂—, in which p1 is an integer from 1 to 12, q1 is an integer from 1 to 3, and/or
if R¹¹ or R is P—Sp-, both groups P—Sp- are identical, or
if R¹¹ or R is P—Sp-, one of the groups Sp is a single bond and the other of the groups Sp is different from a single bond, and/or
L is selected from methyl, ethyl, methoxy, ethoxy, thiomethyl or thiomethyl, more preferably methyl or ethyl, very preferably ethyl, and r denotes 1, and/or
L is selected from methyl, ethyl, methoxy, ethoxy, thiomethyl or thiomethyl, more preferably methyl or ethyl, very preferably ethyl, and r denotes 2, and/or
ring C is substituted by one L which denotes P—Sp-, preferably acrylate, and/or
R¹¹ is P—Sp-, or
R¹¹ is F, Cl, CN, OCH₃ or SCH₃, preferably OCH₃ or SCH₃, very preferably OCH₃, and/or
R²² is OCH₃ or SCH₃, preferably OCH₃.

Very preferred compounds of formula I and I1 are listed below:

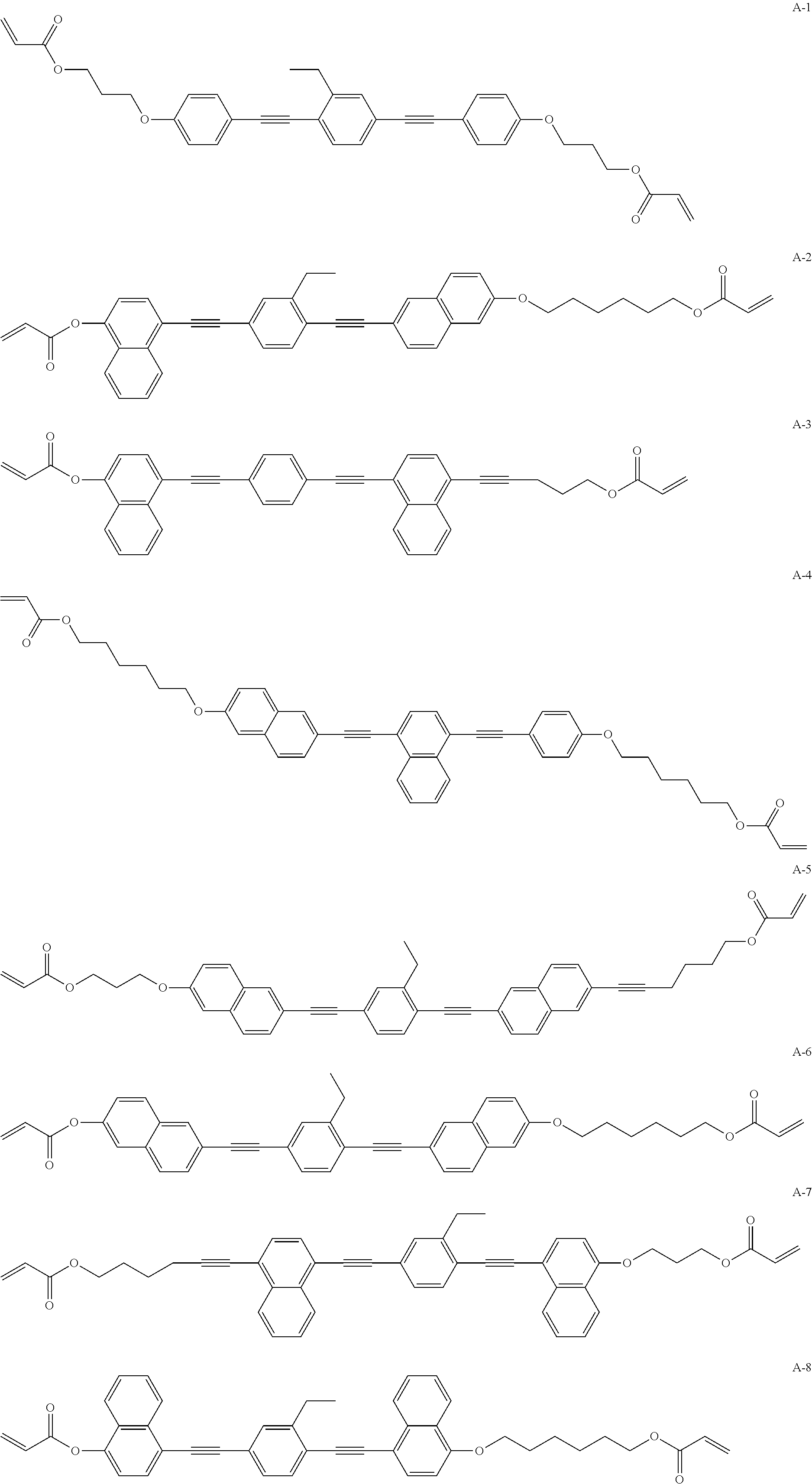

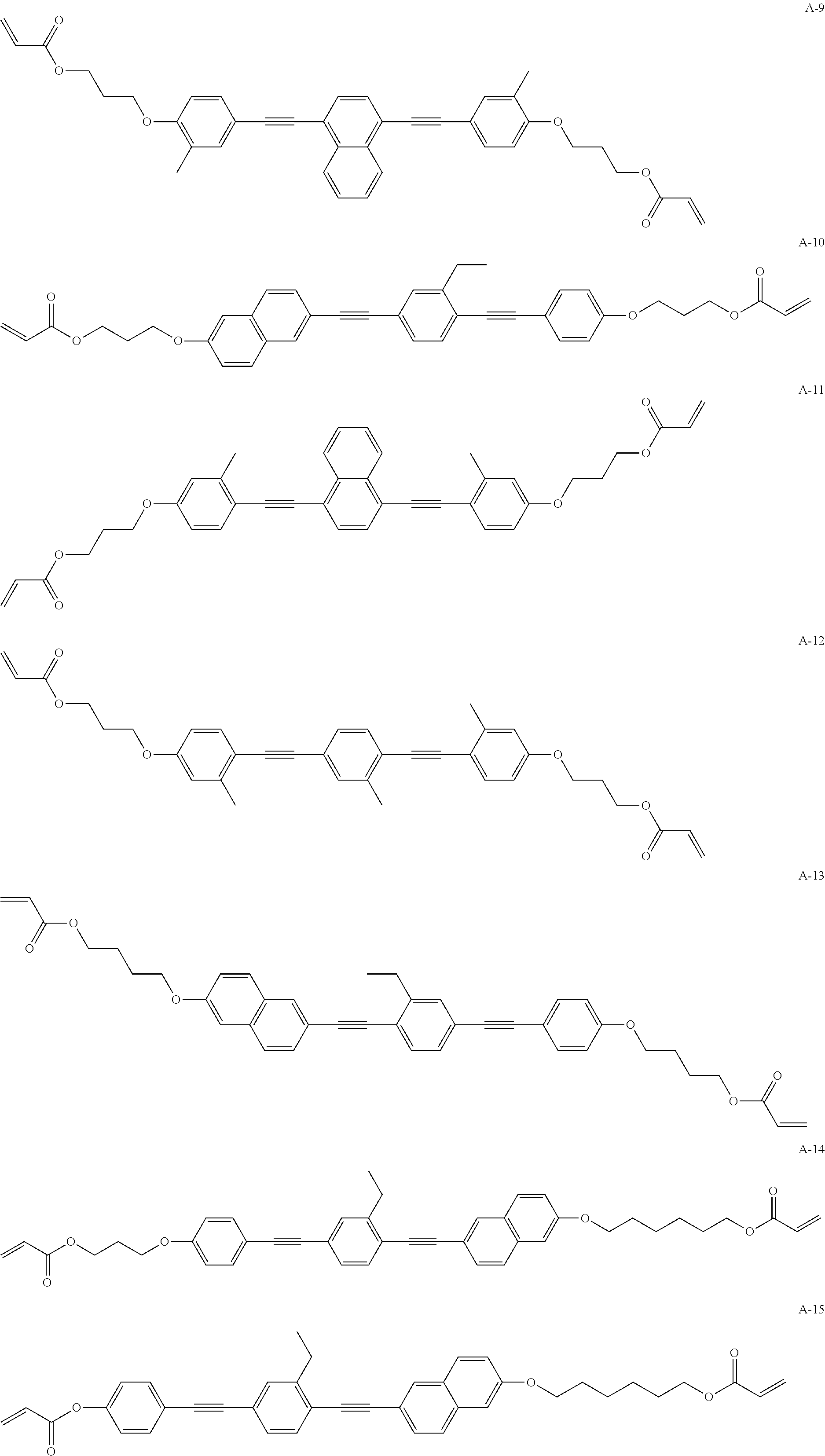

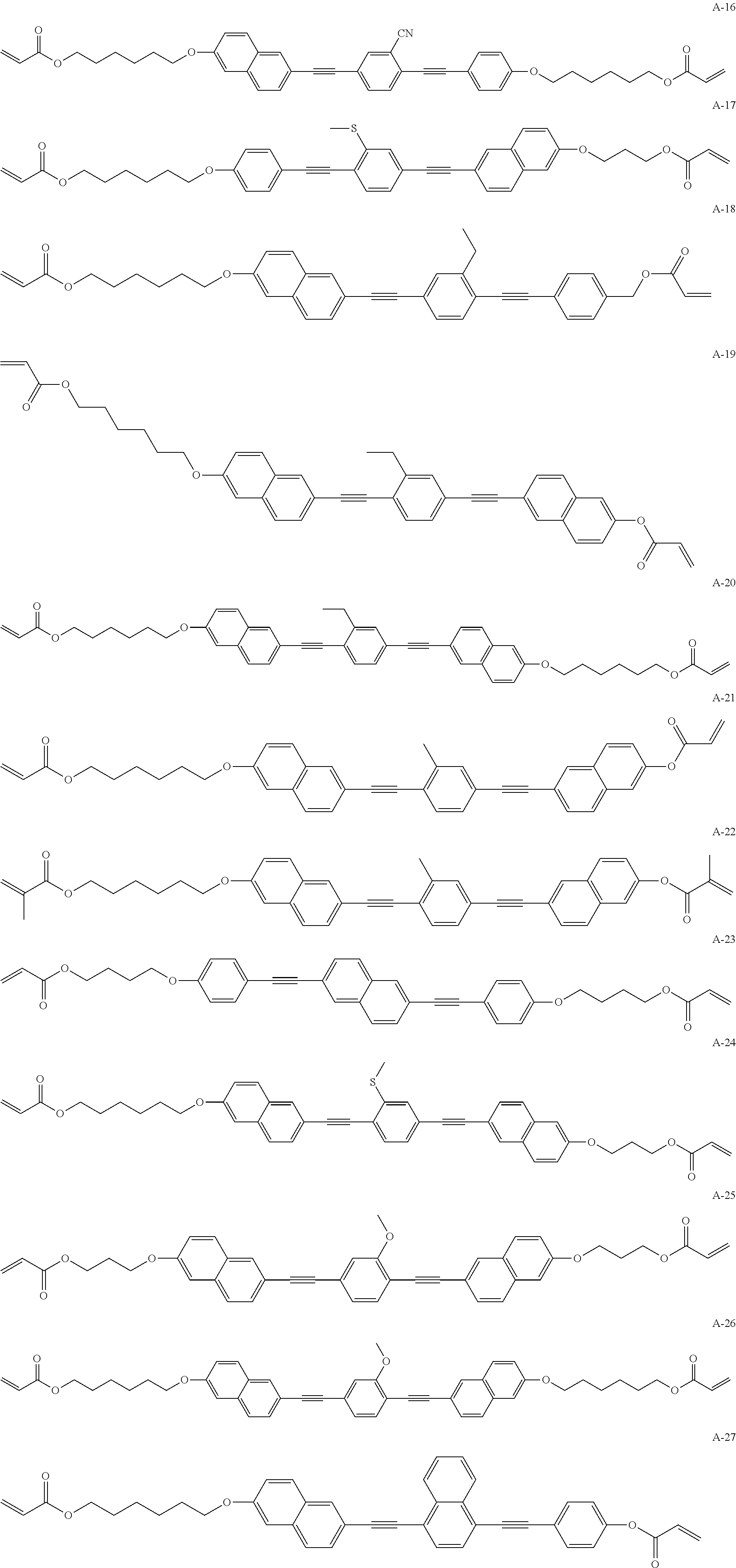

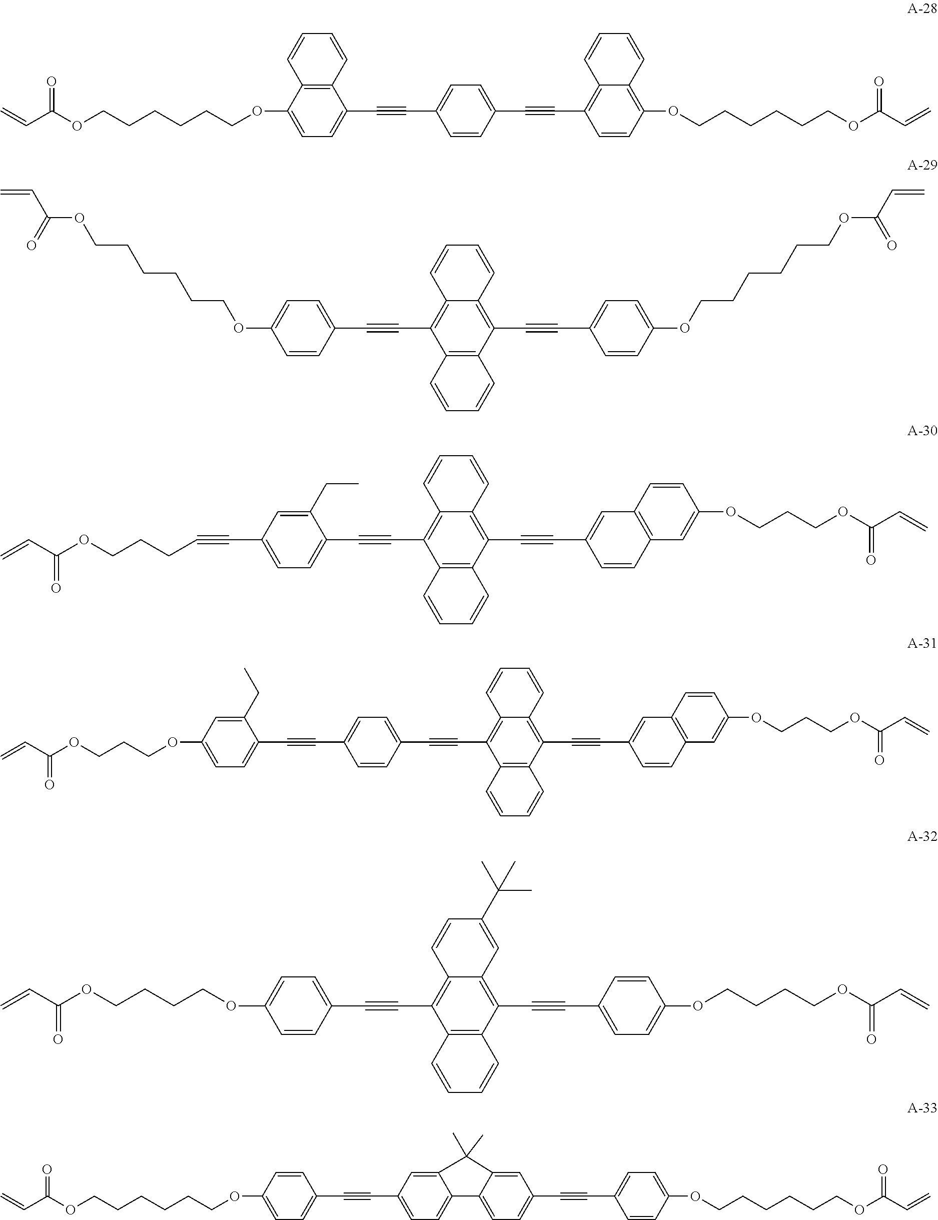

Especially preferred are the compounds of formulae A-1 to A-11.

Very preferred compounds of formula I and I2 are listed below:

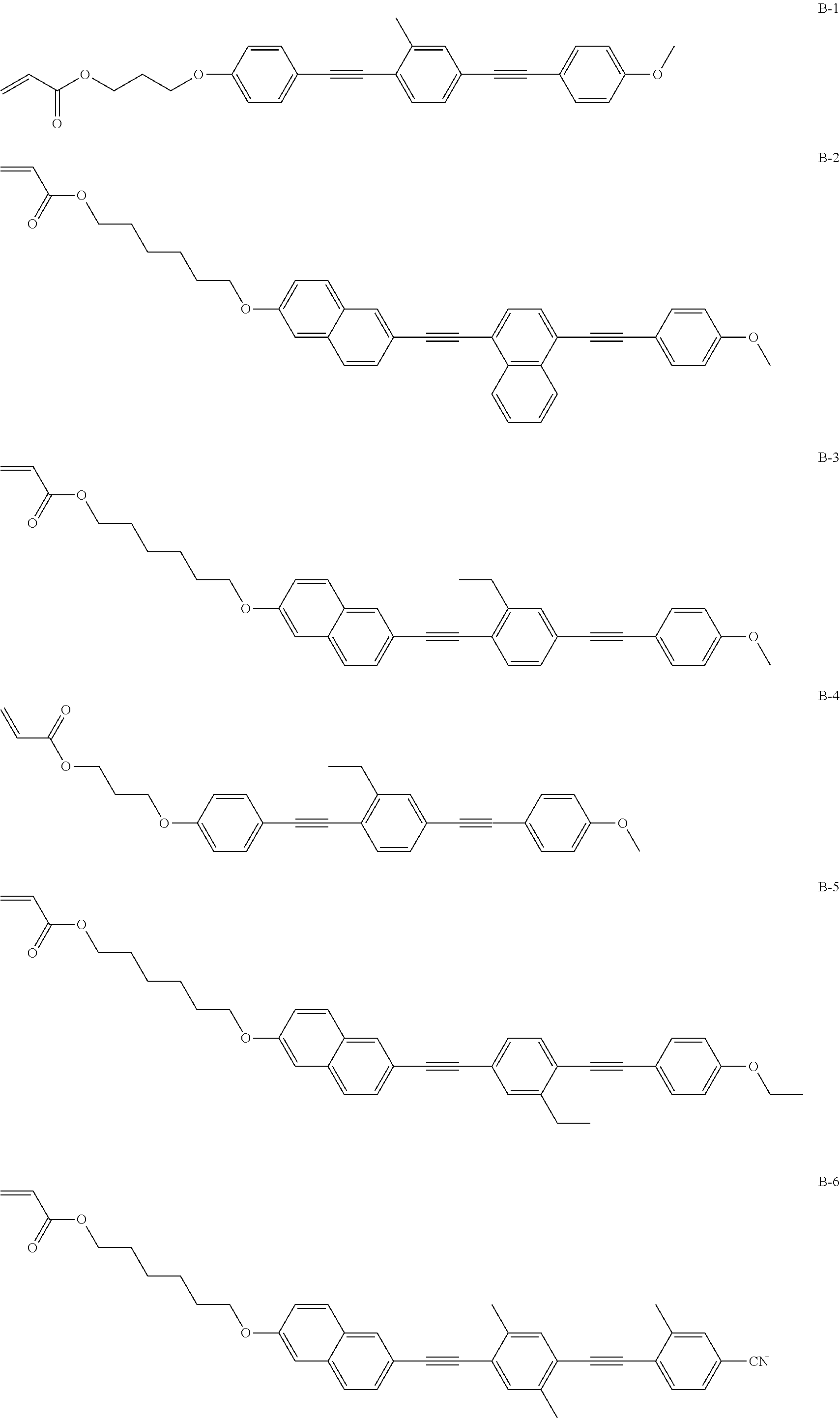

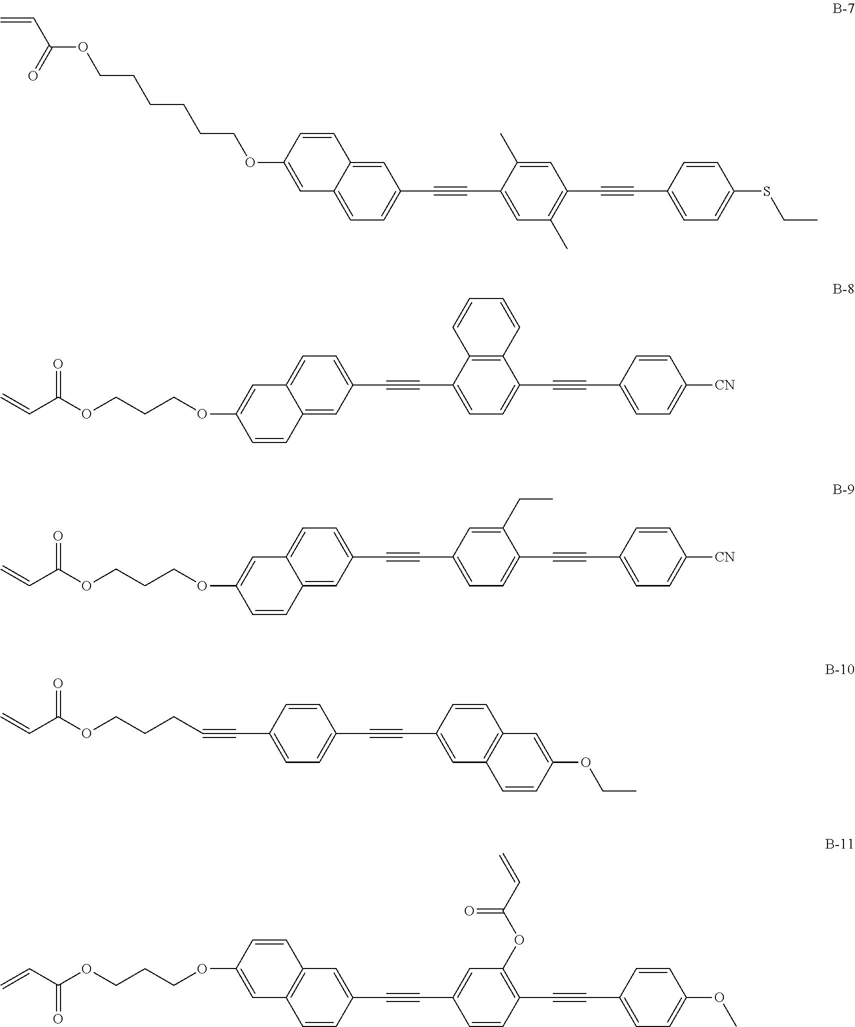

Especially preferred are the compounds of formulae B-1 to B-4.

The synthesis of the compounds of formula I, I1 and I2 and their subformulae can be carried by methods known per se to the person skilled in the art from the literature or in analogy thereto, as described for example in WO 2022/233908 A1.

The compounds of formula I, I1 and I2 either taken alone or in combination with other RMs in an RM mixture, exhibit in particular and preferably at the same time, a high birefringence, exhibit a good solubility in commonly known organic solvents used in mass production, show an improved alignment in the RM mixture, have favorable transition temperatures, and show high resistance against yellowing after being exposed to UV light.

Preferably the RM mixture contains one or more, preferably 1 to 5, very preferably 1, 2 or 3, compounds selected from formulae I1-1 to I1-27 and one or more, preferably 1 to 5, very preferably 1, 2 or 3, compounds selected from formulae I2-1 to I2-36.

Very preferably the RM mixture contains one or more, preferably 1 to 5, very preferably 1, 2 or 3, compounds selected from formulae A-1 to A-35, in particular from formulae A-1 to A-11, and one or more, preferably 1 to 5, very preferably 1, 2 or 3, compounds selected from formulae B-1 to B-11, in particular from formulae B-1 to B-4.

The concentration of the compounds of formula I1 and its subformulae in the RM mixture is preferably from 20 to 95%, very preferably from 30 to 85%.

The concentration of the compounds of formula I2 and its subformulae in the RM mixture is preferably from 5 to 80%, very preferably from 15 to 70%.

The total concentration of the compounds of formula I and its subformulae in the RM mixture is preferably from 65 to 99%, very preferably from 75 to 98%.

In addition to the polymerizable compounds of formula I, I1 and I2 and their subformulae, the RM mixture according to the present invention additionally comprises one or more chiral compounds.

These additional chiral compounds can be polymerizable or not polymerizable. These additionally chiral compounds can be non-mesogenic compounds or mesogenic compounds. If these additional chiral compounds are polymerizable they can be monoreactive or multireactive.

Preferably the additional chiral compounds have each alone or in combination with each other an absolute value of the helical twisting power (IHTPₜₒₜₐₗI) of 20 μm⁻¹ or more, preferably of 40 μm⁻¹ or more, more preferably in the range of 60 μm⁻¹ or more, most preferably in the range of 80 μm⁻¹ or more to 260 μm⁻¹.

In a preferred embodiment the RM mixture according to the present invention comprises one or more polymerizable chiral compounds.

Further preferably the RM mixture comprises only polymerizable chiral compounds, preferably selected from mono- or direactive compounds.

Further preferably the RM mixture does not contain a chiral compound which contains an isomerizable group.

Suitable polymerizable chiral compounds preferably comprise one or more ring elements, linked together by a direct bond or via a linking group and, where two of these ring elements optionally may be linked to each other, either directly or via a linking group, which may be identical to or different from the linking group mentioned. The ring elements are preferably selected from the group of four-, five-, six- or seven-, preferably of five- or six-, membered rings.

Preferred polymerizable chiral compounds are selected from the formulae CRM1, CRM2 and CRM3:

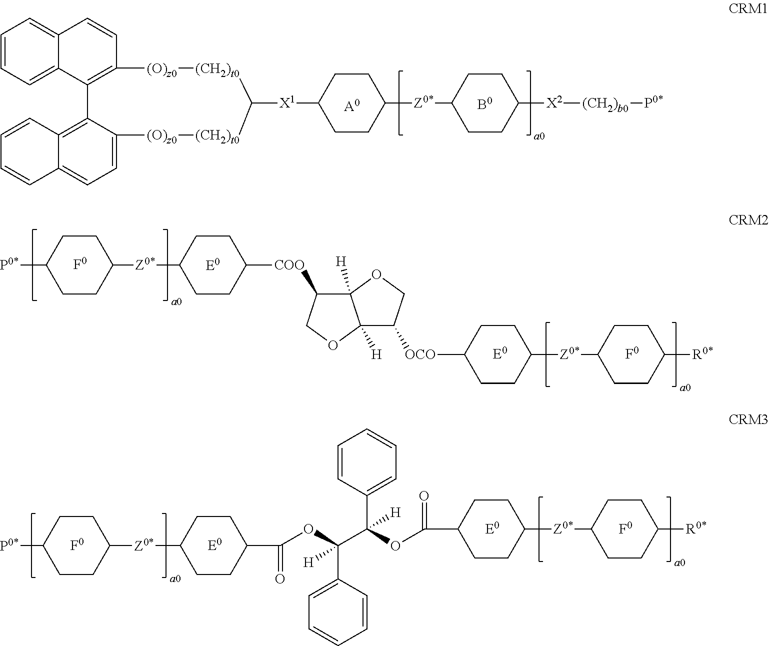

wherein the individual radicals, independently of each other and on each occurrence identically or differently, have the following meanings
P⁰* a polymerizable group,
Sp⁰* a spacer group or a single bond
R⁰* F, Cl, CN, alkyl, alkoxy, thioalkyl, alkylcarbonyl, alkoxycarbonyl, alkylcarbonyloxy or alkoxycarbonyloxy with 1 to 15, preferably 1 to 6 C atoms, P⁰*— or P⁰*—Sp*—,
A⁰, B⁰, E⁰, F⁰ 1,4-phenylene that is unsubstituted or substituted with 1, 2, 3 or 4 groups L, or trans-1,4-cyclohexylene,
L F, Cl, CN, P—Sp-, or alkyl, alkoxy, thioalkyl, alkylcarbonyl, alkoxycarbonyl, alkylcarbonyloxy or alkoxycarbonyloxy with 1 to 5 C atoms that is optionally fluorinated,
X¹, X²—O—, —COO—, —OCO—, —O—CO—O— or a single bond,
Z⁰* —COO—, —OCO—, —O—CO—O—, —OCH₂—, —CH₂O—, —CF₂O—, —OCF₂—, —CH₂CH₂—, —(CH₂)₄—, —CF₂CH₂—, —CH₂CF₂—, —CF₂CF₂—, —C≡C—, —CH═CH—, —CH═CH—COO—, —OCO—CH═CH— or a single bond, preferably —COO—, —OCO— or a single bond,
a0 0, 1 or 2, preferably 0 or 1,
b0 0 or an integer from 1 to 12, preferably 1 to 6,
t0 0, 1, 2 or 3,
z0 0 or 1, preferably 1,
   and wherein the naphthalene rings can additionally be substituted with one or more identical or different groups L.

Further preferred are the stereoisomers of formula CRM2 wherein the central isosorbide unit is replaced by an isomannide or isoidide unit.

The compounds of formula CRM1 are preferably selected from the following formula:

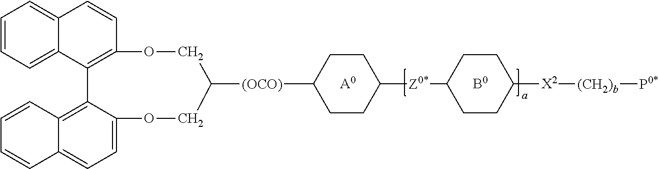

wherein A⁰, B⁰, Z⁰*, X², P⁰*, a and b have the meanings given in formula CRMa or one of the preferred meanings given above and below, and (OCO) denotes —O—CO— or a single bond.

Especially preferred compounds of formula CRM are selected from the group consisting of the following subformulae:

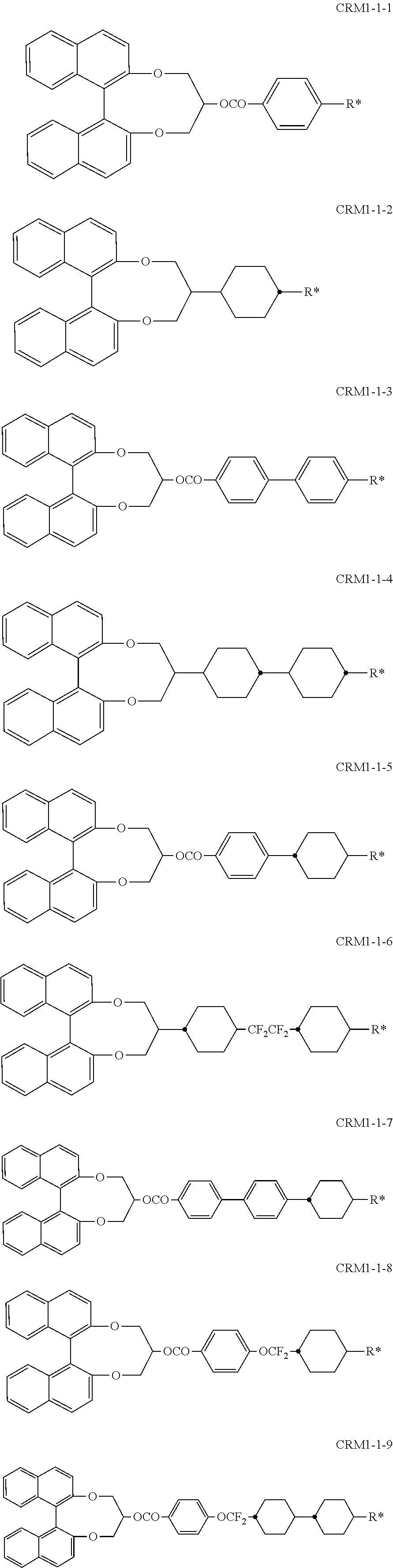

wherein R* is —X²—(CH₂)ₜ—P⁰* as defined in formula CRM1-1, and the benzene and naphthalene rings are unsubstituted or substituted with 1, 2, 3 or 4 groups L as defined above and below.

Very preferred are the compounds of formula CRM-1-1-1, CRM-1-1-2 and CRM-1-1-3, most preferred those of formula CRM-1-1-3.

The mixture preferably comprises 1 to 3, very preferably 1 or 2 polymerizable chiral compounds. The amount of the polymerizable chiral compounds in the RM mixture is preferably from 0.1 to 10%, more preferably from 0.5 to 8% by weight of the total RM mixture.

In another preferred embodiment, the RM mixture comprises one or more additional RMs which are different from formula I, I1, I2, CRM1 to CRM3 and their subformulae. Preferably the RM mixture comprises one or more additional RMs selected from RMs having only one polymerizable functional group (monoreactive RMs), and/or one or more additional RMs having two or more polymerizable functional groups (di- or multireactive RMs).

The additional di- or multireactive RMs are preferably selected of formula DRM

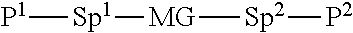

wherein
P¹, P² independently of each other denote a polymerizable group,
Sp¹, Sp² independently of each other are a spacer group or a single bond, and
MG is a rod-shaped mesogenic group, which is preferably selected of formula MG

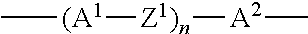

wherein
A¹ and A² denote, in case of multiple occurrence independently of one another, an aromatic or alicyclic group, which optionally contains one or more heteroatoms selected from N, O and S, and is optionally mono- or polysubstituted by L,
L is P—Sp-, F, Cl, Br, I, —CN, —NO₂, —NCO, —NCS, —OCN, —SCN, —C(═O)NR^{x}R^{y}, —C(═O)OR^{x}, —C(═O)R^{x}, —NR^{x}R^{y}, —OH, —SF₅, optionally substituted silyl, aryl or heteroaryl with 1 to 12, preferably 1 to 6 C atoms, and straight chain or branched alkyl, alkoxy, thioalkyl, alkylcarbonyl, alkoxycarbonyl, alkylcarbonyloxy or alkoxycarbonyloxy with 1 to 12 or 3 to 12, preferably 1 to 6 or 3 to 6 C atoms, wherein one or more H atoms are optionally replaced by F or C,
R^{x} and R^{y} independently of each other denote H or alkyl with 1 to 12 C— atoms,
Z¹ denotes, in case of multiple occurrence independently of one another, —O—, —S—, —CO—, —COO—, —OCO—, —S—CO—, —CO—S—, —O—COO—, —CO—NR⁰⁰—, —NR⁰⁰—CO—, —NR⁰⁰—CO—NR⁰⁰⁰, —NR⁰⁰—CO—O—, —O—CO—NR⁰⁰—, —OCH₂—, —CH₂O—, —SCH₂—, —CH₂S—, —CF₂O—, —OCF₂—, —CF₂S—, —SCF₂—, —CH₂CH₂—, —(CH₂)ₙ₁, —CF₂CH₂—, —CH₂CF₂—, —CF₂CF₂—, —CH═N—, —N═CH—, —N═N—, —CH═CR⁰⁰—, —CY¹═CY²—, —C≡C—, —CH═CH—COO—, —OCO—CH═CH— or a single bond, preferably —COO—, —OCO— or a single bond,
Y¹ and Y² independently of each other denote H, F, Cl or CN,
n is 1, 2, 3 or 4, preferably 1 or 2, most preferably 2,
n1 is an integer from 1 to 10, preferably 1, 2, 3 or 4.

Preferred groups A¹ and A² include, without limitation, furan, pyrrol, thiophene, oxazole, thiazole, thiadiazole, imidazole, phenylene, cyclohexylene, bicyclooctylene, cyclohexenylene, pyridine, pyrimidine, pyrazine, azulene, indane, fluorene, naphthalene, tetrahydronaphthalene, anthracene, phenanthrene and dithienothiophene, all of which are unsubstituted or substituted by 1, 2, 3 or 4 groups L as defined above.

Particular preferred groups A¹ and A² are selected from 1,4-phenylene, pyridine-2,5-diyl, pyrimidine-2,5-diyl, thiophene-2,5-diyl, naphthalene-2,6-diyl, 1,2,3,4-tetrahydro-naphthalene-2,6-diyl, indane-2,5-diyl, bicyclooctylene or 1,4-cyclohexylene wherein one or two non-adjacent CH₂ groups are optionally replaced by O and/or S, wherein these groups are unsubstituted or substituted by 1, 2, 3 or 4 groups L as defined above.

Preferred RMs of formula DRM are selected of formula DRMa

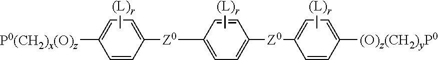

wherein
P⁰ is, in case of multiple occurrence independently of one another, a polymerizable group, preferably an acryl, methacryl, oxetane, epoxy, vinyl, heptadiene, vinyloxy, propenyl ether or styrene group,
Z⁰ is —COO—, —OCO—, —CH₂CH₂—, —CF₂O—, —OCF₂—, —C≡C—, —CH═CH—, —OCO—CH═CH—, —CH═CH—COO—, or a single bond,
L has on each occurrence identically or differently one of the meanings given for L in formula I, and is preferably, in case of multiple occurrence independently of one another, selected from F, Cl, CN or optionally halogenated alkyl, alkoxy, thioalkyl, alkylcarbonyl, alkoxycarbonyl, alkylcarbonyloxy or alkoxycarbonyloxy with 1 to 5 C atoms,
r is 0, 1, 2, 3 or 4,
x and y are independently of each other 0 or identical or different integers from 1 to 12,
z is 0 or 1, with z being 0 if the adjacent x or y is 0.

Very preferred RMs of formula DRM are selected from the following formulae:

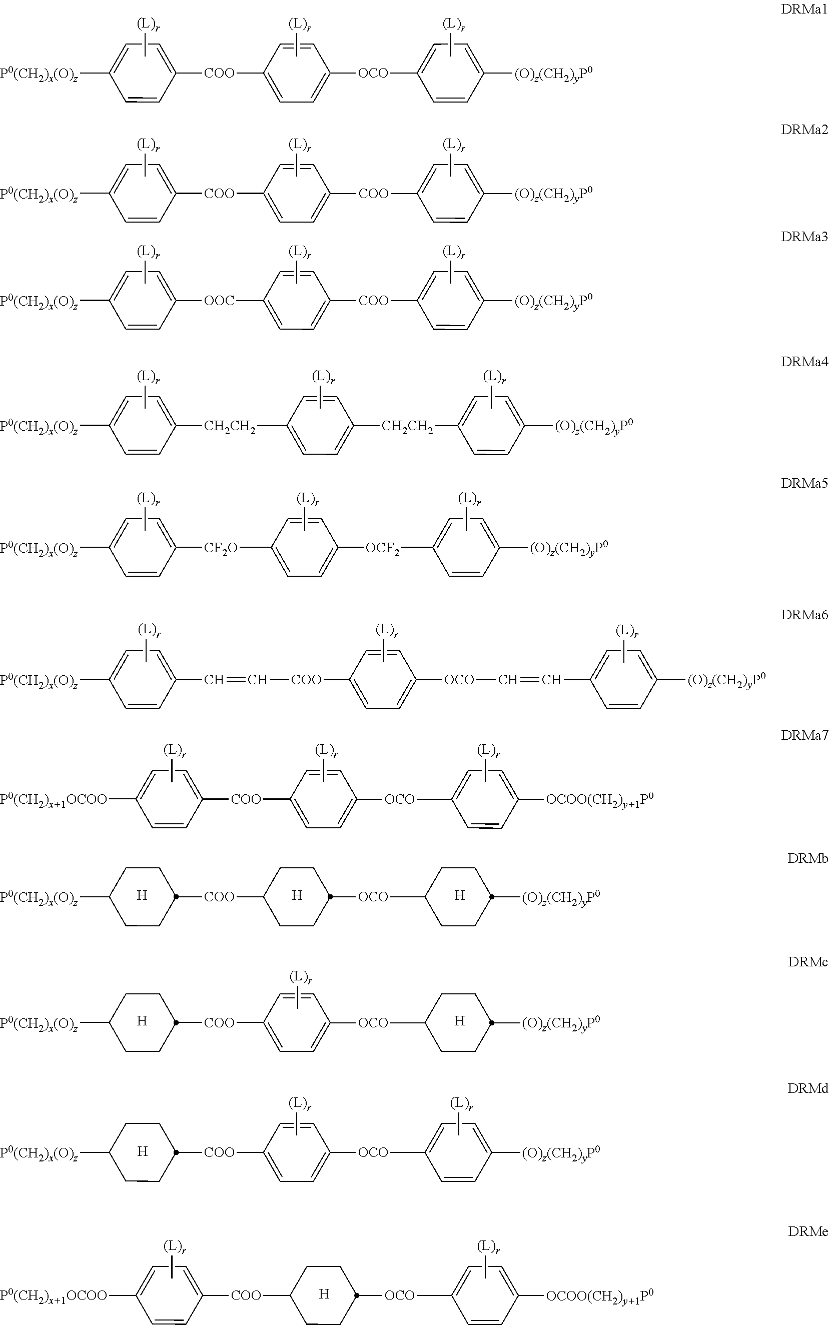

wherein P⁰, L, r, x, y and z are as defined in formula DRMa.

Especially preferred are compounds of formula DRMa1, DRMa2 and DRMa3, in particular those of formula DRMa1.

The concentration of the additional di- or multireactive RMs, preferably those of formula DRM and its subformulae, in the RM mixture is preferably from 1 to 50%, very preferably from 2 to 30%.

In another preferred embodiment the RM mixture comprises, in addition to the compounds of formula I, one or more monoreactive RMs. These additional monoreactive RMs are preferably selected from formula MRM:

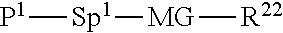

wherein P¹, Sp¹ and MG have the meanings given in formula DRM,
R²² denotes P—Sp-, F, Cl, Br, I, —CN, —NO₂, —NCO, —NCS, —OCN, —SCN, —C(═O)NR^{x}R^{y}, —C(═O)X, —C(═O)OR^{x}, —C(═O)R^{y}, —NR^{x}R^{y}, —OH, —SF₅, optionally substituted silyl, straight chain or branched alkyl, alkoxy, alkylcarbonyl, alkoxycarbonyl, alkylcarbonyloxy or alkoxycarbonyloxy with 1 to 12 or 3 to 12, preferably 1 to 6 or 3 to 6 C atoms, wherein one or more H atoms are optionally replaced by F or Cl,
X is halogen, preferably F or Cl, and
R^{x} and R^{y} are independently of each other H or alkyl with 1 to 12 C— atoms.

Preferably the RMs of formula MRM are selected from the following formulae.

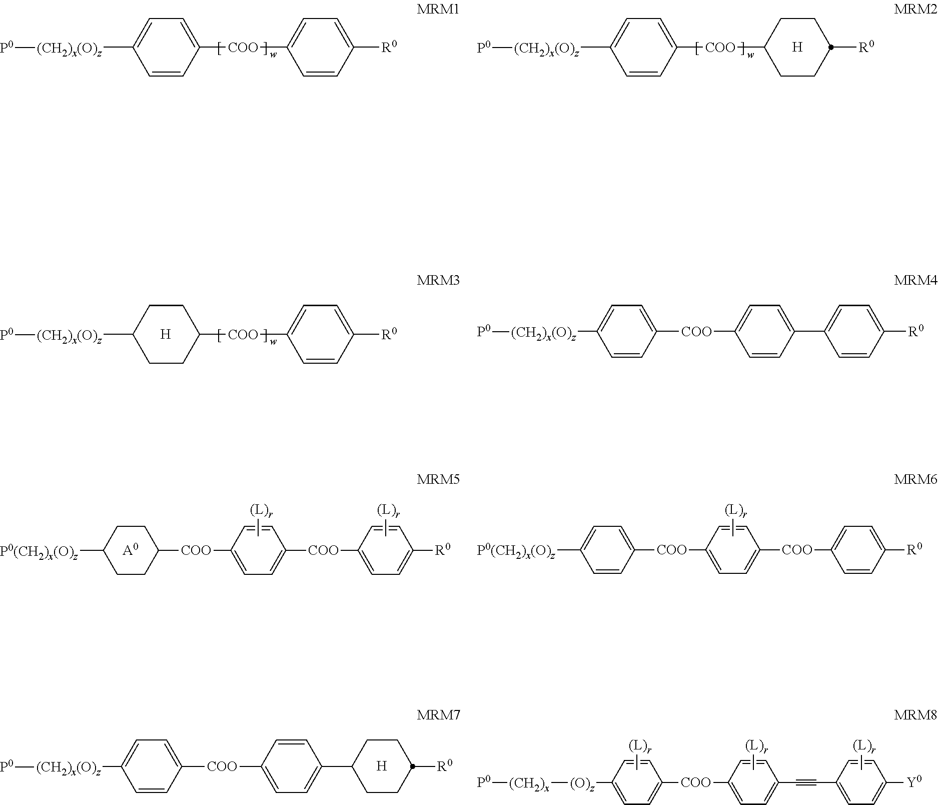

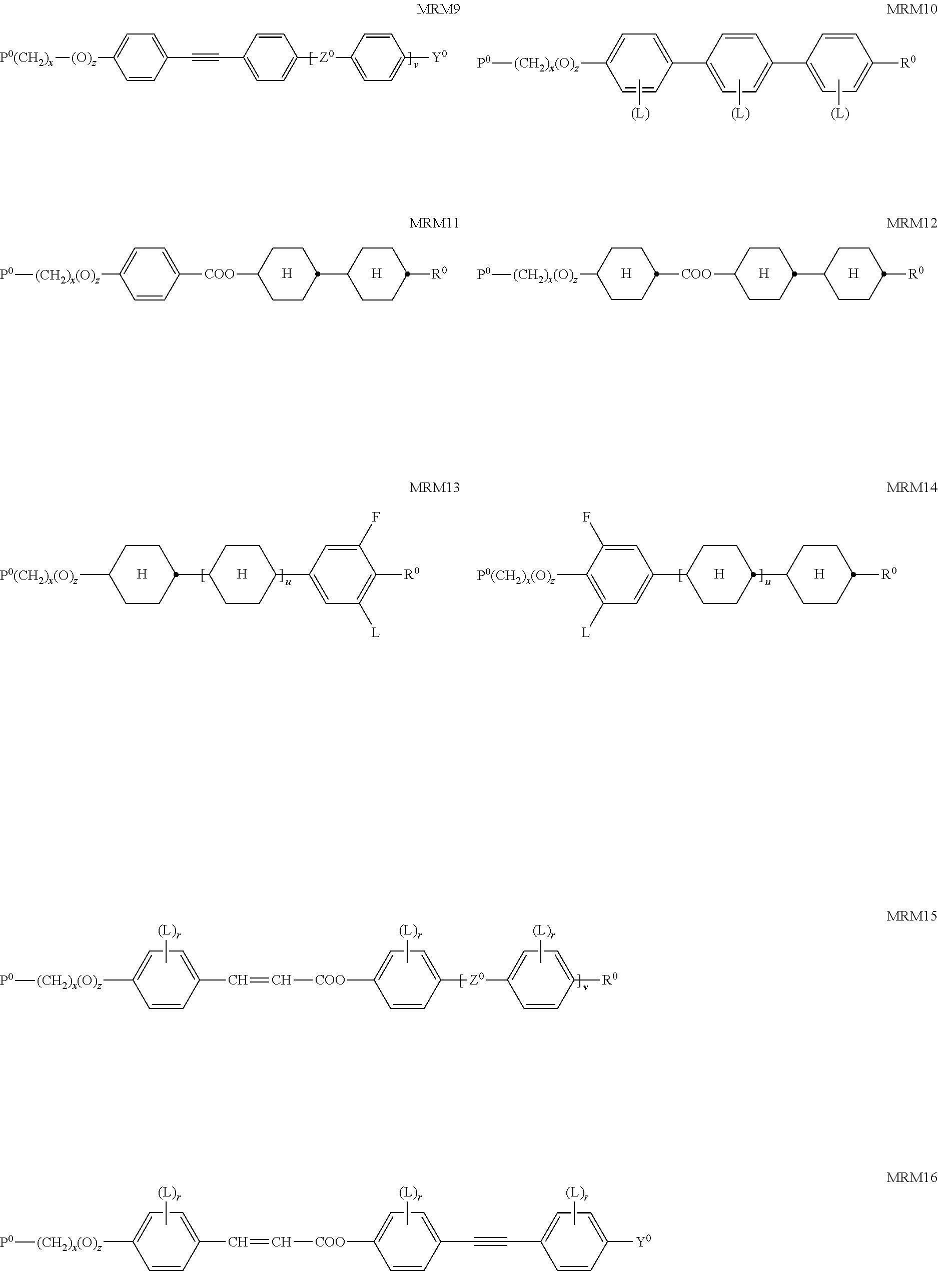

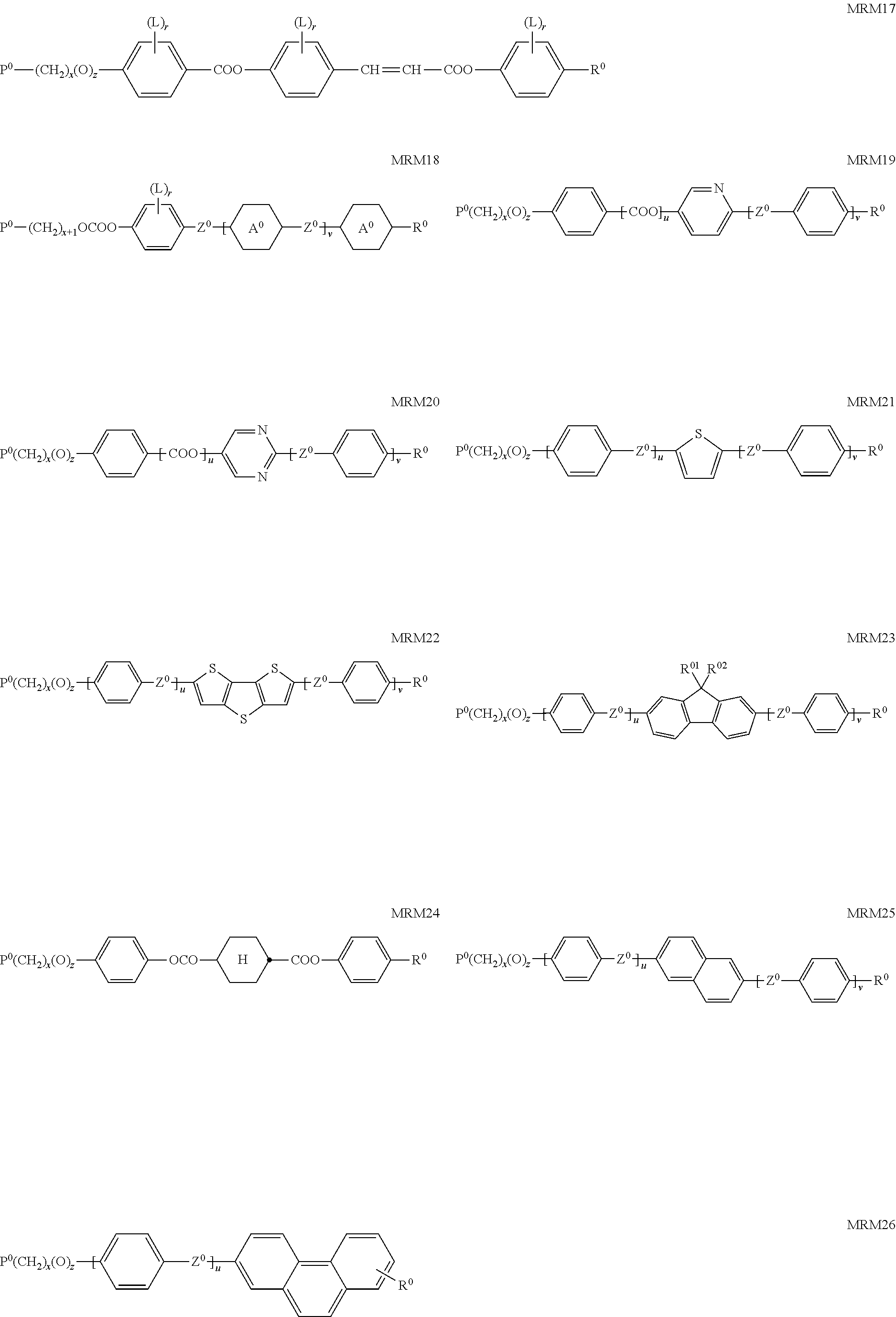

wherein P⁰, L, r, x, y and z are as defined in formula DRMa,
R⁰, R⁰¹ and R⁰² are each an independently alkyl, alkoxy, thioalkyl, alkylcarbonyl, alkoxycarbonyl, alkylcarbonyloxy or alkoxycarbonyloxy with 1 or more, preferably 1 to 15 C atoms or denotes Y⁰ or P—(CH₂)_{y}—(O)_{z}—,
X⁰ is —O—, —S—, —CO—, —COO—, —OCO—, —O—COO—, —CO—NR⁰¹—, —NR⁰¹—CO—, —NR⁰¹—CO—NR⁰¹—, —OCH₂—, —CH₂O—, —SCH₂—, —CH₂S—, —CF₂O—, —OCF₂—, —CF₂S—, —SCF₂—, —CF₂CH₂—, —CH₂CF₂—, —CF₂CF₂—, —CH═N—, —N═CH—, —N═N—, —CH═CR⁰¹—, —CF═CF—, —C═C—, —CH═CH—COO—, —OCO—CH═CH— or a single bond
Y⁰ is F, Cl, CN, NO₂, OCH₃, OCN, SCN, SF₅, or mono- oligo- or polyfluorinated alkyl or alkoxy with 1 to 4 C atoms,
Z⁰ is —COO—, —OCO—, —CH₂CH₂—, —CF₂O—, —OCF₂—, —CH═CH—, —OCO—CH═CH—, —CH═CH—COO—, or a single bond,
A⁰ is, in case of multiple occurrence independently of one another, 1,4-phenylene that is unsubstituted or substituted with 1, 2, 3 or 4 groups L, or trans-1,4-cyclohexylene,
R^{01.02} are independently of each other H, R⁰ or Y⁰,
u and v are independently of each other 0, 1 or 2,
w is 0 or 1,
   and wherein the benzene and naphthalene rings can additionally be substituted with one or more identical or different groups L.

Especially preferred are compounds of formula MRM1, MRM2, MRM3, MRM4, MRM5, MRM6, MRM7, MRM9 and MRM10, in particular those of formula MRM1, MRM4, MRM6, and MRM7.

The concentration of the monoreactive RMs, preferably those of formula MRM, in the RM mixture is preferably from 1 to 40%, very preferably from 2 to 20%.

In formulae DRM, MRM and their preferred subformulae, L is preferably selected from F, Cl, CN, NO₂ or straight chain or branched alkyl, alkoxy, alkylcarbonyl, alkoxycarbonyl, alkylcarbonlyoxy or alkoxycarbonyloxy with 1 to 12 or 3 to 12 C atoms, wherein the alkyl groups are optionally perfluorinated, or P—Sp-.

Very preferably L is selected from F, Cl, CN, NO₂, CH₃, C₂H₅, C(CH₃)₃, CH(CH₃)₂, CH₂CH(CH₃)C₂H₅, OCH₃, SCH₃, OC₂H₅, SC₂H₅, COCH₃, COC₂H₅, COOCH₃, COOC₂H₅, CF₃, OCF₃, OCHF₂, OC₂F₅ or P—Sp-, in particular from F, Cl, CN, CH₃, C₂H₅, C(CH₃)₃, CH(CH₃)₂, OCH₃, SCH₃, COCH₃, OCF₃ or P—Sp-, most preferably from F, Cl, CH₃, C(CH₃)₃, OCH₃, SCH₃, COCH₃ or P—Sp-.

In another preferred embodiment of the present invention the chiral RM mixture does not contain a compound of formula DRM or MRM. In another preferred embodiment the chiral RM mixture consists of compounds selected from formula I, I1, I2 and CRM.

The RM mixture preferably exhibits a chiral nematic LC phase, or a chiral smectic LC phase and a chiral nematic LC phase, very preferably a chiral nematic LC phase at room temperature.

The RM mixture preferably has a birefringence (Δn) in the range from 0.2 to 0.8, more preferably in the range from 0.25 to 0.7 and even more preferably in the range from 0.35 to 0.55.

Another object of the invention is an RM formulation comprising an RM mixture as described above and below, and further comprising one or more solvents and/or additives.

The proportion of the RM mixture comprising, preferably consisting of, compounds selected from formulae I, I1, I2, CRM1-3 and their subformulae and optionally from formulae DRM and MRM and their subformulae, in the RM formulation is preferably from 85 to 100%, more preferably from 85 to 99%, very preferably from 90 to 99%, of total solids, i.e., excluding the solvents.

In a preferred embodiment the RM formulation according to the present invention comprises one or more non-polymerizable chiral dopants in addition to or alternatively to the polymerizable chiral compounds as described above.

Preferred non-polymerizable chiral compounds are selected from the group consisting of compounds of formulae C—I to C—III,

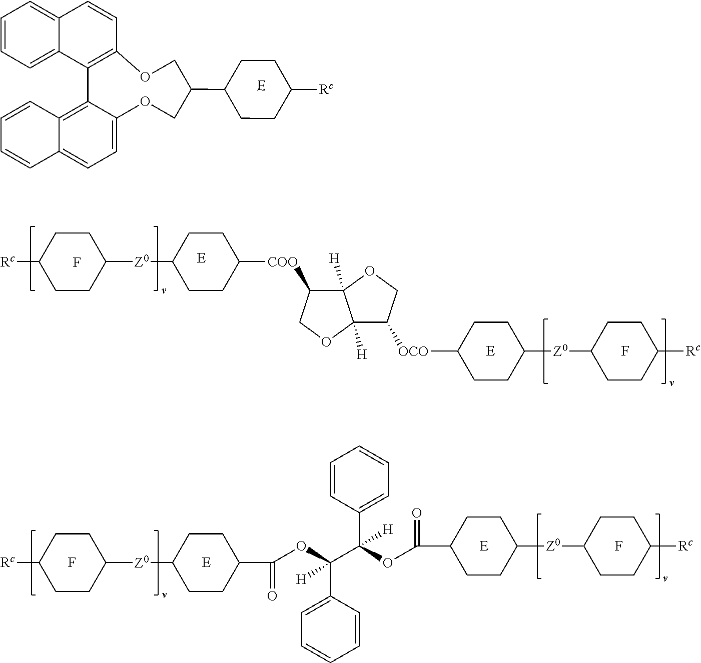

Further preferred are the stereoisomers of formula C-II wherein the central isosorbide unit is replaced by an isomannide or isoidide unit.

The compounds of formula C—I and their synthesis are described in EP1389199 A1. The compounds of formula C-II and their synthesis are described in WO98/00428 A1. The compounds of formula C—III and their synthesis are described in GB2328207 A.

Further preferred additional chiral dopants are e.g. the commercially available R/S-6011, R/S-5011, R/S-4011, R/S-3011, R/S-2011, R/S-1011, R/S-811 and CB-15 (from Merck KGaA, Darmstadt, Germany).

The amount of the non-polymerizable chiral dopants in the RM formulation is preferably from 0.1 to 10%, more preferably from 0.5 to 8% by weight of all solids.

In another preferred embodiment the RM formulation comprises optionally one or more additives selected from the group consisting of polymerization initiators, surfactants, stabilizers, catalysts, sensitizers, inhibitors, chain-transfer agents, co-reacting monomers, reactive thinners, surface-active compounds, lubricating agents, wetting agents, dispersing agents, hydrophobing agents, adhesive agents, flow improvers, degassing or defoaming agents, deaerators, diluents, reactive diluents, auxiliaries, colorants, dyes, pigments and nanoparticles.

In another preferred embodiment the RM formulation comprises one or more specific antioxidant additives, preferably selected from the Irganox® series, e.g. the commercially available antioxidants Irganox®1076 and Irganox®1010, from Ciba, Switzerland.

In another preferred embodiment, the RM formulation comprises a combination of one or more, more preferably of two or more photoinitiators, for example, selected from the commercially available Irgacure® or Darocure® (Ciba AG) series, in particular, Irgacure 127, Irgacure 184, Irgacure 369, Irgacure 651, Irgacure 817, Irgacure 907, Irgacure 1300, Irgacure, Irgacure 2022, Irgacure 2100, Irgacure 2959, or Darcure TPO, further selected from the commercially available OXE02 (Ciba AG), NCI 930, N1919T (Adeka), SPI-03 or SPI-04 (Samyang), TR-PBG 304 or TR-PGB 345 (Tronly).

The concentration of the polymerization initiator(s) as a whole in the RM formulation is preferably from 0.3 to 6%, very preferably from 0.8 to 5%, more preferably 1 to 4%.

In another preferred embodiment the RM formulation optionally comprises one or more additives selected from polymerizable non-mesogenic compounds (reactive thinners). The amount of these additives in the RM formulation is preferably from 0 to 30%, very preferably from 0 to 25%.

The reactive thinners used are not only substances which are referred to in the actual sense as reactive thinners, but also auxiliary compounds already mentioned above which contain one or more complementary reactive units, for example hydroxyl, thiol-, or amino groups, via which a reaction with the polymerizable units of the liquid-crystalline compounds can take place.

The substances which are usually capable of photopolymerization include, for example, mono-, bi- and polyfunctional compounds containing at least one olefinic double bond. Examples thereof are vinyl esters of carboxylic acids, for example of lauric, myristic, palmitic and stearic acid, and of dicarboxylic acids, for example of succinic acid, adipic acid, allyl and vinyl ethers and methacrylic and acrylic esters of monofunctional alcohols, for example of lauryl, myristyl, palmityl and stearyl alcohol, and diallyl and divinyl ethers of bifunctional alcohols, for example ethylene glycol and 1,4-butanediol.

Also suitable are, for example, methacrylic and acrylic esters of polyfunctional alcohols, in particular those which contain no further functional groups, or at most ether groups, besides the hydroxyl groups. Examples of such alcohols are bifunctional alcohols, such as ethylene glycol, propylene glycol and their more highly condensed representatives, for example diethylene glycol, triethylene glycol, dipropylene glycol, tripropylene glycol etc., butanediol, pentanediol, hexanediol, neopentyl glycol, alkoxylated phenolic compounds, such as ethoxylated and propoxylated bisphenols, cyclohexanedimethanol, trifunctional and polyfunctional alcohols, such as glycerol, trimethylolpropane, butanetriol, trimethylolethane, pentaerythritol, ditrimethylolpropane, dipentaerythritol, sorbitol, mannitol, and the corresponding alkoxylated, in particular ethoxylated and propoxylated alcohols.

Other suitable reactive thinners are polyester (meth)acrylates, which are the (meth)acrylic ester of polyesterols.

Examples of suitable polyesterols are those which can be prepared by esterification of polycarboxylic acids, preferably dicarboxylic acids, using polyols, preferably diols. The starting materials for such hydroxyl-containing polyesters are known to the person skilled in the art. Dicarboxylic acids which can be employed are succinic, glutaric acid, adipic acid, sebacic acid, o-phthalic acid and isomers and hydrogenation products thereof, and esterifiable and transesterifiable derivatives of said acids, for example anhydrides and dialkyl esters. Suitable polyols are the abovementioned alcohols, preferably ethyleneglycol, 1,2- and 1,3-propylene glycol, 1,4-butanediol, 1,6-hexanediol, neopentyl glycol, cyclohexanedimethanol and polyglycols of the ethylene glycol and propylene glycol type.

Suitable reactive thinners are furthermore 1,4-divinylbenzene, triallyl cyanurate, acrylic esters of tricyclodecenyl alcohol of the following formula

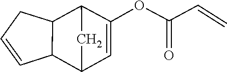

also known under the name dihydrodicyclopentadienyl acrylate, and the allyl esters of acrylic acid, methacrylic acid and cyanoacrylic acid.

Of the reactive thinners which are mentioned by way of example, those containing photopolymerizable groups are used in particular and in view of the abovementioned preferred compositions.

This group includes, for example, dihydric and polyhydric alcohols, for example ethylene glycol, propylene glycol and more highly condensed representatives thereof, for example diethylene glycol, triethylene glycol, dipropylene glycol, tripropylene glycol etc., butanediol, pentanediol, hexanediol, neopentyl glycol, cyclohexanedimethanol, glycerol, trimethylolpropane, butanetriol, trimethylolethane, pentaerythritol, ditrimethylolpropane, dipentaerythritol, sorbitol, mannitol and the corresponding alkoxylated, in particular ethoxylated and propoxylated alcohols.

The group furthermore also includes, for example, alkoxylated phenolic compounds, for example ethoxylated and propoxylated bisphenols.

These reactive thinners may furthermore be, for example, epoxide or urethane (meth)acrylates.

Epoxide (meth)acrylates are, for example, those as obtainable by the reaction, known to the person skilled in the art, of epoxidized olefins or poly- or diglycidyl ether, such as bisphenol A diglycidyl ether, with (meth)acrylic acid.

Urethane (meth)acrylates are, in particular, the products of a reaction, likewise known to the person skilled in the art, of hydroxylalkyl (meth)acrylates with poly- or diisocyanates.

Such epoxide and urethane (meth)acrylates are included amongst the compounds listed above as “mixed forms”.

If reactive thinners are used, their amount and properties must be matched to the respective conditions in such a way that, on the one hand, a satisfactory desired effect, for example the desired color of the composition according to the invention, is achieved, but, on the other hand, the phase behaviour of the liquid-crystalline composition is not excessively impaired. The low-crosslinking (high-crosslinking) liquid-crystalline compositions can be prepared, for example, using corresponding reactive thinners which have a relatively low (high) number of reactive units per molecule.

The group of diluents include, for example:
C1-C4-alcohols, for example methanol, ethanol, n-propanol, isopropanol, butanol, isobutanol, sec-butanol and, in particular, the C5-C12-alcohols n-pentanol, n-hexanol, n-heptanol, n-octanol, n-nonanol, n-decanol, n-undecanol and n-dodecanol, and isomers thereof, glycols, for example 1,2-ethylene glycol, 1,2- and 1,3-propylene glycol, 1,2-, 2,3- and 1,4-butylene glycol, di- and triethylene glycol and di- and tripropylene glycol, ethers, for example methyl tert-butyl ether, 1,2-ethylene glycol mono- and dimethyl ether, 1,2-ethylene glycol mono- and -diethylether, 3-methoxypropanol, 3-isopropoxypropanol, tetrahydrofuran and dioxane, ketones, for example acetone, methyl ethyl ketone, methyl isobutyl ketone and diacetone alcohol (4-hydroxy-4-methyl-2-pentanone), C1-C5-alkyl esters, for example methyl acetate, ethyl acetate, propyl acetate, butyl acetate and amyl acetate, aliphatic and aromatic hydrocarbons, for example pentane, hexane, heptane, octane, isooctane, petroleum ether, toluene, xylene, ethylbenzene, tetralin, decalin, dimethylnaphthalene, white spirit, Shellsol® and Solvesso® mineral oils, for example gasoline, kerosine, diesel oil and heating oil, but also natural oils, for example olive oil, soya oil, rapeseed oil, linseed oil and sunflower oil.

It is of course also possible to use mixtures of these diluents in the compositions according to the invention.

So long as there is at least partial miscibility, these diluents can also be mixed with water. Examples of suitable diluents here are C1-C4-alcohols, for example methanol, ethanol, n-propanol, isopropanol, butanol, isobutanol and sec-butanol, glycols, for example 1,2-ethylene glycol, 1,2- and 1,3-propylene glycol, 1,2-, 2,3- and 1,4-butylene glycol, di- and triethylene glycol, and di- and tripropylene glycol, ethers, for example tetrahydrofuran and dioxane, ketones, for example acetone, methyl ethyl ketone and diacetone alcohol (4-hydroxy-4-methyl-2-pentanone), and C1-C4-alkyl esters, for example methyl, ethyl, propyl and butyl acetate.

The diluents are optionally employed in a proportion of from about 0 to 10.0% by weight, preferably from about 0 to 5.0% by weight, based on the total weight of the RM formulation.

The antifoams and deaerators (c1)), lubricants and flow auxiliaries (c2)), thermally curing or radiation-curing auxiliaries (c3)), substrate wetting auxiliaries (c4)), wetting and dispersion auxiliaries (c5)), hydrophobicizing agents (c6)), adhesion promoters (c7)) and auxiliaries for promoting scratch resistance (c8)) cannot strictly be delimited from one another in their action.

For example, lubricants and flow auxiliaries often also act as antifoams and/or deaerators and/or as auxiliaries for improving scratch resistance. Radiation-curing auxiliaries can also act as lubricants and flow auxiliaries and/or deaerators and/or as substrate wetting auxiliaries. In individual cases, some of these auxiliaries can also fulfil the function of an adhesion promoter (c8)).

Corresponding to the above-said, a certain additive can therefore be classified in a number of the groups c1) to c8) described below.

The antifoams in group c1) include silicon-free and silicon-containing polymers. The silicon-containing polymers are, for example, unmodified or modified polydialkylsiloxanes or branched copolymers, comb or block copolymers comprising polydialkylsiloxane and polyether units, the latter being obtainable from ethylene oxide or propylene oxide.

The deaerators in group c1) include, for example, organic polymers, for example polyethers and polyacrylates, dialkylpolysiloxanes, in particular dimethylpolysiloxanes, organically modified polysiloxanes, for example arylalkyl-modified polysiloxanes, and fluorosilicones.

The action of the antifoams is essentially based on preventing foam formation or destroying foam that has already formed. Antifoams essentially work by promoting coalescence of finely divided gas or air bubbles to give larger bubbles in the medium to be deaerated, for example the compositions according to the invention, and thus accelerate escape of the gas (of the air). Since antifoams can frequently also be employed as deaerators and vice versa, these additives have been included together under group c1).

Such auxiliaries are, for example, commercially available from Tego as TEGO® Foamex 800, TEGO® Foamex 805, TEGO® Foamex 810, TEGO® Foamex 815, TEGO® Foamex 825, TEGO® Foamex 835, TEGO® Foamex 840, TEGO® Foamex 842, TEGO® Foamex 1435, TEGO® Foamex 1488, TEGO® Foamex 1495, TEGO® Foamex 3062, TEGO® Foamex 7447, TEGO® Foamex 8020, Tego® Foamex N, TEGO® Foamex K 3, TEGO® Antifoam 2-18, TEGO® Antifoam 2-18, TEGO® Antifoam 2-57, TEGO® Antifoam 2-80, TEGO® Antifoam 2-82, TEGO® Antifoam 2-89, TEGO® Antifoam 2-92, TEGO® Antifoam 14, TEGO® Antifoam 28, TEGO® Antifoam 81, TEGO® Antifoam D 90, TEGO® Antifoam 93, TEGO® Antifoam 200, TEGO® Antifoam 201, TEGO® Antifoam 202, TEGO® Antifoam 793, TEGO® Antifoam 1488, TEGO® Antifoam 3062, TEGOPREN® 5803, TEGOPREN® 5852, TEGOPREN® 5863, TEGOPREN® 7008, TEGO® Antifoam 1-60, TEGO® Antifoam 1-62, TEGO® Antifoam 1-85, TEGO® Antifoam 2-67, TEGO® Antifoam WM 20, TEGO® Antifoam 50, TEGO® Antifoam 105, TEGO® Antifoam 730, TEGO® Antifoam MR 1015, TEGO® Antifoam MR 1016, TEGO® Antifoam 1435, TEGO® Antifoam N, TEGO® Antifoam KS 6, TEGO® Antifoam KS 10, TEGO® Antifoam KS 53, TEGO® Antifoam KS 95, TEGO® Antifoam KS 100, TEGO® Antifoam KE 600, TEGO® Antifoam KS 911, TEGO® Antifoam MR 1000, TEGO® Antifoam KS 1100, Tego® Airex 900, Tego® Airex 910, Tego® Airex 931, Tego® Airex 935, Tego® Airex 936, Tego® Airex 960, Tego® Airex 970, Tego® Airex 980 and Tego® Airex 985 and from BYK as BYK®-011, BYK®-019, BYK®-020, BYK®-021, BYK®-022, BYK®-023, BYK®-024, BYK®-025, BYK®-027, BYK®-031, BYK®-032, BYK®-033, BYK®-034, BYK®-035, BYK®-036, BYK®-037, BYK®-045, BYK®-051, BYK®-052, BYK®-053, BYK®-055, BYK®-057, BYK®-065, BYK®-066, BYK®-070, BYK®-080, BYK®-088, BYK®-141 and BYK®-A 530.

The auxiliaries in group c1) are optionally employed in a proportion of from about 0 to 3.0% by weight, preferably from about 0 to 2.0% by weight, based on the total weight of the RM formulation.

In group c2), the lubricants and flow auxiliaries typically include silicon-free, but also silicon-containing polymers, for example polyacrylates or modifiers, low-molecular-weight polydialkylsiloxanes. The modification consists in some of the alkyl groups having been replaced by a wide variety of organic radicals. These organic radicals are, for example, polyethers, polyesters or even long-chain alkyl radicals, the former being used the most frequently.

The polyether radicals in the correspondingly modified polysiloxanes are usually built up from ethylene oxide and/or propylene oxide units. Generally, the higher the proportion of these alkylene oxide units in the modified polysiloxane, the more hydrophilic is the resultant product.

Such auxiliaries are, for example, commercially available from Tego as TEGO® Glide 100, TEGO® Glide ZG 400, TEGO® Glide 406, TEGO® Glide 410, TEGO® Glide 411, TEGO® Glide 415, TEGO® Glide 420, TEGO® Glide 435, TEGO® Glide 440, TEGO® Glide 450, TEGO® Glide A 115, TEGO® Glide B 1484 (can also be used as antifoam and deaerator), TEGO® Flow ATF, TEGO® Flow 300, TEGO® Flow 460, TEGO® Flow 425 and TEGO® Flow ZFS 460. Suitable radiation-curable lubricants and flow auxiliaries, which can also be used to improve the scratch resistance, are the products TEGO® Rad 2100, TEGO® Rad 2200, TEGO® Rad 2500, TEGO® Rad 2600 and TEGO® Rad 2700, which are likewise obtainable from TEGO.

Such-auxiliaries are available, for example, from BYK as BYK®-300 BYK®-306, BYK®-307, BYK®-310, BYK®-320, BYK®-333, BYK®-341, Byk® 354, Byk®361, Byk®361N, BYK®388.

The auxiliaries in group c2) are optionally employed in a proportion of from about 0 to 3.0% by weight, preferably from about 0 to 2.0% by weight, based on the total weight of the RM formulation.

In group c3), the radiation-curing auxiliaries include, in particular, polysiloxanes having terminal double bonds which are, for example, a constituent of an acrylate group. Such auxiliaries can be crosslinked by actinic or, for example, electron radiation. These auxiliaries generally combine a number of properties together. In the uncrosslinked state, they can act as antifoams, deaerators, lubricants and flow auxiliaries and/or substrate wetting auxiliaries, while, in the crosslinked state, they increase, in particular, the scratch resistance, for example of coatings or films which can be produced using the compositions according to the invention. The improvement in the gloss properties, for example of precisely those coatings or films, is regarded essentially as a consequence of the action of these auxiliaries as antifoams, deaerators and/or lubricants and flow auxiliaries (in the uncrosslinked state).

Examples of suitable radiation-curing auxiliaries are the products TEGO® Rad 2100, TEGO® Rad 2200, TEGO® Rad 2500, TEGO® Rad 2600 and TEGO® Rad 2700 available from TEGO and the product BYK®-371 available from BYK.

Thermally curing auxiliaries in group c3) contain, for example, primary OH groups which are able to react with isocyanate groups, for example of the binder.

Examples of thermally curing auxiliaries which can be used are the products BYK®-370, BYK®-373 and BYK®-375 available from BYK.

The auxiliaries in group c3) are optionally employed in a proportion of from about 0 to 5.0% by weight, preferably from about 0 to 3.0% by weight, based on the total weight of the RM formulation.

The substrate wetting auxiliaries in group c4) serve, in particular, to increase the wettability of the substrate to be printed or coated, for example, by printing inks or coating compositions, for example compositions according to the invention. The generally attendant improvement in the lubricant and flow behaviour of such printing inks or coating compositions has an effect on the appearance of the finished (for example crosslinked) print or coating.

A wide variety of such auxiliaries are commercially available, for example from Tego as TEGO® Wet KL 245, TEGO® Wet 250, TEGO® Wet 260 and TEGO® Wet ZFS 453 and from BYK as BYK®-306, BYK®-307, BYK®-310, BYK®-333, BYK®-344, BYK®-345, BYK®-346 and Byk®-348.

The auxiliaries in group c4) are optionally employed in a proportion of from about 0 to 3.0% by weight, preferably from about 0 to 1.5% by weight, based on the total weight of the liquid-crystalline composition.

The wetting and dispersion auxiliaries in group c5) serve, in particular, to prevent the flooding and floating and the sedimentation of pigments and are therefore, if necessary, suitable in particular in pigmented compositions according to the invention.

These auxiliaries stabilize pigment dispersions essentially through electrostatic repulsion and/or steric hindrance of the pigment particles containing these additives, where, in the latter case, the interaction of the auxiliary with the ambient medium (for example binder) plays a major role.

Since the use of such wetting and dispersion auxiliaries is common practice, for example in the technical area of printing inks and paints, the selection of a suitable auxiliary of this type generally does not present the person skilled in the art with any difficulties, if they are used.

Such wetting and dispersion auxiliaries are commercially available, for example from Tego, as TEGO® Dispers 610, TEGO® Dispers 610 S, TEGO® Dispers 630, TEGO® Dispers 700, TEGO® Dispers 705, TEGO® Dispers 710, TEGO® Dispers 720 W, TEGO® Dispers 725 W, TEGO® Dispers 730 W, TEGO® Dispers 735 W and TEGO® Dispers 740 W and from BYK as Disperbyk®, Disperbyk®-107, Disperbyk®-108, Disperbyk®-110, Disperbyk®-111, Disperbyk®-115, Disperbyk®-130, Disperbyk®-160, Disperbyk®-161, Disperbyk®-162, Disperbyk®-163, Disperbyk®-164, Disperbyk®-165, Disperbyk®-166, Disperbyk®-167, Disperbyk®-170, Disperbyk®-174, Disperbyk®-180, Disperbyk®-181, Disperbyk®-182, Disperbyk®-183, Disperbyk®-184, Disperbyk®-185, Disperbyk®-190, Anti-Terra®-U, Anti-Terra®-U 80, Anti-Terra®-P, Anti-Terra®-203, Anti-Terra®-204, Anti-Terra®-206, BYK®-151, BYK®-154, BYK®-155, BYK®—P 104 S, BYK®—P 105, Lactimon®, Lactimon®-WS and Bykumen®.

The amount of the auxiliaries in group c5) used on the mean molecular weight of the auxiliary. In any case, a preliminary experiment is therefore advisable, but this can be accomplished simply by the person skilled in the art.

Another preferred group of auxiliaries, which can be allocated to group c2), c4) or c5), includes wetting-, flow- and leveling agents, in particular based on non-ionic fluorosurfactants, which are commercially available from Synthomer under the Polyfox™ series, for example Polyfox™ PF-656.

The hydrophobicizing agents in group c6) can be used to give water-repellent properties to prints or coatings produced, for example, using compositions according to the invention. This prevents or at least greatly suppresses swelling due to water absorption and thus a change in, for example, the optical properties of such prints or coatings. In addition, when the composition is used, for example, as a printing ink in offset printing, water absorption can thereby be prevented or at least greatly reduced.

Such hydrophobicizing agents are commercially available, for example, from Tego as Tego® Phobe WF, Tego® Phobe 1000, Tego® Phobe 1000 S, Tego® Phobe 1010, Tego® Phobe 1030, Tego® Phobe 1010, Tego® Phobe 1010, Tego® Phobe 1030, Tego® Phobe 1040, Tego® Phobe 1050, Tego® Phobe 1200, Tego® Phobe 1300, Tego® Phobe 1310 and Tego® Phobe 1400.

The auxiliaries in group c6) are optionally employed in a proportion of from about 0 to 5.0% by weight, preferably from about 0 to 3.0% by weight, based on the total weight of the RM formulation.

Adhesion promoters from group c7) serve to improve the adhesion of two interfaces in contact. It is directly evident from this that essentially the only fraction of the adhesion promoter that is effective is that located at one or the other or at both interfaces. If, for example, it is desired to apply liquid or pasty printing inks, coating compositions or paints to a solid substrate, this generally means that the adhesion promoter must be added directly to the latter or the substrate must be pre-treated with the adhesion promoters (also known as priming), i.e. this substrate is given modified chemical and/or physical surface properties.

If the substrate has previously been primed with a primer, this means that the interfaces in contact are that of the primer on the one hand and of the printing ink or coating composition or paint on the other hand. In this case, not only the adhesion properties between the substrate and the primer, but also between the substrate and the printing ink or coating composition or paint play a part in adhesion of the overall multilayer structure on the substrate.

Adhesion promoters in the broader sense which may be mentioned are also the substrate wetting auxiliaries already listed under group c4), but these generally do not have the same adhesion promotion capacity.

In view of the widely varying physical and chemical natures of substrates and of printing inks, coating compositions and paints intended, for example, for their printing or coating, the multiplicity of adhesion promoter systems is not surprising.

Adhesion promoters based on silanes are, for example, 3-aminopropyltrimethoxysilane, 3-aminopropyltriethoxysilane, 3-aminopropylmethyldiethoxysilane, N-aminoethyl-3-aminopropyltrimethoxysilane, N-aminoethyl-3-aminopropylmethyldimethoxysilane, N-methyl-3-aminopropyltrimethoxysilane, 3-ureidopropyltriethoxysilane, 3-methacryloyloxypropyltrimethoxysilane, 3-glycidyloxypropyltrimethoxysilane, 3-mercaptopropyltrimethoxysilane, 3-chloropropyltrimethoxysilane and vinyltrimethoxysilane. These and other silanes are commercially available from Hüls, for example under the tradename DYNASILAN®.

Corresponding technical information from the manufacturers of such additives should generally be used or the person skilled in the art can obtain this information in a simple manner through corresponding preliminary experiments.

However, if these additives are to be added as auxiliaries from group c7) to the RM formulations according to the invention, their proportion optionally corresponds to from about 0 to 5.0% by weight, based on the total weight of the RM formulation. These concentration data serve merely as guidance, since the amount and identity of the additive are determined in each individual case by the nature of the substrate and of the printing/coating composition. Corresponding technical information is usually available from the manufacturers of such additives for this case or can be determined in a simple manner by the person skilled in the art through corresponding preliminary experiments.

The auxiliaries for improving the scratch resistance in group c8) include, for example, the abovementioned products TEGO® Rad 2100, TEGO® Rad 2200, TEGO® Rad 2500, TEGO® Rad 2600 and TEGO® Rad 2700, which are available from Tego.

For these auxiliaries, the amount data given for group c3) are likewise suitable, i.e. these additives are optionally employed in a proportion of from about 0 to 5.0% by weight, preferably from about 0 to 3.0% by weight, based on the total weight of the liquid-crystalline composition.

Examples which may be mentioned of light, heat and/or oxidation stabilizers are the following:
alkylated monophenols, such as 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which have a linear or branched side chain, for example 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures of these compounds, alkylthiomethylphenols, such as 2,4-dioctylthiomethyl-6-tert-butylphenol, 2,4-dioctylthiomethyl-6-methylphenol, 2,4-dioctylthiomethyl-6-ethylphenol and 2,6-didodecylthiomethyl-4-nonylphenol,
Hydroquinones and alkylated hydroquinones, such as 2,6-di-tert-butyl-4-methoxyphenol, 2,5-di-tert-butylhydroquinone, 2,5-di-tert-amyihydrocrainone, 2,6-diphenyl-4-octadecyloxyphenol, 2,6-di-tert-butyihydroquinone, 2,5-di-tert-butyl-4-hydroxyanisole, 3,5-di-tert-butyl-4-hydroxyanisole, 3,5-di-tert-butyl-4-hydroxyphenyl stearate and bis(3,5-di-tert-butyl-4-hydroxyphenyl)adipate,
Tocopherols, such as α-tocopherol, β-tocopherol, γ-tocopherol, b-tocopherol and mixtures of these compounds, and tocopherol derivatives, such as tocopheryl acetate, succinate, nicotinate and polyoxyethylenesuccinate (“tocofersolate”),
hydroxylated diphenyl thioethers, such as 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol) and 4,4′-bis(2,6-dimethyl-4-hydroxyphenyl)disulfide,
Alkylidenebisphenols, such as 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecyl-mercaptobutane, ethylene glycol bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl]terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecyl-mercaptobutane and 1,1,5,5-tetrakis(5-tert-butyl-4-hydroxy-2-methylphenyl)pentane,
O—, N- and S-benzyl compounds, such as 3,5,3′,5′-tetra-tert-butyl-4,4′-dihydroxydibenzyl ether, octadecyl 4-hydroxy-3,5-dimethylbenzylmercaptoacetate, tridecyl 4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide and isooctyl-3,5-di-tert-butyl-4-hydroxybenzylmercaptoacetate,
aromatic hydroxybenzyl compounds, such as 1,3,5-tris(3,5-di-tert-butyl-4-hydroxybenzyl)-2,4,6-trimethyl-benzene, 1,4-bis(3,5-di-tert-butyl-4-hydroxybenzyl)-2,3,5,6-tetramethyl-benzene and 2,4,6-tris(3,5-di-tert-butyl-4-hydroxybenzyl)phenol,
Triazine compounds, such as 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris-(3,5-di-tert-butyl-4-hydroxyphenylpropionyl)hexahydro-1,3,5-triazine, 1,3,5-tris(3,5-dicyclohexyl-4-hydroxybenzyl)isocyanurate and 1,3,5-tris(2-hydroxyethyl)isocyanurate,
Benzylphosphonates, such as dimethyl 2,5-di-tert-butyl-4-hydroxybenzylphosphonate, diethyl 3,5-di-tert-butyl-4-hydroxybenzylphosphonate, dioctadecyl 3,5-di-tert-butyl-4-hydroxybenzylphosphonate and dioctadecyl 5-tert-butyl-4-hydroxy-3-methylbenzylphosphonate,
Acylaminophenols, such as 4-hydroxylauroylanilide, 4-hydroxystearoylanilide and octyl N-(3,5-di-tert-butyl-4-hydroxyphenyl)carbamate,
Propionic and acetic esters, for example of monohydric or polyhydric alcohols, such as methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxalamide, 3-thiaundecanol, 3-thiapentadecanol, trimethylhexanediol, trimethylolpropane and 4-hydroxymethyl-1-phospha-2,6,7-trioxabicyclo[2.2.2]-octane,
Propionamides based on amine derivatives, such as N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine and N,N′-bis(3,5-di-tert-butyl-4-hydroxyphenylpropionyl)hydrazine,
Ascorbic acid (Vitamin C) and ascorbic acid derivatives, such as ascorbyl palmitate, laurate and stearate, and ascorbyl sulfate and phosphate,
Antioxidants based on amine compounds, such as N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octyl-substituted diphenylamine, such as p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis[4-methoxyphenyl)amine, 2,6-di-tert-butyl-4-dimethylaminomethylphenol, 2,4-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octyl-substituted N-phenyl-1-naphthylamine, a mixture of mono- and dialkylated tert-butyl/tert-octyldiphenylamine, a mixture of mono- and dialkylated nonyldiphenylamine, a mixture of mono- and dialkylated dodecyldiphenylamine, a mixture of mono- and dialkylated isopropyl/isohexyldiphenylamine, a mixture of mono- and dialkylated tert-butyldiphenylamine, 2,3-dihydro-3,3-dimethyl-4H-1,4-benzothiazine, phenothiazine, a mixture of mono- and dialkylated tert-butyl/tert-octylphenothiazine, a mixture of mono- and dialkylated tert-octylphenothiazine, N-allylphenothiazine, N,N,N′,N′-tetraphenyl-1,4-diaminobut-2-ene, N,N-bis(2,2,6,6-tetramethylpiperidin-4-yl)hexamethylenediamine, bis(2,2,6,6-tetramethylpiperidin-4-yl)sebacate, 2,2,6,6-tetramethylpiperidin-4-one and 2,2,6,6-tetramethylpiperidin-4-ol,
Phosphines, Phosphites and phosphonites, such as triphenylphosnine triphenylphosphite, diphenyl alkyl phosphite, phenyl dialkyl phosphite, tris(nonylphenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,6-di-tert-butyl-4-methylphenyl)pentaerythritol diphosphite, diisodecyloxy pentaerythritol diphosphite, bis(2,4-di-tert-butyl-6-methylphenyl)pentaerythritol diphosphite, bis(2,4,6-tris(tert-butylphenyl))pentaerythritol diphosphite, tristearyl sorbitol triphosphite, tetrakis(2,4-di-tert-butylphenyl)4,4′-biphenylenediphosphonite, 6-isooctyloxy-2,4,8,10-tetra-tert-butyl-12H-dibenz[d,g]-1,3,2-dioxaphosphocine, 6-fluoro-2,4,8,10-tetra-tert-butyl-12-methyl-dibenz[d,g]-1,3,2-dioxaphosphocine, bis(2,4-di-tert-butyl-6-methylphenyl)methyl phosphite and bis(2,4-di-tert-butyl-6-methylphenyl)ethyl phosphite,
2-(2′-Hydroxyphenyl)benzotriazoles, such as 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3,5′-bis-(α,α-dimethylbenzyl)-2′-hydroxyphenyl)benzotriazole, a mixture of 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxy phenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxy phenyl)benzotriazole, 2-(3′-dodecyl-2′-hydroxy-5′-methylphenyl)benzotriazole and 2-(3′-tert-butyl-2′-hydroxy-5′-(2-isooctyloxycarbonylethyl)phenyl benzotriazole, 2,2′-methylenebis[4-(1,1,3,3-tetramethylbutyl)-6-benzotriazol-2-ylphenol]; the product of complete esterification of 2-[3′-tert-butyl-5′-(2-methoxycarbonylethyl)-2′-hydroxyphenyl]-2H-benzotriazole with polyethylene glycol 300;
sulfur-containing peroxide scavengers and sulfur-containing antioxidants, such as esters of 3,3′-thiodipropionic acid, for example the lauryl, stearyl, myristyl and tridecyl esters, mercaptobenzimidazole and the zinc salt of 2-mercaptobenzimidazole, dibutylzinc dithiocarbamates, dioctadecyl disulfide and pentaerythritol tetrakis(β-dodecylmercapto)propionate,
2-hydroxybenzophenones, such as the 4-hydroxy, 4-methoxy, 4-octyloxy, 4-decycloxy, 4-dodecyloxy, 4-benzyloxy, 4,2′,4′-trihydroxy and 2′-hydroxy-4,4′-dimethoxy derivatives,
Esters of unsubstituted and substituted benzoic acids, such as 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl-3,5-di-tert-butyl-4-hydroxybenzoate, octadecyl-3,5-di-tert-butyl-4-hydroxybenzoate and 2-methyl-4,6-di-tert-butylphenyl-3,5-di-tert-butyl-4-hydroxybenzoate,
Acrylates, such as ethyl α-cyano-β,β-diphenylacrylate, isooctyl α-cyano-β,β-diphenylacrylate, methyl α-methoxycarbonylcinnamate, methyl α-cyano-β-methyl-p-methoxycinnamate, butyl-α-cyano-β-methyl-p-methoxycinnamate and methyl-α-methoxycarbonyl-p-methoxycinnamate, sterically hindered amines, such as bis(2,2,6,6-tetramethylpiperidin-4-yl)sebacate, bis(2,2,6,6-tetramethylpiperidin-4-yl)succinate, bis(1,2,2,6,6-pentamethylpiperidin-4-yl)sebacate, bis(1-octyloxy-2,2,6,6-tetramethylpiperidin-4-yl)sebacate, bis(1,2,2,6,6-pentamethylpiperidin-4-yl)-n-butyl-3,5-di-tert-butyl-4-hydroxybenzylmalonate, the condensation product of 1-(2-hydroxyethyl)-2,2,6,6-tetramethyl-4-hydroxypiperidine and succinic acid, the condensation product of N,N′-bis(2,2,6,6-tetramethylpiperidin-4-yl)hexamethylenediamine and 4-tert-octylamino-2,6-dichloro-1,3,5-triazine, tris(2,2,6,6-tetramethylpiperidin-4-yl)nitrilotriacetate, tetrakis(2,2,6,6-tetramethylpiperidin-4-yl)1,2,3,4-butanetetracarboxylate, 1,1′-(1,2-ethylene)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidin-4-yl)2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidin-4-yl)sebacate, bis(1-octyloxy-2,2,6,6-tetramethylpiperidin-4-yl)succinate, the condensation product of N,N′-bis(2,2,6,6-tetramethylpiperidin-4-yl)hexamethylenediamine and 4-morpholino-2,6-dichloro-1,3,5-triazine, the condensation product of 2-chloro-4,6-bis(4-n-butylamino-2,2,6,6-tetramethylpiperidin-4-yl)-1,3,5-triazine and 1,2-bis(3-aminopropylamino)ethane, the condensation product of 2-chloro-4,6-di(4-n-butylamino-1,2,2,6,6-pentamethylpiperidin-4-yl)-1,3,5-triazine and 1,2-bis(3-aminopropylamino)ethane, 8-acetyl-3-dodecyl-7,7,9,9-tetramethyl-1,3,8-triazaspiro[4.5]-decane-2,4-dione, 3-dodecyl-1-(2,2,6,6-tetramethylpiperidin-4-yl)pyrrolidine-2,5-dione, 3-dodecyl-1-(1,2,2,6,6-pentamethylpiperidin-4-yl)pyrrolidine-2,5-dione, a mixture of 4-hexadecyloxy- and 4-stearyloxy-2,2,6,6-tetramethylpiperidine, the condensation product of N,N′-bis(2,2,6,6-tetramethylpiperidin-4-yl)hexamethylenediamine and 4-cyclohexylamino-2,6-dichloro-1,3,5-triazine, the condensation product of 1,2-bis(3-aminopropylamino)ethane and 2,4,6-trichloro-1,3,5-triazine, 4-butylamino-2,2,6,6-tetramethylpiperidine, N-(2,2,6,6-tetramethylpiperidin-4-yl)-n-dodecylsuccinimide, N-(1,2,2,6,6-pentamethylpiperidin-4-yl)-n-dodecylsuccinimide, 2-undecyl-7,7,9,9-tetramethyl-1-oxa-3,8-diaza-4-oxospiro[4.5]-decane, the condensation product of 7,7,9,9-tetramethyl-2-cycloundecyl-1-oxa-3,8-diaza-4-oxospiro-[4.5]decane and epichlorohydrin, the condensation products of 4-amino-2,2,6,6-tetramethylpiperidine with tetramethylolacetylenediureas and poly(methoxypropyl-3-oxy)-[4(2,2,6,6-tetramethyl)piperidinyl]-siloxane,
Oxalamides, such as 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxalamide, 2-ethoxy-5-tert-butyl-2′-ethoxanilide and its mixture with 2-ethoxy-2′-ethyl-5,4′-di-tert-butoxanilide, and mixtures of ortho-, para-methoxy-disubstituted oxanilides and mixtures of ortho- and para-ethoxy-disubstituted oxanilides, and
2-(2-hydroxyphenyl)-1,3,5-triazines, such as 2,4,6-tris-(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropoxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis-(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine and 2-(2-hydroxyphenyl)-4-(4-methoxyphenyl)-6-phenyl-1,3,5-triazine.

In a preferred embodiment the RM formulation is dissolved in a suitable solvent, which are preferably selected from organic solvents.

The solvents are preferably selected from ketones such as acetone, methyl ethyl ketone, methyl propyl ketone, methyl isobutyl ketone or cyclohexanone; acetates such as methyl, ethyl or butyl acetate or methyl acetoacetate; alcohols such as methanol, ethanol or isopropyl alcohol; aromatic solvents such as toluene or xylene; alicyclic hydrocarbons such as cyclopentane or cyclohexane; halogenated hydrocarbons such as di- or trichloromethane; glycols or their esters such as PGMEA (propyl glycol monomethyl ether acetate), γ-butyrolactone. It is also possible to use binary, ternary or higher mixtures of the above solvents. In particular, for multilayer applications, methyl iso butyl ketone is the preferred utilized solvent

In case the RM formulation contains one or more solvents, the total concentration of all solids, including the RMs, in the solvent(s) is preferably from 5 to 60%, more preferably from 10 to 50%, in particular from 10 to 35%.

Preferably, the RM formulation comprises, in addition to one or more compounds or formula I, I1, I2 and one or more chiral compounds:
a) optionally one or more multi- or direactive polymerizable mesogenic compounds, preferably selected from compounds of formula DRM and corresponding subformulae, and/or
b) optionally one or more monoreactive mesogens, preferably selected from compounds of formula MRM and corresponding subformulae, and/or
c) optionally one or more photoinitiators, and/or
d) optionally one or more antioxidative additives, and/or
e) optionally one or more adhesion promotors, and/or
f) optionally one or more surfactants, and/or
g) optionally one or more mono-, di- or multireactive polymerizable non-mesogenic compounds, and/or
h) optionally one or more dyes showing an absorption maximum at the wavelength used to initiate photo polymerization, and/or
i) optionally one or more chain transfer agents, and/or
j) optionally one or more (UV) stabilizers, and/or
k) optionally one or more lubricants and flow auxiliaries, and
l) optionally one or more diluents, and/or
m) optionally a non-polymerizable nematic component, and/or
n) optionally one or more organic solvents.

More preferably, the RM formulation comprises:
a) one or more compounds of formula I, preferably one or more compounds of formula I1 and one or more compounds of formula I2, or their corresponding preferred subformulae,
b) one or more chiral compounds, preferably selected from formulae CRM1 to CRM-3 and/or formulae C—I to C—III, or their corresponding preferred subformulae,
c) optionally one or more, preferably two or more, direactive polymerizable mesogenic compounds, preferably selected from the compounds of formula DRMa-1,
d) optionally one or more, preferably two or more, monoreactive polymerizable mesogenic compounds, preferably selected from compounds of formulae MRM-1, and/or MRM-4, and/or MRM-6, and/or MRM-7,
e) optionally one or more antioxidative additives,
f) optionally one or more photoinitiators,
g) optionally one or more organic solvents.

The invention further relates to a method of preparing a polymer film by
providing a layer of an RM mixture or RM formulation as described above and below onto a substrate,
removing any solvents,
optionally annealing the layer of the RM mixture,
polymerizing the polymerizable components of the RM formulation by photopolymerization, and
optionally removing the polymerized film from the substrate and/or optionally providing it onto another substrate.

The RM formulation can be coated or printed onto the substrate, for example by spin-coating, printing, or other known techniques, and the solvent is evaporated off before polymerization. In most cases, it is suitable to heat the mixture in order to facilitate the evaporation of the solvent.

The RM formulation can be applied onto a substrate by conventional coating techniques like spin coating, bar coating or blade coating. It can also be applied to the substrate by conventional printing techniques which are known to the expert, like for example screen printing, offset printing, reel-to-reel printing, letter press printing, gravure printing, rotogravure printing, flexographic printing, intaglio printing, pad printing, heat-seal printing, ink-jet printing or printing by means of a stamp or printing plate.

Suitable substrate materials and substrates are known to the expert and described in the literature, as for example conventional substrates used in the optical films industry, such as glass or plastic. Especially suitable and preferred substrates for polymerization are polyester such as polyethyleneterephthalate (PET) or polyethylenenaphthalate (PEN), polyvinylalcohol (PVA), polycarbonate (PC) triacetylcellulose (TAC), or cyclo olefin polymers (COP), or commonly known color filter materials, in particular triacetylcellulose (TAC), cyclo olefin polymers (COP), or commonly known color filter materials. Also an optical film obtainable from another or the same RM material can serve as a substrate. This is especially preferred if multilayer systems should be designed comprising one, two, three, four, five or more optical films in an optical component.

The RM formulation preferably exhibits a uniform alignment throughout the whole layer. Preferably the RM formulation exhibits a uniform planar alignment.

The Friedel-Creagh-Kmetz rule can be used to predict whether a mixture will adopt planar or homeotropic alignment, by comparing the surface energies of the RM layer (γ_{RM}) and the substrate (γₛ):

If γ_{RM}>γₛ the reactive mesogenic compounds will display homeotropic alignment, If γ_{RM}<γₛ the reactive mesogenic compounds will display homogeneous alignment.

Without to be bound by theory, when the surface energy of a substrate is relatively low, the intermolecular forces between the reactive mesogens are stronger than the forces across the RM-substrate interface and consequently, reactive mesogens align perpendicular to the substrate (homeotropic alignment) in order to maximize the intermolecular forces.

Homeotropic alignment can also be achieved by using amphiphilic materials; they can be added directly to the polymerizable LC material, or the substrate can be treated with these materials in the form of a homeotropic alignment layer. The polar head of the amphiphilic material chemically bonds to the substrate, and the hydrocarbon tail points perpendicular to the substrate. Intermolecular interactions between the amphiphilic material and the RMs promote homeotropic alignment. Commonly used amphiphilic surfactants are described above.

Another method used to promote homeotropic alignment is to apply corona discharge treatment to plastic substrates, generating alcohol or ketone functional groups on the substrate surface. These polar groups can interact with the polar groups present in RMs or surfactants to promote homeotropic alignment.

When the surface tension of the substrate is greater than the surface tension of the RMs, the force across the interface dominates. The interface energy is minimised if the reactive mesogens align parallel with the substrate, so the long axis of the RM can interact with the substrate. One way planar alignment can be promoted is by coating the substrate with a polyimide layer, and then rubbing the alignment layer with a velvet cloth.

Other suitable planar alignment layers are known in the art, like for example rubbed polyimide or alignment layers prepared by photoalignment as described in U.S. Pat. No. 5,602,661, 5,389,698 or 6,717,644.

In general, reviews of alignment techniques are given for example by I. Sage in “Thermotropic Liquid Crystals”, edited by G. W. Gray, John Wiley & Sons, 1987, pages 75-77; and by T. Uchida and H. Seki in “Liquid Crystals—Applications and Uses Vol. 3”, edited by B. Bahadur, World Scientific Publishing, Singapore 1992, pages 1-63. A further review of alignment materials and techniques is given by J. Cognard, Mol. Cryst. Liq. Cryst. 78, Supplement 1 (1981), pages 1-77.

However, it is likewise preferred, that the orientation of the RM molecules vary though the layer thickness. Such as splayed alignments, tilted or twisted alignment types commonly known by the expert.

For the production of the polymer films according to the invention, the polymerizable compounds in the RM formulation are polymerized or crosslinked (if one compound contains two or more polymerizable groups) by in-situ photopolymerization.

The photopolymerization can be carried out in one step. It is also possible to photopolymerize or crosslink the compounds in a second step, which have not reacted in the first step (“end curing”).

In a preferred method of preparation the RM formulation is coated onto a substrate and subsequently photopolymerized for example by exposure to actinic radiation as described for example in WO 01/20394, GB 2,315,072 A or WO 98/04651 A1.

Photopolymerization of the LC material is preferably achieved by exposing it to actinic radiation. Actinic radiation means irradiation with light, like UV light, IR light or visible light, irradiation with X-rays or gamma rays, or irradiation with high-energy particles, such as ions or electrons. Preferably, polymerization is carried out by photo irradiation, in particular with UV light. As a source for actinic radiation, for example a single UV lamp or a set of UV lamps can be used. When using a high lamp power the curing time can be reduced. Another possible source for photo radiation is a laser, like e.g. a UV laser, an IR laser, or a visible laser. Another possible source for photo radiation is a LED lamp.

The curing time is dependent, inter alia, on the reactivity of the polymerizable LC material, the thickness of the coated layer, the type of polymerization initiator and the power of the UV lamp. The curing time is preferably ≤5 minutes, very preferably ≤3 minutes, most preferably ≤1 minute. For mass production, short curing times of 30 seconds are preferred.

A suitable UV radiation power is preferably in the range from 5 to 200 mWcm-2, more preferably in the range from 50 to 175 mWcm⁻² and most preferably in the range from 100 to 150 mWcm⁻².

In connection with the applied UV radiation and as a function of time, a suitable UV dose is preferably in the range from 25 to 7200 mJcm⁻² more preferably in the range from 100 to 7200 mJcm⁻² and most preferably in the range from 200 to 7200 mJcm⁻².

Photopolymerization is preferably performed under an inert gas atmosphere, preferably in a heated nitrogen atmosphere, but also polymerization in air is possible.

Photopolymerization is preferably performed at a temperature from 1 to 70° C., more preferably 5 to 50° C., even more preferably 15 to 30° C.

The polymer film according to the present invention has good adhesion to plastic substrates, in particular to TAC, COP, and color filters. Accordingly, it can be used as adhesive or base coating for subsequent LC layers which otherwise would not well adhere to the substrates.

For optical applications of the polymer film, it preferably has a thickness of from 0.1 to 10 μm, very preferably from 0.1 to 2 μm, in particular from 0.1 to 1 μm.

The optical retardation (δ(λ)) of a polymer film as a function of the wavelength of the incident beam (λ) is given by the following equation (7):

$$δ ( λ ) = ( 2 π Δ n \cdot d ) / λ \qquad ( 7 )$$

wherein (Δn) is the birefringence of the film, (d) is the thickness of the film and λ is the wavelength of the incident beam.

According to Snellius law, the birefringence as a function of the direction of the incident beam is defined as

$$Δ n = sin Θ / sin Ψ \qquad ( 8 )$$

wherein sin Θ is the incidence angle or the tilt angle of the optical axis in the film and sin Ψ is the corresponding reflection angle.

Based on these laws, the birefringence and accordingly optical retardation depends on the thickness of a film and the tilt angle of optical axis in the film (cf. Berek's compensator). Therefore, the skilled expert is aware that different optical retardations or different birefringence can be induced by adjusting the orientation of the liquid-crystalline molecules in the polymer film.

The birefringence (Δn) of the polymer film according to the present invention is preferably in the range from 0.25 to 0.8, more preferably from 0.3 to 0.7, very preferably from 0.35 to 0.55.

The polymer film of the present invention can also be used as alignment film or substrate for other liquid-crystalline or RM materials. The inventors have found that the polymer film obtainable from a RM formulation as described above and below, is in particular useful for multilayer applications due to its improved dewetting characteristics. In this way, stacks of optical films or preferably polymerized LC films can be prepared.

In a preferred embodiment the present invention the polymer film comprises two or more layers of a polymerized RM mixture or RM formulation as described above and below.

The invention further relates to an optical, electro-optical or electronic device or a component comprising an RM mixture or a polymer film as described above and below.

In particular, the invention relates to a diffraction grating, preferably a PBG or Bragg PG, comprising two or more LC polymer (LCP) layers obtained from an RM mixture or RM formulation according to the present invention as described above and below.

The invention further relates to a process of preparing a diffraction grating, preferably a PBG or Bragg PG, and to a diffraction grating, preferably a PBG or Bragg PG, obtained by said process, wherein said process comprises the steps of:
A1) providing a first layer of an RM mixture or RM formulation according to the invention onto a substrate, preferably a substrate which has a surface grating or pattern, preferably by coating or printing,
A2) removing any solvents present,
A3) optionally annealing the first layer of the RM mixture or RM formulation, preferably at a temperature where it is in the chiral nematic phase,
A4) polymerizing the RM mixture or RM formulation, preferably by exposure to UV light, under an inert atmosphere,
B1) providing a second layer of an RM mixture or RM formulation according to the invention on to the first layer, preferably by coating or printing,
B2) removing any solvents present,
B3) optionally annealing the second layer of the RM mixture or RM formulation, preferably at a temperature where it is in the chiral nematic phase,
B4) polymerizing the RM mixture or RM formulation, preferably by exposure to UV light, under an inert atmosphere.

A third, fourth or further layers can be prepared by repeating process steps B1) to B4) using a different RM mixture or formulation.

The RM mixture or formulation of the first layer and the RM mixture or formulation of the second layer are preferably different from each other. In a preferred embodiment the RM mixtures used for preparation of the first and second layer, respectively, contain different amounts of the chiral compound(s) and/or contain chiral compounds with different HTP. As a consequence the helical pitch of the first and second layer will be different from each other. Very preferably the RM mixture or formulation of the second layer contains a higher amount of the same chiral compound than the RM mixture or formulation of the first layer, and/or the RM mixture or formulation of the second layer contains a chiral compound with a higher HTP than the RM mixture or formulation of the first layer. Preferably the helical pitch in the first layer is longer than the helical pitch in the second layer.

The RM mixtures and methods of the present invention allow a simple way of preparing a multilayer of two or more chiral LC polymer films, by using one achiral RM host mixture comprising, or consisting of, one or more compounds of formula I, preferably one or more compounds of formula I1 and one or more compounds of formula I2, and optionally one or more compounds of formula DRM and/or MRM. This achiral RM host mixture can be used for the preparation of each individual layer. Chiral RM mixtures for use in the first, second or further layers, respectively, are prepared by adding different amounts of the same chiral compound to the RM host mixture, or by adding chiral compounds with differing HTP to the RM host mixture.

In a preferred embodiment the substrate has a surface grating or pattern. In another preferred embodiment the substrate is prepared from a photoalignment layer (PAL) which is patterned by laser interferometry to create a grating pattern with a defined pitch.

The thickness of an individual LCP layer in the diffraction grating is preferably from 100 to 1000 nm, very preferably from 200 to 800 nm. Preferably the first LCP layer has a thickness from 100 to 300 nm, and the second LCP layer has a thickness from 300 to 500 nm.

The helical pitch in a polymer film or an individual LCP layer is preferably from 100 to 1200 nm, very preferably from 150 to 800 nm and most preferably from 200 to 500 nm.

In summary, the polymerized LC films and polymerizable LC materials according to the present invention are useful in optical elements like polarisers, compensators, alignment layer, circular polarisers or color filters in liquid crystal displays or projection systems, decorative images, for the preparation of liquid crystal or effect pigments, and especially in reflective films with spatially varying reflection colors, e.g. as multicolor image for decorative, information storage or security uses, such as non-forgeable documents like identity or credit cards, banknotes etc.

The polymerized LC films according to the present invention can be used in displays of the transmissive or reflective type. They can be used in conventional OLED displays or LCDs, in particular LCDs.

The invention further relates to an optical, electro-optical or electronic device or a component comprising an RM mixture or a polymer film as described above and below.

Said components include, without limitation, optical retardation films, polarizers, optical compensators, diffraction or surface gratings such as Bragg polarization gratings (Bragg PG), polarization volume gratings (PVG) or Pancharatnam Berry gratings (PBG), furthermore nonmechanical beam steering elements, optical waveguides, optical couplers or combiners, polarization beam splitters, partial mirrors, reflective films, alignment layers, color filters, antistatic protection sheets, electromagnetic interference protection sheets, lenses for light guides, focusing and optical effects, polarization controlled lenses, and IR reflection films; for example for use in LC displays (LCDs), organic light emitting diodes (OLEDs), autostereoscopic 3D displays, see-through near-eye displays, augmented reality (AR) or virtual reality (VR) systems, switchable windows, spatial light modulators, optical data storage, remote optical sensing, holography, spectroscopy, optical telecommunications, polarimetry or front/back-lighting.

Said devices include, without limitation, electro optical displays, especially LCDs, OLEDs, autostereoscopic 3D displays, see-through near-eye displays, AR/VR systems, goggles for AR/VR applications, switchable windows, spatial light modulators, optical data storage devices, optical sensors, holographic devices, spectrometers, optical telecommunication systems, polarimeters or front-/backlights.

The present invention is described above and below with particular reference to the preferred embodiments. It should be understood that various changes and modifications might be made therein without departing from the spirit and scope of the invention.

Many of the compounds or mixtures thereof mentioned above and below are commercially available. All of these compounds are either known or can be prepared by methods which are known per se, as described in the literature (for example in the standard works such as Houben-Weyl, Methoden der Organischen Chemie [Methods of Organic Chemistry], Georg-Thieme-Verlag, Stuttgart), to be precise under reaction conditions which are known and suitable for said reactions. Use may also be made here of variants which are known per se, but are not mentioned here.

It will be appreciated that variations to the foregoing embodiments of the invention can be made while still falling within the scope of the invention. Alternative features serving the same, equivalent, or similar purpose may replace each feature disclosed in this specification, unless stated otherwise. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

It will be appreciated that many of the features described above, particularly of the preferred embodiments, are inventive in their own right and not just as part of an embodiment of the present invention. Independent protection may be sought for these features in addition to or alternative to any invention presently claimed.

Unless explicitly noted otherwise, all temperature values indicated in the present application, such as, for example, for the melting point T(K,N), the transition from the smectic (S) to the nematic (N) phase T(S,N) and the clearing point T(N,I), are quoted in degrees Celsius (° C.). Furthermore, K denotes the crystalline state, N denotes the nematic phase, and I denotes the isotropic phase. The data between these symbols represent the transition temperatures.

All physical properties have been and are determined according to “Merck Liquid Crystals, Physical Properties of Liquid Crystals”, Status November 1997, Merck KGaA, Germany and are given for a temperature of 20° C., unless explicitly stated otherwise. The optical anisotropy (Δn) is determined at a wavelength of 589.3 nm.

Above and below, percentages are percent by weight unless stated otherwise. All temperatures are given in degrees Celsius.

Above and below, m.p. denotes the melting point, cl.p. denotes the clearing point, T_{g} denotes glass transition temperature. Furthermore, C denotes the crystalline state, N denotes the nematic phase, SA, SB etc. denotes the smectic A phase, smectic B phase etc., Sₓ denotes an unidentified smectic phase, X denotes an unidentified mesophase and I denotes the isotropic phase. The values between these symbols represent the transition temperature in ° C. Δn denotes the optical anisotropy or birefringence (Δn=nₑ−nₒ, where nₒ denotes the refractive index perpendicular to the longitudinal molecular axes and nₑ denotes the refractive index parallel thereto), measured at 550 nm and 20° C. The optical and electro optical data are measured at 20° C., unless expressly stated otherwise. “Clearing point” and “clearing temperature” mean the temperature of the transition from an LC phase into the isotropic phase.

Unless stated otherwise, the percentages of solid components in an RM mixture or RM formulation as described above and below refer to the total amount of solids in the mixture or formulation, i.e. without any solvents.

Unless stated otherwise, all optical, electro optical properties and physical parameters like birefringence, permittivity, electrical conductivity, electrical resistivity and sheet resistance, refer to a temperature of 20° C.

The invention will now be described in more detail by reference to the following working examples, which are illustrative only and do not limit the scope of the invention.

### EXAMPLES

In the following examples, a pair of chiral RM mixtures with differing amounts of chiral additive is produced and dissolved at 10% solids content in a blended ketone solvent system: butan-2-one:cyclopentanone:4-methylpentan-2-one:2-undecanone in a 1:2:1:2 ratio. The first mixture in the set indicated as the Layer 1 mixture contains a lower chiral loading, typically 3-4%, and no surfactant is included in this mixture. The second mixture indicated as the Layer 2 mixture contains a higher chiral loading, typically 6-7.5%, and a surfactant. All mixtures additionally contain a photoinitiator and a stabilizer.

For each pair of RM mixtures described a photoalignment layer (PAL) is prepared by spin-coating a solution of azobenzene sulfonic dye SD-1 (0.5% in PGME, 3000 rpm 30 s), annealing at 80° C. for 60 s then exposure to a 406 nm laser interferometry setup for 60 s to write a 400 nm pitch grating pattern.

On this freshly prepared PAL layer the Layer 1 mixture is spin-coated (2500 rpm, 30 s); annealed 80° C. for 60 s and cured by exposure to a broadband H-bulb UV lamp (100 mWcm⁻², 40° C., 40 s) under an inert N₂ atmosphere.

The resulting single-layer grating is then overcoated with the Layer 2 mixture; spin-coated (900 rpm, 30 s); annealed 80° C. for 60 s and cured by exposure to a broadband H-bulb UV lamp (100 mWcm⁻², 40° C., 40 s) under an inert N₂ atmosphere.

This method produces a bilayer film with a first layer of ~200 nm in thickness and a second layer of ~400 nm in thickness with a different slant angle in each layer. The resulting grating is then examined by polarized optical microscopy to assess the quality of alignment in the layers.

### Example 1

Ex-1

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| A-3 | 35.00% | 35.00% |

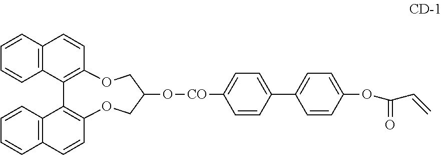 [SMILES: C=CC(=O)Oc1ccc(-c2ccc(C(=O)OC3COc4ccc5ccccc5c4-c4c(ccc5ccccc45)OC3)cc2)cc1]

### Example 2

Ex-2

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| A-4 | 35.00% | 35.00% |

### Example 3

Ex-3

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| A-5 | 35.00% | 35.00% |

### Example 4

Ex-4

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| A-6 | 35.00% | 35.00% |

### Example 5

Ex-5

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| A-7 | 35.00% | 35.00% |

### Example 6

Ex-6

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| A-8 | 35.00% | 35.00% |

### Example 7

Ex-7

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| A-9 | 35.00% | 35.00% |

### Example 8

Ex-8

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| A-10 | 35.00% | 35.00% |

### Example 9

Ex-9

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| A-11 | 35.00% | 35.00% |

### Example 10

Ex-10

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 50.52% | 49.67% |
| B-1 | 31.71% | 29.96% |
| A-2 | 13.04% | 12.32% |

### Example 11

Ex-11

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 48.04% | 47.32% |

### Example 12

Ex-12

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 66.71% | 64.96% |
| A-2 | 13.04% | 12.32% |

### Example 13

Ex-13

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| B-2 | 35.00% | 35.00% |

### Example 14

Ex-14

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| B-2 | 35.00% | 35.00% |

### Example 15

Ex-15

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| B-3 | 35.00% | 35.00% |

### Example 16

Ex-16

| | Layer 1 | Layer 2 |
|---|---|---|
| Component | Weight % | Weight % |
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| B-4 | 35.00% | 35.00% |

### Example 17

| | | |
|---|---|---|
| | Layer 1 | Layer 2 |
| Component | Weight % | Weight % |

Ex-17

| | | |
|---|---|---|
| Surfactant | 0.00% | 0.38% |
| Stabilizer | 0.08% | 0.08% |
| Photoinitiator | 1.50% | 1.50% |
| CD1 | 4.00% | 7.60% |
| A-5 | 37.77% | 36.18% |
| B-2 | 25.49% | 24.42% |
| A-7 | 31.16% | 29.85% |

Ex 18

| | | |
|---|---|---|
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| B-6 | 35.00% | 35.00% |

Ex 19

| | | |
|---|---|---|
| Surfactant | 0.00% | 0.38% |
| Stabilizer | 0.08% | 0.08% |
| Photoinitiator | 1.50% | 1.50% |
| CD1 | 3.15% | 6.10% |
| A-1 | 15.52% | 14.67% |
| B-1 | 31.71% | 29.96% |
| A-2 | 13.04% | 12.32% |
| B-9 | 35.00% | 35.00% |

Observation by polarization optical microscopy confirms that for all LCP PBGs made from the respective Layer 1 and Layer 2 chiral RM mixtures of Examples 1 to 19 a good alignment can be achieved in the resulting two-layer LCP PBG stack, wherein the 400 nm pitch grating texture of the first layer is clearly visible through the second layer.

### Comparison Example 1

Ex-C1

| | Layer C1 | Layer C2 |
|---|---|---|
| Component | Weight % | Weight % |
| Surfactant | 0.00% | 0.20% |
| Stabilizer | 0.08% | 0.08% |
| Photoinitiator | 1.50% | 1.50% |
| CD1 | 3.80% | 6.10% |
| C-1 | 18.92% | 18.34% |
| A-4 | 37.85% | 36.69% |
| C-2 | 18.92% | 18.34% |
| A-7 | 18.92% | 18.34% |

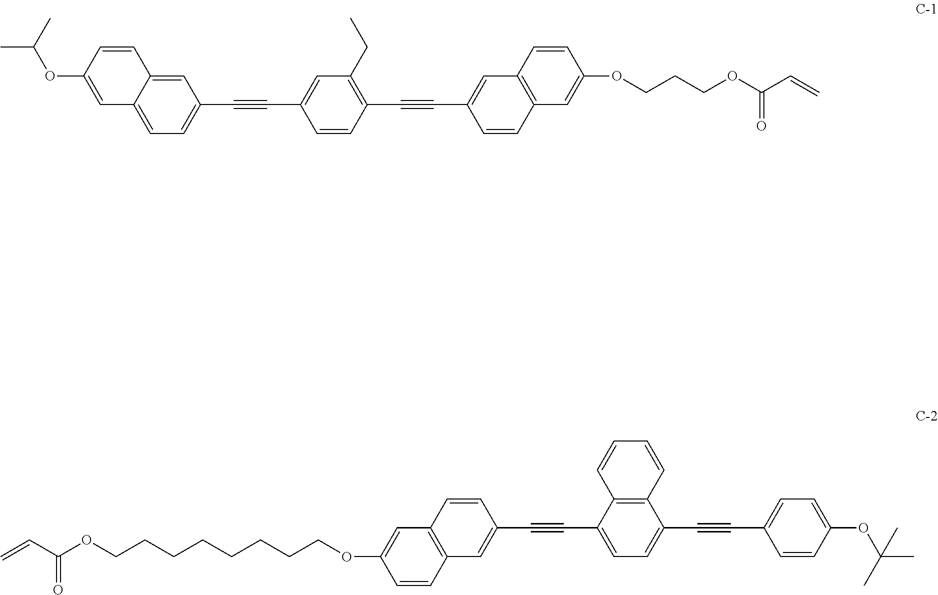

The Layer C1 and C2 chiral RM mixtures contain the monoreactive compounds C-1 and C-2 of formula I3 with bulky terminal alkoxy groups.

An LCP PBG is prepared from the Layer C1 and C2 chiral RM mixtures according to the method described above for Examples 1 to 19.

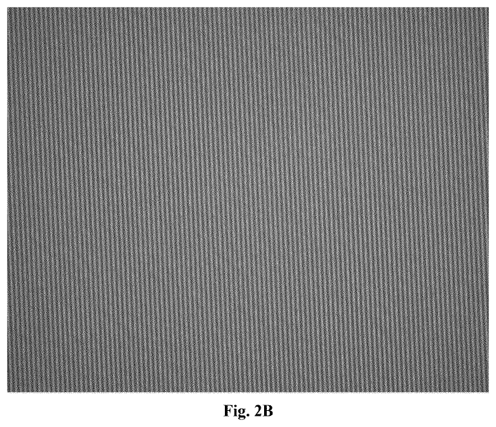

FIG. 2A shows a polarization optical microscopy image using a ×50 objective of an LCP PBG according to Comparison Example 1, with Layer C1 chiral RM mixture coated on top of a well-aligned LCP PBG of Layer C2 chiral RM mixture. The 400 nm pitch grating texture of the first layer is only partially visible behind a messy unaligned schlieren-like texture.

FIG. 2B shows a polarization optical microscopy image using a ×50 objective, of an LCP PBG according to Example 1, with Layer 1 chiral RM mixture coated on top of a well-aligned LCP PBG of Layer 2 chiral RM mixture. The 400 nm pitch grating texture of the first layer is clearly visible.

1. A mixture comprising at least one chiral compound and at least one polymerizable compound of formula I 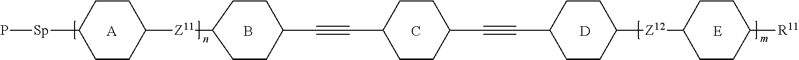
wherein the individual radicals, independently of each other and on each occurrence identically or differently, have the following meanings
P denotes a polymerizable group,
Sp denotes a spacer group or a single bond,
A, B, D, E denote benzene-1,4-diyl, naphthalene-1,4-diyl, naphthalene 2,6-diyl or anthracene-9,10-diyl, each of which is optionally substituted by one or more groups L or P—Sp-,
C denotes benzene-1,4-diyl, naphthalene-1,4-diyl, naphthalene 2,6-diyl, anthracene-9,10-diyl, phenanthrene-2,7-diyl or fluorene-2,7-diyl, each of which is optionally substituted by one or more groups L or P—Sp-,
and one of C and D optionally denotes a single bond,
R¹¹ denotes F, Cl, CN, alkoxy or thioalkyl with 1 or 2 C atoms which is optionally fluorinated, or P—Sp-,
Z¹¹, Z¹² denote —O—, —S—, —CO—, —COO—, —OCO—, —S—CO—, —CO—S—, —O—COO—, —CO—NR⁰—, —NR⁰—CO—, —NR⁰—CO—NR⁰⁰, —NR⁰—CO—O—, —O—CO—NR⁰—, —OCH₂—, —CH₂O—, —SCH₂—, —CH₂S—, —CF₂O—, —OCF₂—, —CF₂S—, —SCF₂—, —CH₂CH₂—, —(CH₂)ₙ₁, —CF₂CH₂—, —CH₂CF₂—, —CF₂CF₂—, —CH═N—, —N═CH—, —N═N—, —CH═CR⁰—, —CY¹═CY²—, —C≡C—, —CH═CH—COO—, —OCO—CH═CH— or a single bond,
Y¹, Y² denote H, F, Cl or CN,
L denotes F, Cl, —CN, P—Sp-, or straight chain, branched or cyclic alkyl having 1 to 25 or 3 to 25 C atoms, wherein one or more non-adjacent CH₂-groups are optionally replaced by —O—, —S—, —CO—, —CO—O—, —O—CO—, —O—CO—O—, CR⁰═CR⁰⁰—, —C≡C—, 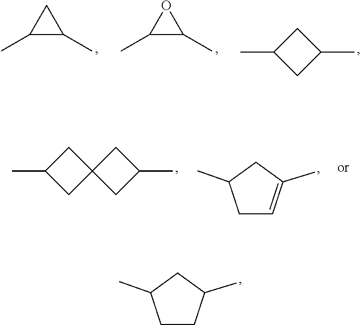
in such a manner that O- and/or S-atoms are not directly connected with each other, and wherein one or more H atoms are each optionally replaced by P—Sp-, F or Cl, or two substituents L that are connected to directly adjacent C atoms optionally form a cycloalkyl or cycloalkenyl group with 5, 6, 7 or 8 C atoms,
R⁰, R⁰⁰ denote H or an alkyl having 1 to 12 C atoms,
n1 denotes 1, 2, 3 or 4,
n denotes 0, 1, 2, 3 or 4,
m denotes 0, 1, 2, 3 or 4,
r denotes 0, 1, 2, 3 or 4,
s denotes 0, 1, 2 or 3, and
t denotes 0, 1 or 2.

2. The mixture according to claim 1, wherein the at least one polymerizable compound of formula I comprises one or more compounds of formula I1 and one or more compounds of formula I2 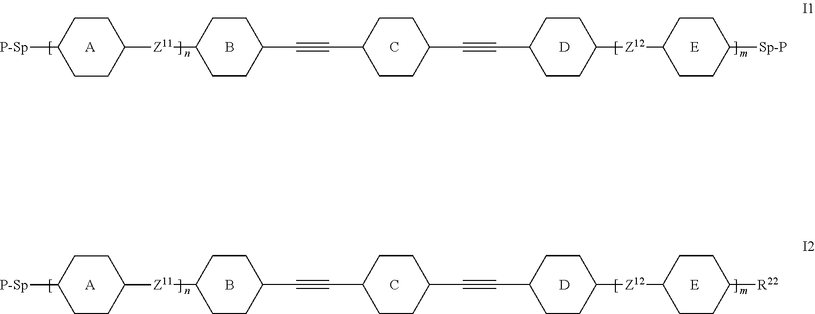
wherein
P denotes a polymerizable group,
Sp denotes a spacer group or a single bond,
A, B, D, E denote benzene-1,4-diyl, naphthalene-1,4-diyl, naphthalene 2,6-diyl or anthracene-9,10-diyl, each of which is optionally substituted by one or more groups L or P—Sp-,
C denotes benzene-1,4-diyl, naphthalene-1,4-diyl, naphthalene 2,6-diyl, anthracene-9,10-diyl, phenanthrene-2,7-diyl or fluorene-2,7-diyl, each of which is optionally substituted by one or more groups L or P—Sp-,
and one of C and D optionally denotes a single bond,
Z¹¹, Z¹² denote —O—, —S—, —CO—, —COO—, —OCO—, —S—CO—, —CO—S—, —O—COO—, —CO—NR⁰—, —NR⁰—CO—, —NR⁰—CO—NR⁰⁰, —NR⁰—CO—O—, —O—CO—NR⁰—, —OCH₂—, CH₂O—, —SCH₂—, —CH₂S—, —CF₂—, —OCF₂—, —CF₂S—, —SCF₂—, —CH₂CH₂—, —(CH₂)ₙ₁, —CF₂CH₂—, —CH₂CF₂—, —CF₂CF₂—, —CH═N—, —N═CH—, —N═N—, —CH═CR⁰—, —CY¹═CY²—, —C≡C—, —CH═CH—COO—, —OCO—CH═CH— or a single bond,
n denotes 0, 1, 2, 3 or 4,
m denotes 0, 1, 2, 3 or 4, and
R²² denotes CN, OCH₃ or SCH₃.

3. The mixture according to claim 1, wherein A, B, C, D and E are selected from the group consisting of 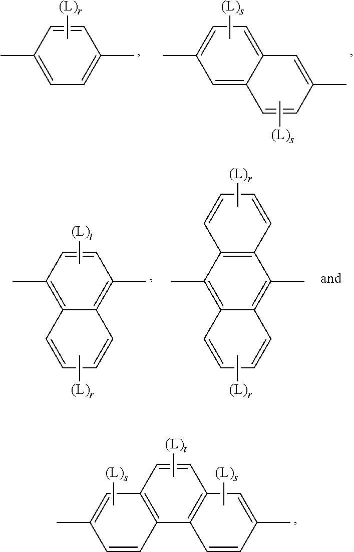
wherein the individual radicals, independently of each other and on each occurrence identically or differently, have the following meanings
L denotes P—Sp-, —CN, F, Cl, or alkyl, alkoxy or thioalkyl which is optionally fluorinated and has 1 to 6,
r denotes 0, 1, 2, 3 or 4,
s denotes 0, 1, 2 or 3, band
t denotes 0, 1 or 2.

4. The mixture according to claim 1, wherein B, C and D are selected form the group consisting of the following formulae and their mirror images: 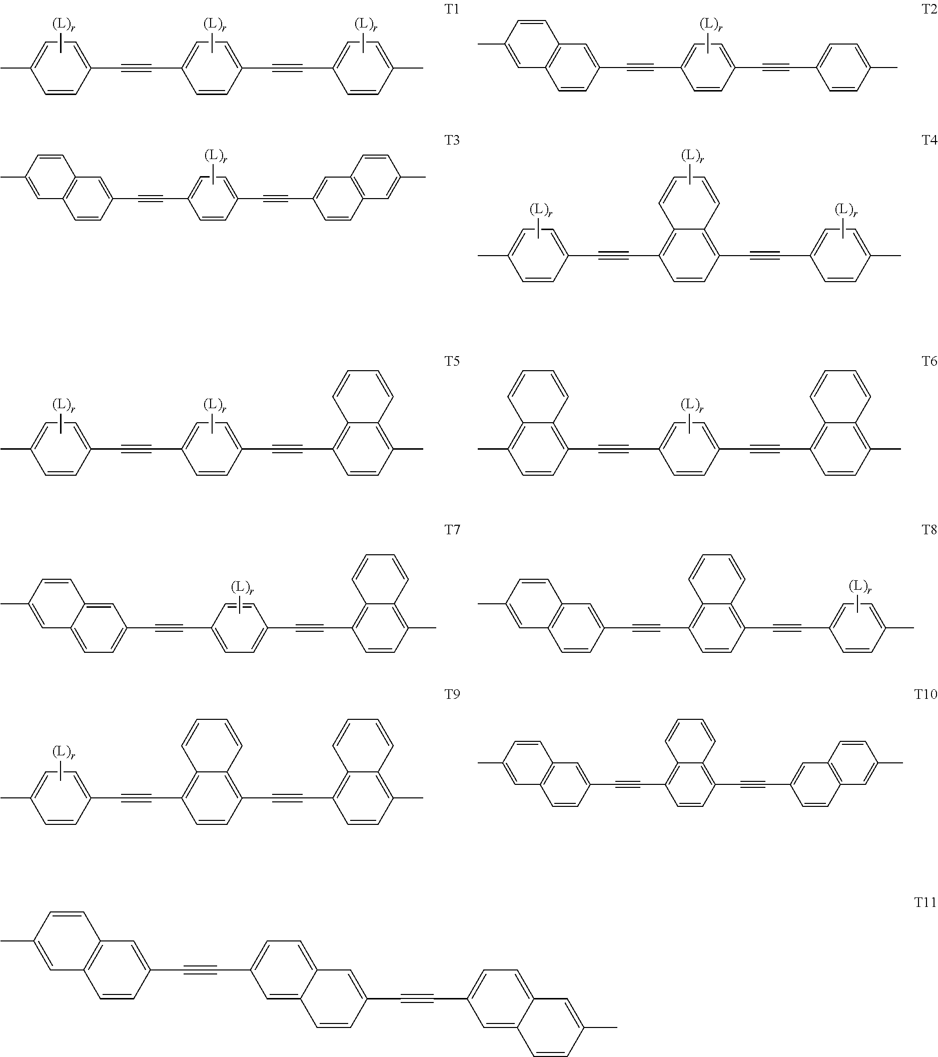 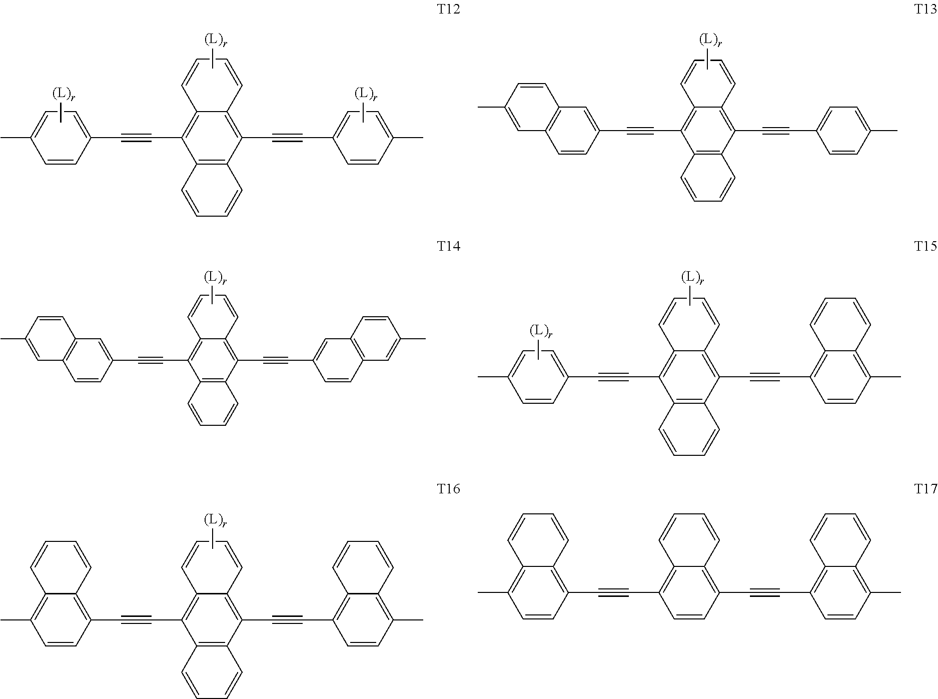
wherein the naphthalene rings are optionally substituted with one or two groups L, and L, on each occurrence identically or differently, denotes P—Sp-, —CN, F, Cl, or alkyl, alkoxy or thioalkyl which is optionally fluorinated and has 1 to 6 C atoms, and r is 0, 1, 2 or 3.

5. The mixture according to claim 1, wherein the at least one polymerizable compound of formula I is selected from the following subformulae: 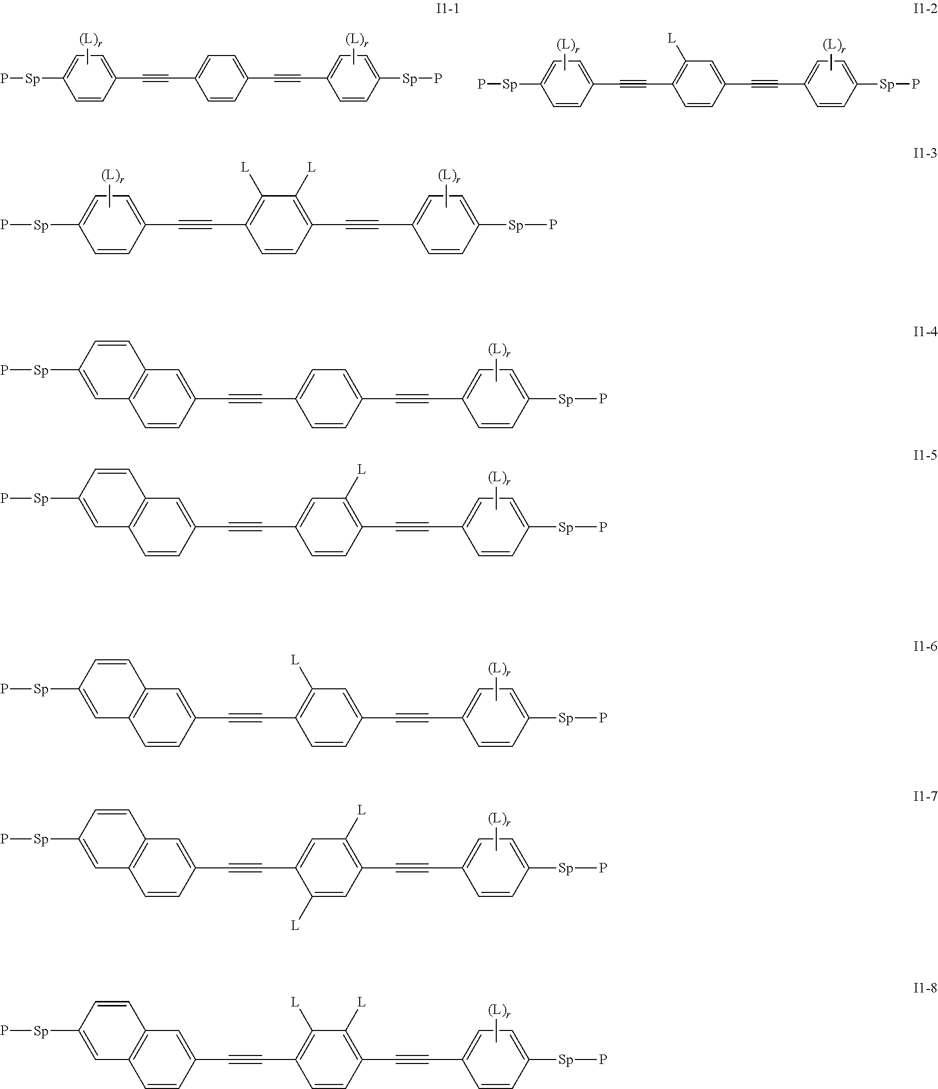 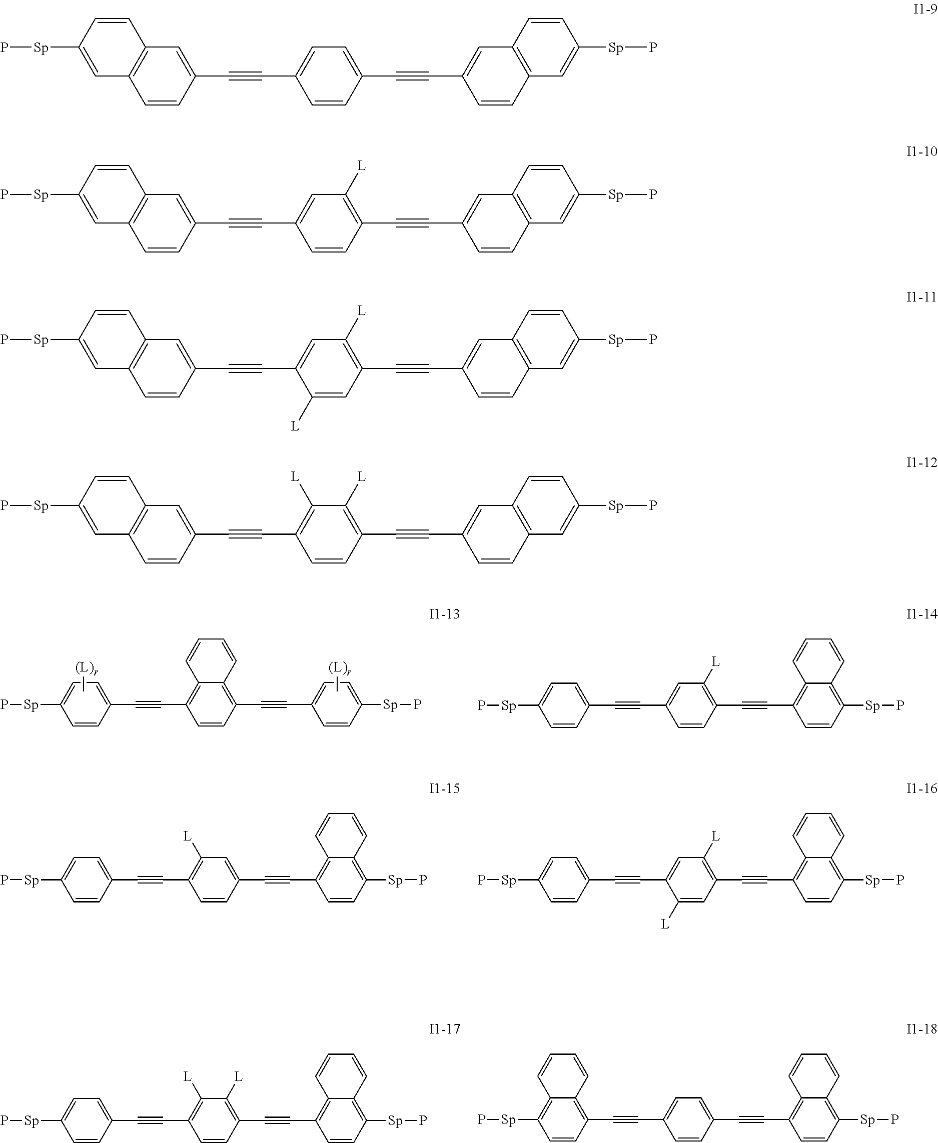 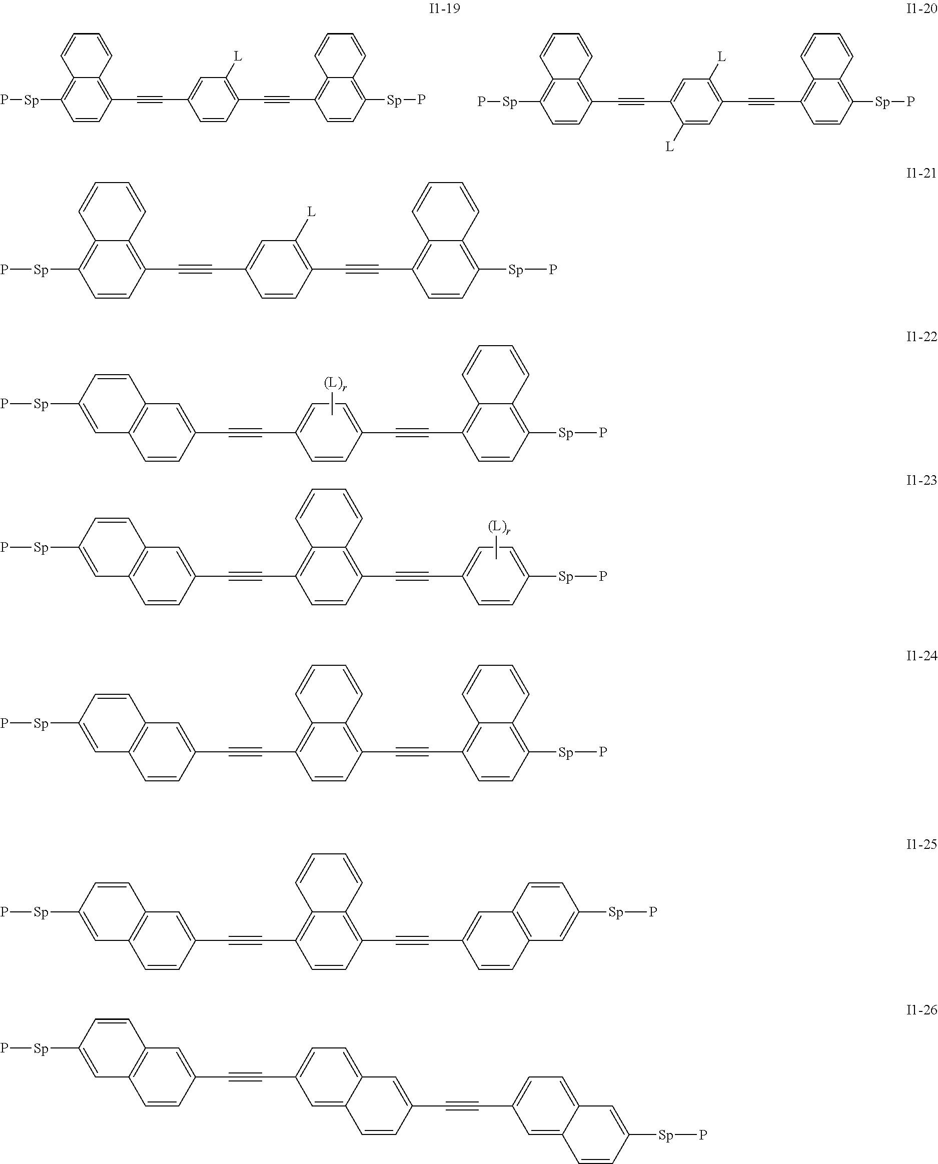 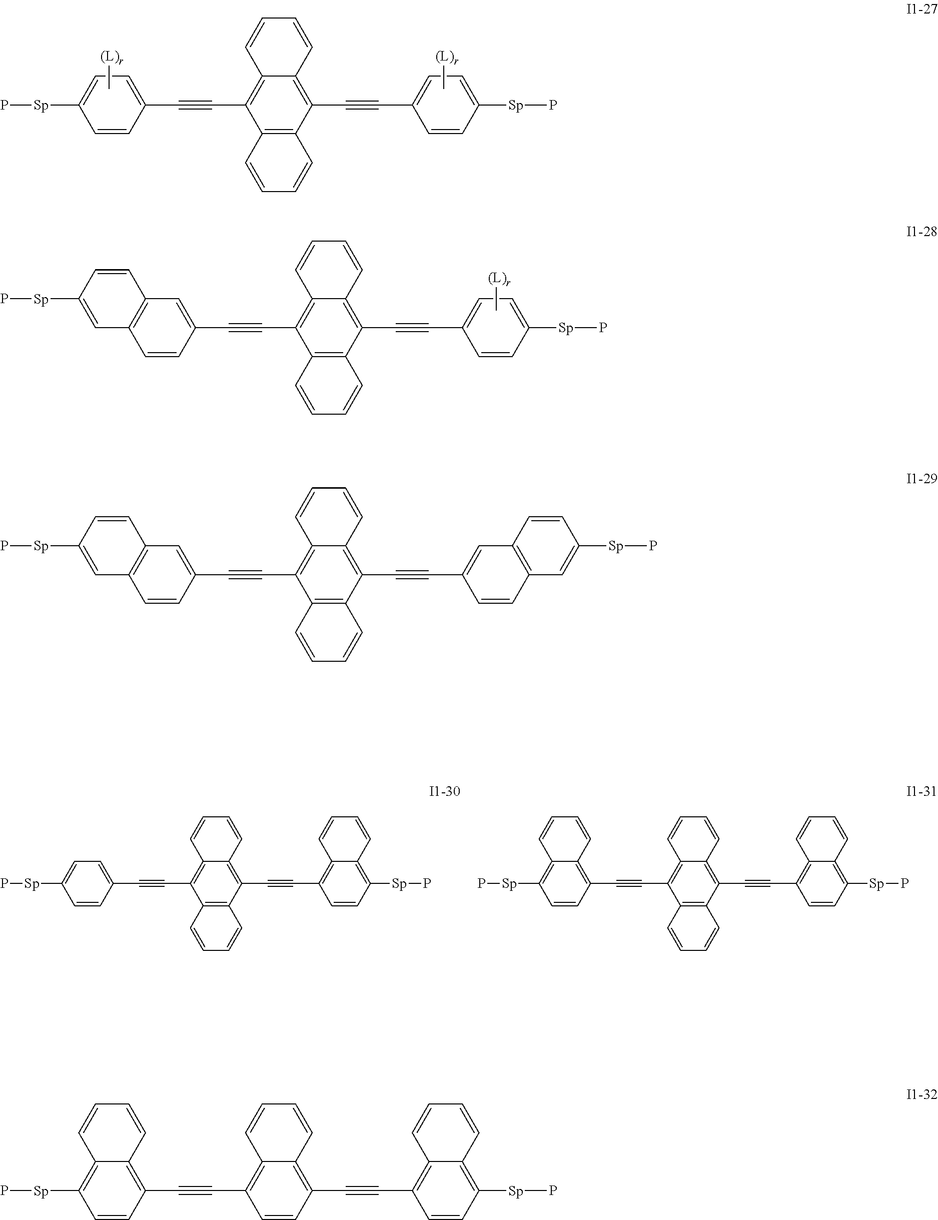 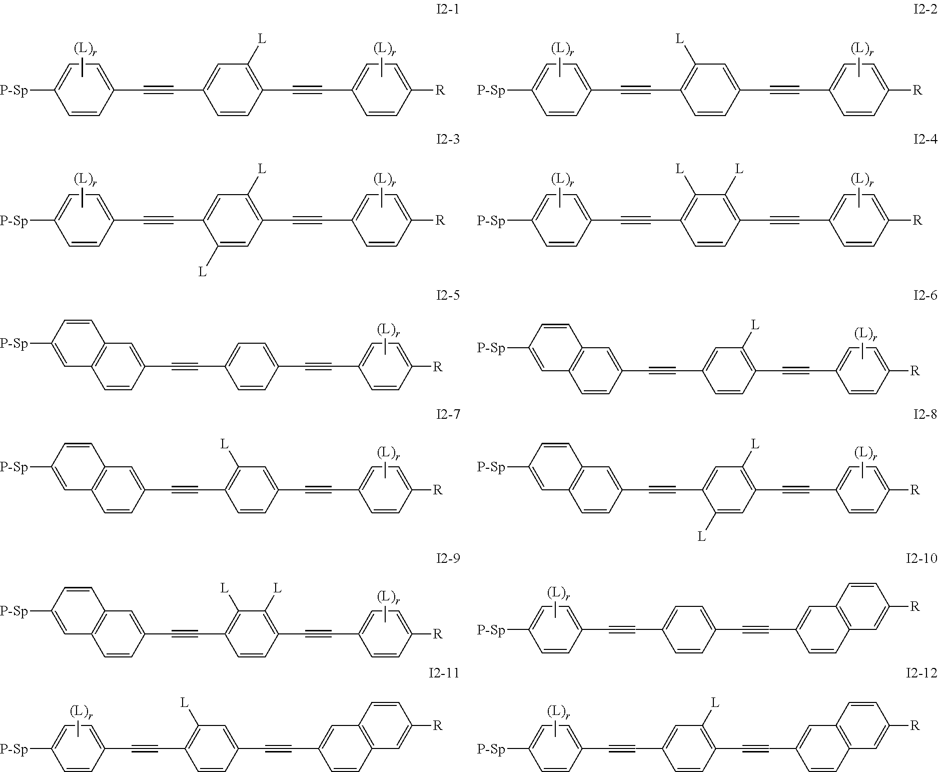 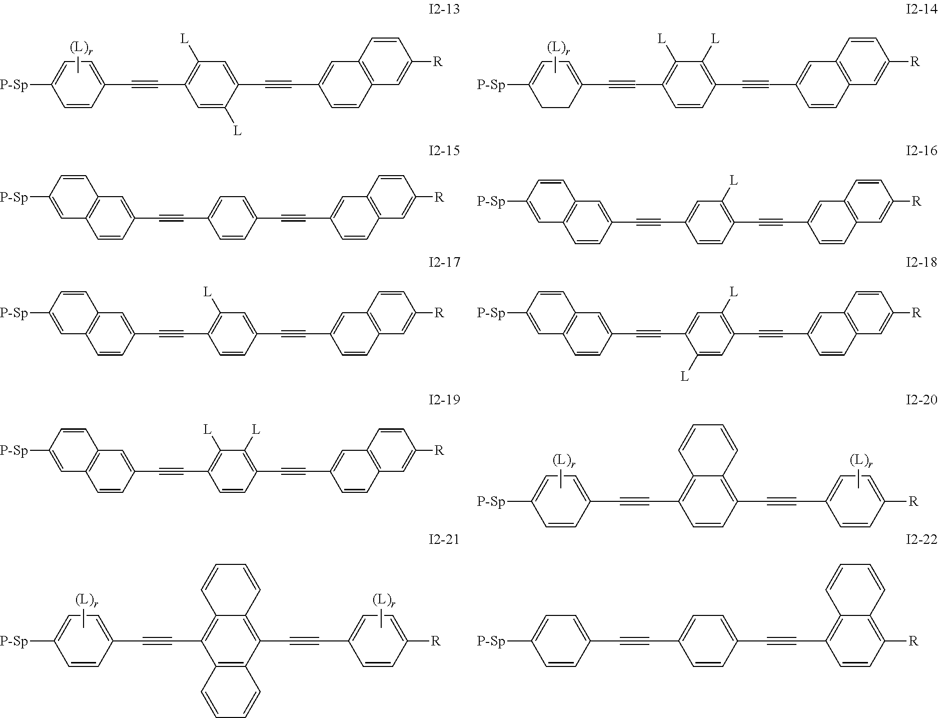 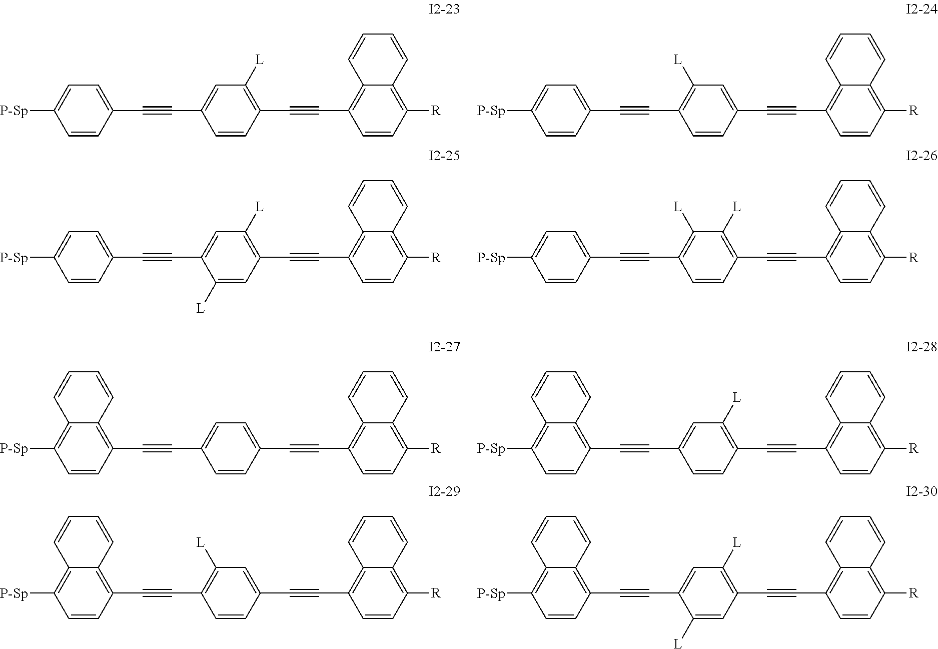 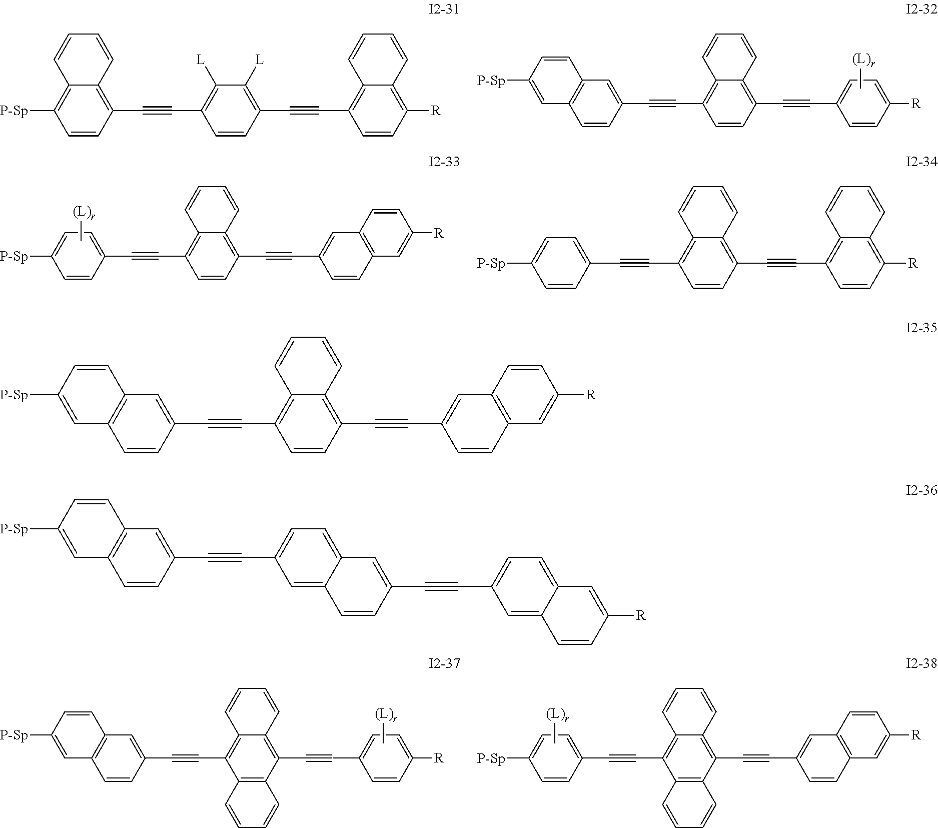 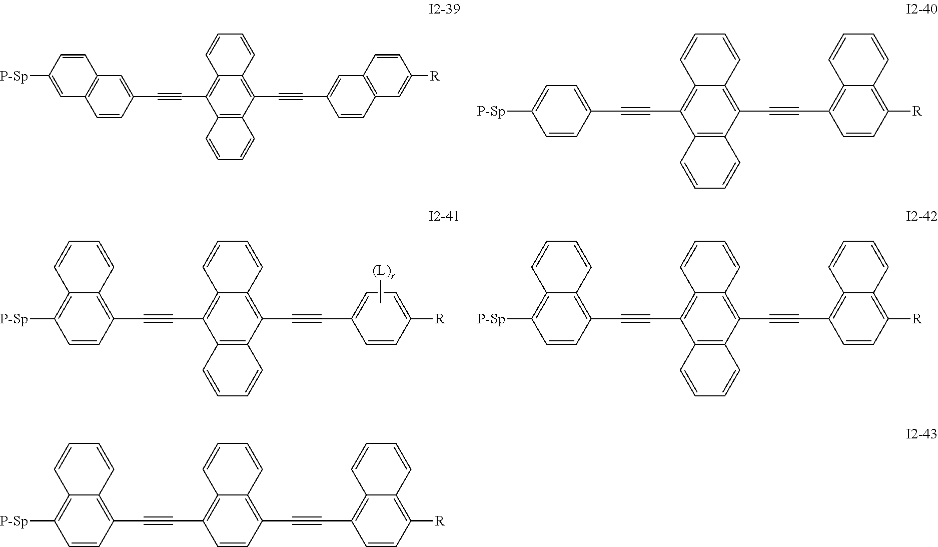
wherein
the naphthalene rings are optionally substituted with one or two groups L,
P denotes a polymerizable group,
Sp denotes a spacer group or a single bond,
L denotes F, Cl, —CN, P—Sp-, or straight chain, branched or cyclic alkyl having 1 to 25 or 3 to 25 C atoms, wherein one or more non-adjacent CH₂-groups are optionally replaced by —O—, —S—, —CO—, —CO—O—, —O—CO—, —O—CO—O—, CR⁰═CR⁰—, —C≡O—, 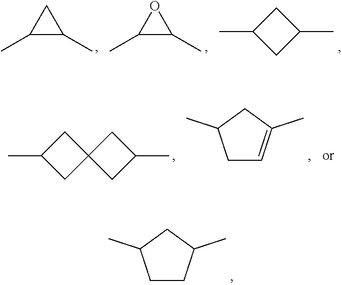
in such a manner that O- and/or S-atoms are not directly connected with each other, and wherein one or more H atoms are each optionally replaced by P—Sp-, F or Cl, or two substituents L that are connected to directly adjacent C atoms optionally form a cycloalkyl or cycloalkenyl group with 5, 6, 7 or 8 C atoms,
r denotes 0, 1, 2, 3 or 4, and
R denotes CN, OCH₃ or SCH₃.

6. The mixture according to claim 1, wherein P is acrylate or methacrylate, and Sp is —(CH₂)ₚ₁—, —(CH₂)ₚ₁—O—, —(CH₂)ₚ₁—O—CO—, —(CH₂)ₚ₁—CO—O— or —(CH₂)ₚ₁—O—CO—O—, in which p1 is an integer from 1 to 6.

7. The mixture according to claim 1, further comprising one or more chiral compounds selected from the the group consisting of the following formulae: 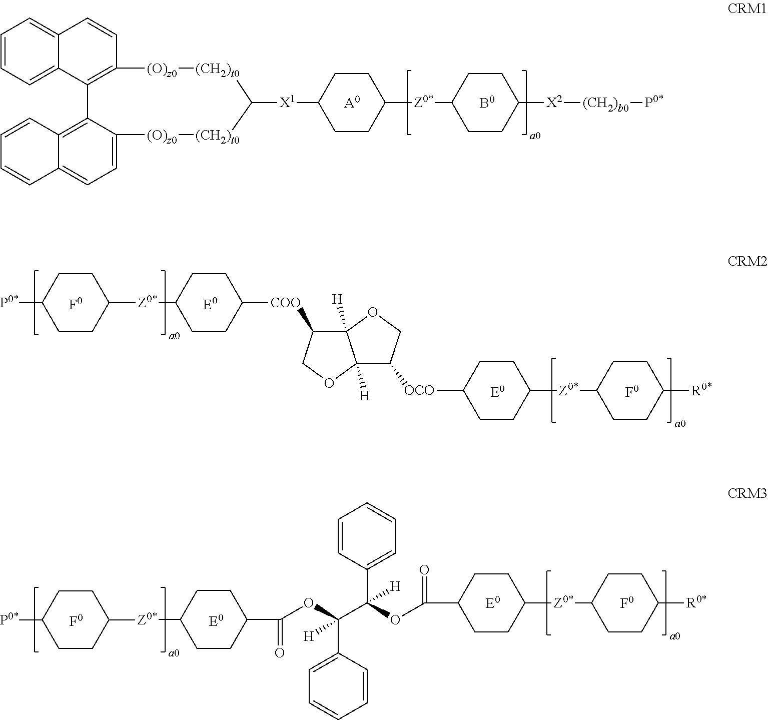
wherein the individual radicals, independently of each other and on each occurrence identically or differently, have the following meanings
P⁰* denotes a polymerizable group,
Sp⁰* denotes a spacer group or a single bond,
R⁰* denotes F, Cl, CN, alkyl, alkoxy, thioalkyl, alkylcarbonyl, alkoxycarbonyl, alkylcarbonyloxy or alkoxycarbonyloxy with 1 to 15 C atoms, P⁰*— or P⁰*— Sp*—,
A⁰, B⁰, E⁰, F⁰
denote 1,4-phenylene that is unsubstituted or substituted with 1, 2, 3 or 4 groups L, or trans-1,4-cyclohexylene,
L denotes F, Cl, CN, P—Sp-, or alkyl, alkoxy, thioalkyl, alkylcarbonyl, alkoxycarbonyl, alkylcarbonyloxy or alkoxycarbonyloxy with 1 to 5 C atoms that is optionally fluorinated,
X¹, X² denote —O—, —COO—, —OCO—, —O—CO—O— or a single bond,
Z⁰* denotes —COO—, —OCO—, —O—CO—O—, —OCH₂—, —CH₂O—, —CF₂O—, —OCF₂—, —CH₂CH₂—, —(CH₂)₄—, —CF₂CH₂—, —CH₂CF₂—, —CF₂CF₂—, —C≡C—, —CH═CH—, —CH═CH—COO—, —OCO—CH═CH— or a single bond,
a0 denotes 0, 1 or 2,
b0 denotes 0 or an integer from 1 to 12,
t0 denotes 0, 1, 2 or 3, and
z0 denotes 0 or 1,
and wherein the naphthalene rings are optionally substituted with one or more identical or different groups L.

8. The mixture according to claim 1, further comprising one or more chiral compounds selected from the following formula: 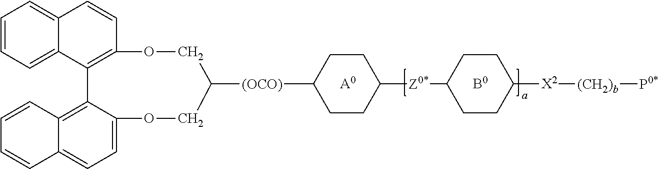
wherein
A⁰, B⁰ denote 1,4-phenylene that is unsubstituted or substituted with 1, 2, 3 or 4 groups L, or trans-1 4-cyclohexylene,
Z⁰* denotes —COO—, —OCO—, —O—CO—O—, —OCH₂—, —CH₂O—, —CF₂O—, —OCF₂—, —CH₂CH₂—, —(CH₂)₄, —CF₂CH₂—, —CH₂CF₂—, —CF₂CF₂—, —C≡C—, —CH═CH—, —CH═CH—COO—, —OCO—CH═CH— or a single bond,
P⁰* denotes a polymerizable group,
a denotes 0, 1 or 2,
b denotes 0 or an integer from 1 to 12, and
(OCO) denotes —O—CO— or a single bond.

9. The mixture according to claim 1, additionally comprising one or more reactive mesogens having only one polymerizable functional group, and one or more reactive mesogens having two or more polymerizable functional groups, wherein these additional reactive mesogens are different from the at least one polymerizable compound of formulae I.

10. A formulation comprising a mixture according to claim 1, further comprising one or more solvents and/or additives.

11. A polymer film obtained by polymerizing the mixture or a formulation comprising the mixture according to claim 1 at a temperature where the at least one polymerizable compound of formula I or the mixture exhibits a liquid crystal phase.

12. An optical, electro-optical or electronic device or a component thereof, comprising the mixture according to claim 1.

13. An optical, electro-optical or electronic device or a component thereof, comprising the polymer film according to claim 11.

14. The component of claim 13, which is selected from optical retardation films, polarizers, optical compensators, diffraction or surface gratings such as Bragg polarization gratings (Bragg PG), polarization volume gratings (PVG) or Pancharatnam Berry gratings (PBG), furthermore nonmechanical beam steering elements, optical waveguides, optical couplers or combiners, polarization beam splitters, partial mirrors, reflective films, alignment layers, colour filters, antistatic protection sheets, electromagnetic interference protection sheets, lenses for light guides, focusing and optical effects, polarization controlled lenses, and IR reflection films.

15. The device of claim 13, which is selected from liquid crystal displays, organic light emitting diodes, autostereoscopic 3D displays, see-through near-eye displays, AR/VR systems, goggles for AR/VR applications, switchable windows, spatial light modulators, optical data storage devices, optical sensors, holographic devices, spectrometers, optical telecommunication systems, polarimeters or front-/backlights.
